(19) United States
(12) Patent Application Publication
(10) Pub. No.: US 2013/0253018 A1
(43) Pub. Date: Sep. 26, 2013

(54) Use of Fluopyram for Controlling Nematodes in Crops and for Increasing Yield

(71) Applicants: Heike Hungenberg, Langenfeld (DE); Helmut Fuersch, Leichlingen (DE); Heiko Rieck, Burscheid (DE); Elke Hellwege, Langenfeld (DE)

(72) Inventors: Heike Hungenberg, Langenfeld (DE); Helmut Fuersch, Leichlingen (DE); Heiko Rieck, Burscheid (DE); Elke Hellwege, Langenfeld (DE)

(73) Assignee: BAYER INTELLECTUAL PROPERTY GMBH, Monheim (DE)

(21) Appl. No.: 13/990,662

(22) PCT Filed: Nov. 30, 2011
(86) PCT No.: PCT/EP2011/071341

§ 371 Date: May 30, 2013

Related U.S. Application Data
(60) Provisional application No. 61/419,450, filed on Dec. 3, 2010.

(30) Foreign Application Priority Data
Dec. 1, 2010 (DE) 10193324.0

(51) Int. Cl. A01N 43/40

(52) U.S. Cl. CPC A01N 43/40
USPC 514/357; 546/337

(57) ABSTRACT

The present invention relates generally to the use of pyridylethylbenzamide derivatives for controlling nematodes and to methods particularly useful for controlling nematodes and/or increasing crop yield.

### BACKGROUND OF THE INVENTION

The present invention relates generally to the use of N-{[3-chloro-5-(trifluoromethyl)-2-pyridinyl]-ethyl}-2,6-dichlorobenzamide (fluopyram) and compositions comprising fluopyram for controlling nematodes in vegetables, in particular tomato and cucurbits, potato, corn, soy, cotton, tobacco, coffee, fruits, in particular, citrus fruits, pine apples and bananas, and grapes and to methods particularly useful for controlling nematodes and/or increasing crop yield in consisting of vegetables, in particular tomato and cucurbits, potato, pepper, carrots, onions, corn, soy, cotton, tobacco, coffee, sugarcane, fruits, in particular, citrus fruits, pine apples and bananas, and grapes, tree crops—pome fruits, tree crops—stone fruits, tree crops—nuts, flowers and for increasing yield.

Fluopyram is defined to be the compound of the formula (I)

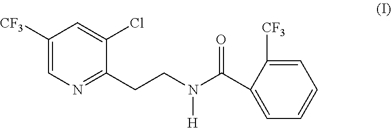 [SMILES: O=C(NCCc1ncc(C(F)(F)F)cc1Cl)c1ccccc1C(F)(F)F]

as well as the N-oxides of the compound thereof.

Fluopyram is a broad spectrum fungicide with penetrant and translaminar properties for foliar, drip, drench and seed treatment applications on a wide range of different crops against many economically important plant diseases. It is very effective in preventative applications against powdery mildew species, grey mould and white mould species. It has an efficacy against many other plant diseases. Fluopyram has shown activity in spore germination, germ tube elongation and mycelium growth tests. At the biochemical level, fluopyram inhibits mitochondrial respiration by blocking the electron transport in the respiratory chain of Succinate Dehydrogenase (complex II—SDH inhibitor).

Fluopyram and its manufacturing process starting from known and commercially available compounds is described in EP-A-1 389 614 and WO 2004/016088.

A general description of the nematicidal activity of pyridylethylbenzamide derivatives is found in WO-A 2008/126922.

Nematodes are tiny, worm-like, multicellular animals adapted to living in water. The number of nematode species is estimated at half a million. An important part of the soil fauna, nematodes live in a maze of interconnected channels, called pores, that are formed by soil processes. They move in the films of water that cling to soil particles. Plant-parasitic nematodes, a majority of which are root feeders, are found in association with most plants. Some are endoparasitic, living and feeding within the tissue of the roots, tubers, buds, seeds, etc. Others are ectoparasitic, feeding externally through plant walls. A single endoparasitic nematode can kill a plant or reduce its productivity. Endoparasitic root feeders include such economically important pests as the root-knot nematodes (Meloidogyne species), the reniform nematodes (Rotylenchulus species), the cyst nematodes (Heterodera species), and the root-lesion nematodes (Pratylenchus species). Direct feeding by nematodes can drastically decrease a plant's uptake of nutrients and water. Nematodes have the greatest impact on crop productivity when they attack the roots of seedlings immediately after seed germination. Nematode feeding also creates open wounds that provide entry to a wide variety of plant-pathogenic fungi and bacteria. These microbial infections are often more economically damaging than the direct effects of nematode feeding.

Current nematode control focuses essentially on the prevention of nematode attack on the plant. Once a plant is parasitized it is virtually impossible to kill the nematode without also destroying the plant.

Therefore, it would be advantageous to provide nematode control compounds and methods of treating plants to prevent or reduce nematode damage.

### SUMMARY OF THE INVENTION

This invention now provides advantageous uses of fluopyram for controlling nematodes infesting crops selected from the group consisting of vegetables, tomato, cucurbits, potato, pepper, carrots, onions, corn, soy, cotton, tobacco, coffee, sugarcane, fruits, citrus fruits, pine apples and bananas, and grapes, tree crops—pome fruits, tree crops—stone fruits, tree crops—nuts, flowers and for increasing yield.

This invention now provides advantageous uses of fluopyram for controlling nematodes infesting crops selected from the group consisting of vegetables, corn, soy, cotton, tobacco, coffee, sugarcane, fruits, tree crops—nuts, flowers and for increasing yield.

This invention now provides advantageous uses of fluopyram for controlling nematodes infesting crops selected from the group consisting of vegetables, in particular tomato and cucurbits, potato, pepper, carrots, onions, corn, soy, cotton, tobacco, coffee, sugarcane, fruits, in particular, citrus fruits, pine apples and bananas, and grapes, tree crops—pome fruits, tree crops—stone fruits, tree crops—nuts, flowers and for increasing yield.

This invention now provides advantageous uses of fluopyram for controlling nematodes infesting crops selected from the group consisting of vegetables, in particular tomato and cucurbits, potato, corn, soy, cotton, tobacco, coffee, fruits, in particular, citrus fruits, pine apples and bananas, and grapes and for increasing yield.

The invention relates further to the use of fluopyram for controlling nematodes selected from the group of genera selected from Aphelenchoides spp., Bursaphelenchus spp., Ditylenchus spp., Globodera spp., Heterodera spp., Longidorus spp., Meloidogyne spp., Pratylenchus spp., Radopholus spp., Trichodorus spp., Tylenchulus spp, Xiphinema spp., Helicotylenchus spp., Tylenchorhynchus spp., Scutellonema spp., Paratrichodorus spp., Meloinema spp., Paraphelenchus spp., Aglenchus spp., Belonolaimus spp., Nacobbus spp, Rotylenchulus spp., Rotylenchus spp., Neotylenchus spp., Paraphelenchus spp., Dolichodorus spp., Hoplolaimus spp., Punctodera spp., Criconemella spp., Quinisulcius spp., Hemicycliophora spp., Anguina spp., Subanguina spp., Hemicriconemoides spp., Psilenchus spp., Pseudohalenchus spp., Criconemoides spp., Cacopaurus spp. infesting crops selected from the group consisting of vegetables, in particular tomato and cucurbits, potato, corn, soy, cotton, tobacco, coffee, fruits, in particular, citrus fruits, pine apples and bananas, and grapes.

The invention relates further to the use of fluopyram for controlling nematodes selected from the group of genera selected from Aphelenchoides spp., Bursaphelenchus spp., Ditylenchus spp., Globodera spp., Heterodera spp., Longidorus spp., Meloidogyne spp., Pratylenchus spp., Radopholus spp., Trichodorus spp., Tylenchulus spp, Xiphinema spp., Helicotylenchus spp., Tylenchorhynchus spp., Scutellonema spp., Paratrichodorus spp., Meloinema spp., Paraphelenchus spp., Aglenchus spp., Belonolaimus spp., Nacobbus spp, Rotylenchulus spp., Rotylenchus spp., Neotylenchus spp., Paraphelenchus spp., Dolichodorus spp., Hoplolaimus spp., Punctodera spp., Criconemella spp., Quinisulcius spp., Hemicycliophora spp., Anguina spp., Subanguina spp., Hemicriconemoides spp., Psilenchus spp., Pseudohalenchus spp., Criconemoides spp., Cacopaurus spp. infesting crops selected from the group consisting of vegetables, in particular tomato and cucurbits, potato, pepper, carrots, onions, corn, soy, cotton, tobacco, coffee, sugarcane, fruits, in particular, citrus fruits, pine apples and bananas, and grapes, tree crops—pome fruits, tree crops—stone fruits, tree crops—nuts, flowers and for increasing yield.

The invention relates further to the use of fluopyram for controlling nematode species selected from the group consisting of Aglenchus agricola, Anguina tritici, Aphelenchoides arachidis, Aphelenchoides fragariae, Belonolaimus gracilis, Belonolaimus longicaudatus, Belonolaimus nortoni, Cacopaurus pestis, Criconemella curvata, Criconemella onoensis, Criconemella ornata, Criconemella rusium, Criconemella xenoplax (=Mesocriconema xenoplax) and Criconemella spp. in general, Criconemoides ferniae, Criconemoides onoense, Criconemoides ornatum and Criconemoides spp. in general, Ditylenchus destructor, Ditylenchus dipsaci, Ditylenchus myceliophagus and Ditylenchus spp. in general, Dolichodorus heterocephalus, Globodera pallida (=Heterodera pallida), Globodera rostochiensis, Globodera solanacearum, Globodera tabacum, Globodera virginiae, Helicotylenchus digonicus, Helicotylenchus dihystera, Helicotylenchus erythrine, Helicotylenchus multicinctus, Helicotylenchus nannus, Helicotylenchus pseudorobustus and Helicotylenchus spp. in general, Hemicriconemoides, Hemicycliophora arenaria, Hemicycliophora nudata, Hemicycliophora parvana, Heterodera avenae, Heterodera cruciferae, Heterodera glycines, Heterodera oryzae, Heterodera schachtii, Heterodera zeae and Heterodera spp. in general, Hoplolaimus aegyptii, Hoplolaimus californicus, Hoplolaimus columbus, Hoplolaimus galeatus, Hoplolaimus indicus, Hoplolaimus magnistylus, Hoplolaimus pararobustus, Longidorus africanus, Longidorus breviannulatus, Longidorus elongatus, Longidorus laevicapitatus, Longidorus vineacola and Longidorus spp. in general, Meloidogyne acronea, Meloidogyne africana, Meloidogyne arenaria, Meloidogyne arenaria thamesi, Meloidogyne artiella, Meloidogyne chitwoodi, Meloidogyne coffeicola, Meloidogyne ethiopica, Meloidogyne exigua, Meloidogyne graminicola, Meloidogyne graminis, Meloidogyne hapla, Meloidogyne incognita, Meloidogyne incognita acrita, Meloidogyne javanica, Meloidogyne kikuyensis, Meloidogyne naasi, Meloidogyne paranaensis, Meloidogyne thamesi and Meloidogyne spp. in general, Meloinema spp., Nacobbus aberrans, Neotylenchus vigissi, Paraphelenchus pseudoparietinus, Paratrichodorus allius, Paratrichodorus lobatus, Paratrichodorus minor, Paratrichodorus nanus, Paratrichodorus porosus, Paratrichodorus teres and Paratrichodorus spp. in general, Paratylenchus hamatus, Paratylenchus minutus, Paratylenchus projectus and Paratylenchus spp. in general, Pratylenchus agilis, Pratylenchus alleni, Pratylenchus andinus, Pratylenchus brachyurus, Pratylenchus cerealis, Pratylenchus coffeae, Pratylenchus crenatus, Pratylenchus delattrei, Pratylenchus giibbicaudatus, Pratylenchus goodeyi, Pratylenchus hamatus, Pratylenchus hexincisus, Pratylenchus loosi, Pratylenchus neglectus, Pratylenchus penetrans, Pratylenchus pratensis, Pratylenchus scribneri, Pratylenchus teres, Pratylenchus thornei, Pratylenchus vulnus, Pratylenchus zeae and Pratylenchus spp. in general, Pseudohalenchus minutus, Psilenchus magnidens, Psilenchus tumidus, Punctodera chalcoensis, Quinisulcius acutus, Radopholus citrophilus, Radopholus similis, Rotylenchulus borealis, Rotylenchulus parvus, Rotylenchulus reniformis and Rotylenchulus spp. in general, Rotylenchus laurentinus, Rotylenchus macrodoratus, Rotylenchus robustus, Rotylenchus uniformis and Rotylenchus spp. in general, Scutellonema brachyurum, Scutellonema bradys, Scutellonema clathricaudatum and Scutellonema spp. in general, Subanguina radiciola, Tetylenchus nicotianae, Trichodorus cylindricus, Trichodorus minor, Trichodorus primitivus, Trichodorus proximus, Trichodorus similis, Trichodorus sparsus and Trichodorus spp. in general, Tylenchorhynchus agri, Tylenchorhynchus brassicae, Tylenchorhynchus clarus, Tylenchorhynchus claytoni, Tylenchorhynchus digitatus, Tylenchorhynchus ebriensis, Tylenchorhynchus maximus, Tylenchorhynchus nudus, Tylenchorhynchus vulgaris and Tylenchorhynchus spp. in general, Tylenchulus semipenetrans, Xiphinema americanum, Xiphinema brevicolle, Xiphinema dimorphicaudatum, Xiphinema index and Xiphinema spp. in general.

Accordingly, the present invention also relates to the use of compositions comprising

A) fluopyram and

B) at least one agrochemically active compound,

in addition to extenders and/or surfactants

for controlling nematodes infesting crops selected from the group consisting of vegetables, in particular tomato and cucurbits, potato, corn, soy, cotton, tobacco, coffee, fruits, in particular, citrus fruits, pine apples and bananas, and grapes and for increasing yield.

Accordingly, the present invention also relates to the use of compositions comprising

A) fluopyram and

B) at least one agrochemically active compound,

in addition to extenders and/or surfactants

for controlling nematodes infesting crops selected from the group consisting of vegetables, in particular tomato and cucurbits, potato, pepper, carrots, onions, corn, soy, cotton, tobacco, coffee, sugarcane, fruits, in particular, citrus fruits, pine apples and bananas, and grapes, tree crops—pome fruits, tree crops—stone fruits, tree crops—nuts, flowers and for increasing yield.

Accordingly, the present invention also relates to the use of compositions comprising

A) fluopyram and

B) at least one agrochemically active compound,

in addition to extenders and/or surfactants

for controlling nematodes selected from the group of genera selected from Aphelenchoides spp., Bursaphelenchus spp., Ditylenchus spp., Globodera spp., Heterodera spp., Longidorus spp., Meloidogyne spp., Pratylenchus spp., Radopholus spp., Trichodorus spp., Tylenchulus spp, Xiphinema spp., Helicotylenchus spp., Tylenchorhynchus spp., Scutellonema spp., Paratrichodorus spp., Meloinema spp., Paraphelenchus spp., Aglenchus spp., Belonolaimus spp., Nacobbus spp, Rotylenchulus spp., Rotylenchus spp., Neotylenchus spp., Paraphelenchus spp., Dolichodorus spp., Hoplolaimus spp., Punctodera spp., Criconemella spp., Quinisulcius spp., Hemicycliophora spp., Anguina spp., Subanguina spp., Hemicriconemoides spp., Psilenchus spp., Pseudohalenchus spp., Criconemoides spp., Cacopaurus spp. infesting crops selected from the group consisting of vegetables, in particular tomato and cucurbits, potato, corn, soy, cotton, tobacco, coffee, fruits, in particular, citrus fruits, pine apples and bananas, and grapes and for increasing yield.

Accordingly, the present invention also relates to the use of compositions comprising

A) fluopyram and

B) at least one agrochemically active compound,

in addition to extenders and/or surfactants

for controlling nematodes selected from the group of genera selected from Aphelenchoides spp., Bursaphelenchus spp., Ditylenchus spp., Globodera spp., Heterodera spp., Longidorus spp., Meloidogyne spp., Pratylenchus spp., Radopholus spp., Trichodorus spp., Tylenchulus spp, Xiphinema spp., Helicotylenchus spp., Tylenchorhynchus spp., Scutellonema spp., Paratrichodorus spp., Meloinema spp., Paraphelenchus spp., Aglenchus spp., Belonolaimus spp., Nacobbus spp, Rotylenchulus spp., Rotylenchus spp., Neotylenchus spp., Paraphelenchus spp., Dolichodorus spp., Hoplolaimus spp., Punctodera spp., Criconemella spp., Quinisulcius spp., Hemicycliophora spp., Anguina spp., Subanguina spp., Hemicriconemoides spp., Psilenchus spp., Pseudohalenchus spp., Criconemoides spp., Cacopaurus spp. infesting crops selected from the group consisting of vegetables, for controlling nematodes infesting crops selected from the group consisting of vegetables, in particular tomato and cucurbits, potato, pepper, carrots, onions, corn, soy, cotton, tobacco, coffee, sugarcane, fruits, in particular, citrus fruits, pine apples and bananas, and grapes, tree crops—pome fruits, tree crops—stone fruits, tree crops—nuts, flowers and for increasing yield.

Accordingly, the present invention also relates to the use of compositions comprising

A) fluopyram and

B) at least one agrochemically active compound,

in addition to extenders and/or surfactants

for controlling nematodes species selected from the group consisting of Aglenchus agricola, Anguina tritici, Aphelenchoides arachidis, Aphelenchoides fragariae, Belonolaimus gracilis, Belonolaimus longicaudatus, Belonolaimus nortoni, Cacopaurus pestis, Criconemella curvata, Criconemella onoensis, Criconemella ornata, Criconemella rusium, Criconemella xenoplax (=Mesocriconema xenoplax) and Criconemella spp. in general, Criconemoides ferniae, Criconemoides onoense, Criconemoides ornatum and Criconemoides spp. in general, Ditylenchus destructor, Ditylenchus dipsaci, Ditylenchus myceliophagus and Ditylenchus spp. in general, Dolichodorus heterocephalus, Globodera pallida (=Heterodera pallida), Globodera rostochiensis, Globodera solanacearum, Globodera tabacum, Globodera virginiae, Helicotylenchus digonicus, Helicotylenchus dihystera, Helicotylenchus erythrine, Helicotylenchus multicinctus, Helicotylenchus nannus, Helicotylenchus pseudorobustus and Helicotylenchus spp. in general, Hemicriconemoides, Hemicycliophora arenaria, Hemicycliophora nudata, Hemicycliophora parvana, Heterodera avenae, Heterodera cruciferae, Heterodera glycines, Heterodera oryzae, Heterodera schachtii, Heterodera zeae and Heterodera spp. in general, Hoplolaimus aegyptii, Hoplolaimus californicus, Hoplolaimus columbus, Hoplolaimus galeatus, Hoplolaimus indicus, Hoplolaimus magnistylus, Hoplolaimus pararobustus, Longidorus africanus, Longidorus breviannulatus, Longidorus elongatus, Longidorus laevicapitatus, Longidorus vineacola and Longidorus spp. in general, Meloidogyne acronea, Meloidogyne africana, Meloidogyne arenaria, Meloidogyne arenaria thamesi, Meloidogyne artiella, Meloidogyne chitwoodi, Meloidogyne coffeicola, Meloidogyne ethiopica, Meloidogyne exigua, Meloidogyne graminicola, Meloidogyne graminis, Meloidogyne hapla, Meloidogyne incognita, Meloidogyne incognita acrita, Meloidogyne javanica, Meloidogyne kikuyensis, Meloidogyne naasi, Meloidogyne paranaensis, Meloidogyne thamesi and Meloidogyne spp. in general, Meloinema spp., Nacobbus aberrans, Neotylenchus vigissi, Paraphelenchus pseudoparietinus, Paratrichodorus allius, Paratrichodorus lobatus, Paratrichodorus minor, Paratrichodorus nanus, Paratrichodorus porosus, Paratrichodorus teres and Paratrichodorus spp. in general, Paratylenchus hamatus, Paratylenchus minutus, Paratylenchus projectus and Paratylenchus spp. in general, Pratylenchus agilis, Pratylenchus alleni, Pratylenchus andinus, Pratylenchus brachyurus, Pratylenchus cerealis, Pratylenchus coffeae, Pratylenchus crenatus, Pratylenchus delattrei, Pratylenchus giibbicaudatus, Pratylenchus goodeyi, Pratylenchus hamatus, Pratylenchus hexincisus, Pratylenchus loosi, Pratylenchus neglectus, Pratylenchus penetrans, Pratylenchus pratensis, Pratylenchus scribneri, Pratylenchus teres, Pratylenchus thornei, Pratylenchus vulnus, Pratylenchus zeae and Pratylenchus spp. in general, Pseudohalenchus minutus, Psilenchus magnidens, Psilenchus tumidus, Punctodera chalcoensis, Quinisulcius acutus, Radopholus citrophilus, Radopholus similis, Rotylenchulus borealis, Rotylenchulus parvus, Rotylenchulus reniformis and Rotylenchulus spp. in general, Rotylenchus laurentinus, Rotylenchus macrodoratus, Rotylenchus robustus, Rotylenchus uniformis and Rotylenchus spp. in general, Scutellonema brachyurum, Scutellonema bradys, Scutellonema clathricaudatum and Scutellonema spp. in general, Subanguina radiciola, Tetylenchus nicotianae, Trichodorus cylindricus, Trichodorus minor, Trichodorus primitivus, Trichodorus proximus, Trichodorus similis, Trichodorus sparsus and Trichodorus spp. in general, Tylenchorhynchus agri, Tylenchorhynchus brassicae, Tylenchorhynchus clarus, Tylenchorhynchus claytoni, Tylenchorhynchus digitatus, Tylenchorhynchus ebriensis, Tylenchorhynchus maximus, Tylenchorhynchus nudus, Tylenchorhynchus vulgaris and Tylenchorhynchus spp. in general, Tylenchulus semipenetrans, Xiphinema americanum, Xiphinema brevicolle, Xiphinema dimorphicaudatum, Xiphinema index and Xiphinema spp. in general infesting crops selected from the group consisting of vegetables, in particular tomato and cucurbits, potato, corn, soy, cotton, tobacco, coffee, fruits, in particular, citrus fruits, pine apples and bananas, and grapes and for increasing yield.

Accordingly, the present invention also relates to the use of compositions comprising

A) fluopyram and

B) at least one agrochemically active compound,

in addition to extenders and/or surfactants

for controlling nematodes species selected from the group consisting of Aglenchus agricola, Anguina tritici, Aphelenchoides arachidis, Aphelenchoides fragariae, Belonolaimus gracilis, Belonolaimus longicaudatus, Belonolaimus nortoni, Cacopaurus pestis, Criconemella curvata, Criconemella onoensis, Criconemella ornata, Criconemella rusium, Criconemella xenoplax (=Mesocriconema xenoplax) and Criconemella spp. in general, Criconemoides ferniae, Criconemoides onoense, Criconemoides ornaturn and Criconemoides spp. in general, Ditylenchus destructor, Ditylenchus dipsaci, Ditylenchus myceliophagus and Ditylenchus spp. in general, Dolichodorus heterocephalus, Globodera pallida (=Heterodera pallida), Globodera rostochiensis, Globodera solanacearum, Globodera tabacum, Globodera virginiae, Helicotylenchus digonicus, Helicotylenchus dihystera, Helicotylenchus erythrine, Helicotylenchus multicinctus, Helicotylenchus nannus, Helicotylenchus pseudorobustus and Helicotylenchus spp. in general, Hemicriconemoides, Hemicycliophora arenaria, Hemicycliophora nudata, Hemicycliophora parvana, Heterodera avenae, Heterodera cruciferae, Heterodera glycines, Heterodera oryzae, Heterodera schachtii, Heterodera zeae and Heterodera spp. in general, Hoplolaimus aegyptii, Hoplolaimus califormicus, Hoplolaimus columbus, Hoplolaimus galeatus, Hoplolaimus indicus, Hoplolaimus magnistylus, Hoplolaimus pararobustus, Longidorus africanus, Longidorus breviannulatus, Longidorus elongatus, Longidorus laevicapitatus, Longidorus vineacola and Longidorus spp. in general, Meloidogyne acronea, Meloidogyne africana, Meloidogyne arenaria, Meloidogyne arenaria thamesi, Meloidogyne artiella, Meloidogyne chitwoodi, Meloidogyne coffeicola, Meloidogyne ethiopica, Meloidogyne exigua, Meloidogyne graminicola, Meloidogyne graminis, Meloidogyne hapla, Meloidogyne incognita, Meloidogyne incognita acrita, Meloidogyne javanica, Meloidogyne kikuyensis, Meloidogyne naasi, Meloidogyne paranaensis, Meloidogyne thamesi and Meloidogyne spp. in general, Heloinema spp., Nacobbus aberrans, Neotylenchus vigissi, Paraphelenchus pseudoparietinus, Paratrichodorus allius, Paratrichodorus lobatus, Paratrichodorus minor, Paratrichodorus nanus, Paratrichodorus porosus, Paratrichodorus teres and Paratrichodorus spp. in general, Paratylenchus hamatus, Paratylenchus minutus, Paratylenchus projectus and Paratylenchus spp. in general, Pratylenchus agilis, Pratylenchus alleni, Pratylenchus andinus, Pratylenchus brachyurus, Pratylenchus cerealis, Pratylenchus coffeae, Pratylenchus crenatus, Pratylenchus delattrei, Pratylenchus giibbicaudatus, Pratylenchus goodeyi, Pratylenchus hamatus, Pratylenchus hexincisus, Pratylenchus loosi, Pratylenchus neglectus, Pratylenchus penetrans, Pratylenchus pratensis, Pratylenchus scribneri, Pratylenchus teres, Pratylenchus thornei, Pratylenchus vulnus, Pratylenchus zeae and Pratylenchus spp. in general, Pseudohalenchus minutus, Psilenchus magnidens, Psilenchus turnidus, Punctodera chalcoensis, Quinisulcius acutus, Radopholus citrophilus, Radopholus similis, Rotylenchulus borealis, Rotylenchulus parvus, Rotylenchulus reniformis and Rotylenchulus spp. in general, Rotylenchus laurentinus, Rotylenchus macrodoratus, Rotylenchus robustus, Rotylenchus uniformis and Rotylenchus spp. in general, Scutellonema brachyurum, Scutellonema bradys, Scutellonema clathricaudatum and Scutellonema spp. in general, Subanguina radiciola, Tetylenchus nicotianae, Trichodorus cylindricus, Trichodorus minor, Trichodorus primitivus, Trichodorus proximus, Trichodorus similis, Trichodorus sparsus and Trichodorus spp. in general, Tylenchorhynchus agri, Tylenchorhynchus brassicae, Tylenchorhynchus clarus, Tylenchorhynchus claytoni, Tylenchorhynchus digitatus, Tylenchorhynchus ebriensis, Tylenchorhynchus maximus, Tylenchorhynchus nudus, Tylenchorhynchus vulgaris and Tylenchorhynchus spp. in general, Tylenchulus semipenetrans, Xiphinema americanum, Xiphinema brevicolle, Xiphinema dimorphicaudatum, Xiphinema index and Xiphinema spp. in general infesting crops selected from the group consisting of vegetables, in particular tomato and cucurbits, potato, pepper, carrots, onions, corn, soy, cotton, tobacco, coffee, sugarcane, fruits, in particular, citrus fruits, pine apples and bananas, and grapes, tree crops—pome fruits, tree crops—stone fruits, tree crops—nuts, flowers and for increasing yield.

An exemplary method of the invention comprises applying fluopyram of the invention to either soil or a plant (e.g., seeds or foliarly) to control nematode damage and/or increase crop yield.

### DESCRIPTION OF THE PREFERRED EMBODIMENTS

Vegetables are for example broccoli, cauliflower, globe artichokes, Sweet corn (maize), peas, beans, kale, collard greens, spinach, arugula, beet greens, bok Choy, chard, choi sum, turnip greens, endive, lettuce, mustard greens, watercress, garlic chives, gai lan, leeks, brussels sprouts, capers, kohlrabi, celery, rhubarb, cardoon, Chinese celery, lemon grass, asparagus, bamboo shoots, galangal, and ginger, potatoes, Jerusalem artichokes, sweet potatoes, taro, yams soybean sprouts, mung beans, urad, alfalfa, carrots, parsnips, beets, radishes, rutabagas, turnips, burdocks, onions, shallots, garlic, tomatoes, curcurbis (cucumbers, squash, pumpkins, melons, luffas, gourds, watermelons), zucchinis peppers, eggplant, tomatillos, christophene, okra, breadfruit and avocado, green beans, lentils, snow peas.

Preferred vegetables are tomato cucurbits, potato, pepper, carrots, onions,

Tree crops—stone fruits are e.g. apricots, cherries, almonds and peaches.

Tree crops—pome fruits are e.g. apples, pears.

Tree crops—nuts are e.g. Beech, Brazil nut, Candlenut, Cashew, Chestnuts, including Chinese Chestnut, Sweet Chestnut, Colocynth, Cucurbita ficifolia, Filbert, Gevuina avellana, Hickory, including Pecan, Shagbark Hickory, Terminalia catappa, Hazelnut, Indian Beech, Kola nut, Macadamia, Malabar chestnut, Pistacia, Mamoncillo, Maya nut, Mongongo, Oak acorns, Ogbono nut, Paradise nut, Pili nut, Walnut, Black Walnut, Water Caltrop.

In the present context, agrochemically active compounds are to be understood as meaning all substances which are or may be customarily used for treating plants. Fungicides, bactericides, insecticides, acaricides, nematicides, molluscicides, safeners, plant growth regulators and plant nutrients as well as biological control agents may be mentioned as being preferred.

Mixing Partners

Examples of fungicides which may be mentioned are:

1) Inhibitors of the ergosterol biosynthesis, for example (1.1) aldimorph (1704-28-5), (1.2) azaconazole (60207-31-0), (1.3) bitertanol (55179-31-2), (1.4) bromuconazole (116255-48-2), (1.5) cyproconazole (113096-99-4), (1.6) diclobutrazole (75736-33-3), (1.7) difenoconazole (119446-68-3), (1.8) diniconazole (83657-24-3), (1.9) diniconazole-M (83657-18-5), (1.10) dodemorph (1593-77-7), (1.11) dodemorph acetate (31717-87-0), (1.12) epoxiconazole (106325-08-0), (1.13) etaconazole (60207-93-4), (1.14) fenarimol (60168-88-9), (1.15) fenbuconazole (114369-43-6), (1.16) fenhexamid (126833-17-8), (1.17) fenpropidin (67306-00-7), (1.18) fenpropimorph (67306-03-0), (1.19) fluquinconazole (136426-54-5), (1.20) flurprimidol (56425-91-3), (1.21) flusilazole (85509-19-9), (1.22) flutriafol (76674-21-0), (1.23) furconazole (112839-33-5), (1.24) furconazole-cis (112839-32-4), (1.25) hexaconazole (79983-71-4), (1.26) imazalil (60534-80-7), (1.27) imazalil sulfate (58594-72-2), (1.28) imibenconazole (86598-92-7), (1.29) ipconazole (125225-28-7), (1.30) metconazole (125116-23-6), (1.31) myclobutanil (88671-89-0), (1.32) naftifine (65472-88-0), (1.33) nuarimol (63284-71-9), (1.34) oxpoconazole (174212-12-5), (1.35) paclobutrazol (76738-62-0), (1.36) pefurazoate (101903-30-4), (1.37) penconazole (66246-88-6), (1.38) piperalin (3478-94-2), (1.39) prochloraz (67747-09-5), (1.40) propiconazole (60207-90-1), (1.41) prothioconazole (178928-70-6), (1.42) pyributicarb (88678-67-5), (1.43) pyrifenox (88283-41-4), (1.44) quinconazole (103970-75-8), (1.45) simeconazole (149508-90-7), (1.46) spiroxamine (118134-30-8), (1.47) tebuconazole (107534-96-3), (1.48) terbinafine (91161-71-6), (1.49) tetraconazole (112281-77-3), (1.50) triadimefon (43121-43-3), (1.51) triadimenol (89482-17-7), (1.52) tridemorph (81412-43-3), (1.53) triflumizole (68694-11-1), (1.54) triforine (26644-46-2), (1.55) triticonazole (131983-72-7), (1.56) uniconazole (83657-22-1), (1.57) uniconazole-p (83657-17-4), (1.58) viniconazole (77174-66-4), (1.59) voriconazole (137234-62-9), (1.60) 1-(4-chlorophenyl)-2-(1H-1,2,4-triazol-1-yl)cycloheptanol (129586-32-9), (1.61) methyl 1-(2,2-dimethyl-2,3-dihydro-1H-inden-1-yl)-1H-imidazole-5-carboxylate (110323-95-0), (1.62) N′-{5-(di fluoromethyl)-2-methyl-4-[3-(trimethylsilyl)propoxy]phenyl}-N-ethyl-N-methylimidoformamide, (1.63) N-ethyl-N-methyl-N′-{2-methyl-5-(trifluoromethyl)-4-[3-(trimethylsilyl)propoxy]phenyl}imidoformamide and (1.64) O-[1-(4-methoxyphenoxy)-3,3-dimethylbutan-2-yl]1H-imidazole-1-carbothioate (111226-71-2).

(2) inhibitors of the respiratory chain at complex I or II, for example (2.1) bixafen (581809-46-3), (2.2) boscalid (188425-85-6), (2.3) carboxin (5234-68-4), (2.4) diflumetorim (130339-07-0), (2.5) fenfuram (24691-80-3), (2.6) fluopyram (658066-35-4), (2.7) flutolanil (66332-96-5), (2.8) fluxapyroxad (907204-31-3), (2.9) furametpyr (123572-88-3), (2.10) furmecyclox (60568-05-0), (2.11) isopyrazam (mixture of syn-epimeric racemate 1RS,4SR,9RS and anti-epimeric racemate 1RS,4SR,9SR) (881685-58-1), (2.12) isopyrazam (anti-epimeric racemate 1RS,4SR,9SR), (2.13) isopyrazam (anti-epimeric enantiomer 1R,4S,9S), (2.14) isopyrazam (anti-epimeric enantiomer 1S,4R,9R), (2.15) isopyrazam (syn epimeric racemate 1RS,4SR,9RS), (2.16) isopyrazam (syn-epimeric enantiomer 1R,4S,9R), (2.17) isopyrazam (syn-epimeric enantiomer 1S,4R,9S), (2.18) mepronil (55814-41-0), (2.19) oxycarboxin (5259-88-1), (2.20) penflufen (494793-67-8), (2.21) penthiopyrad (183675-82-3), (2.22) sedaxane (874967-67-6), (2.23) thifluzamide (130000-40-7), (2.24) 1-methyl-N-[2-(1,1,2,2-tetrafluoroethoxy)phenyl]-3-(trifluoromethyl)-1H-pyrazole-4-carboxamide, (2.25) 3-(difluoromethyl)-1-methyl-N-[2-(1,1,2,2-tetrafluoroethoxy)phenyl]-1H-pyrazole-4-carboxamide, (2.26) 3-(difluoromethyl)-N-[4-fluoro-2-(1,1,2,3,3,3-hexafluoropropoxy)phenyl]-1-methyl-1H-pyrazole-4-carboxamide, (2.27) N-[1-(2,4-dichlorophenyl)-1-methoxypropan-2-yl]-3-(difluoromethyl)-1-methyl-1H-pyrazole-4-carboxamide (1092400-95-7) (WO 2008148570), (2.28) 5,8-difluoro-N-[2-(2-fluoro-4-{[4-(trifluoromethyl)pyridin-2-yl]oxy}phenyl)ethyl]quinazolin-4-amine (1210070-84-0) (WO2010025451), (2.29) N-[9-(dichloromethylene)-1,2,3,4-tetrahydro-1,4-methanonaphthalen-5-yl]-3-(difluoromethyl)-1-methyl-1H-pyrazole-4-carboxamide, (2.30) N-[(1S,4R)-9-(dichloromethylene)-1,2,3,4-tetrahydro-1,4-methanonaphthalen-5-yl]-3-(difluoromethyl)-1-methyl-1H-pyrazole-4-carboxamide and (2.31) N-[(1R,4S)-9-(dichloromethyl ene)-1,2,3,4-tetrahydro-1,4-methanonaphthalen-5-yl]-3-(difluoromethyl)-1-methyl-1H-pyrazole-4-carboxamide.

(3) inhibitors of the respiratory chain at complex III, for example (3.1) ametoctradin (865318-97-4), (3.2) amisulbrom (348635-87-0), (3.3) azoxystrobin (131860-33-8), (3.4) cyazofamid (120116-88-3), (3.5) coumethoxystrobin (850881-30-0), (3.6) coumoxystrobin (850881-70-8), (3.7) dimoxystrobin (141600-52-4), (3.8) enestroburin (238410-11-2) (WO 2004/058723), (3.9) famoxadone (131807-57-3) (WO 2004/058723), (3.10) fenamidone (161326-34-7) (WO 2004/058723), (3.11) fenoxystrobin (918162-02-4), (3.12) fluoxastrobin (361377-29-9) (WO 2004/058723), (3.13) kresoxim-methyl (143390-89-0) (WO 2004/058723), (3.14) metominostrobin (133408-50-1) (WO 2004/058723), (3.15) orysastrobin (189892-69-1) (WO 2004/058723), (3.16) picoxystrobin (117428-22-5) (WO 2004/058723), (3.17) pyraclostrobin (175013-18-0) (WO 2004/058723), (3.18) pyrametostrobin (915410-70-7) (WO 2004/058723), (3.19) pyraoxystrobin (862588-11-2) (WO 2004/058723), (3.20) pyribencarb (799247-52-2) (WO 2004/058723), (3.21) triclopyricarb (902760-40-1), (3.22) trifloxystrobin (141517-21-7) (WO 2004/058723), (3.23) (2E)-2-(2-{[6-(3-chloro-2-methylphenoxy)-5-fluoropyrimidin-4-yl]oxy}phenyl)-2-(methoxyimino)-N-methylethanamide (WO 2004/058723), (3.24) (2E)-2-(methoxyimino)-N-methyl-2-(2-{[({(1E)-1-[3-(trifluoromethyl)phenyl]ethylidene}amino)oxy]methyl}phenyl)ethanamide (WO 2004/058723), (3.25) (2E)-2-(methoxyimino)-N-methyl-2-{2-[(E)-({1-[3-(trifluoromethyl)phenyl]ethoxy} imino)methyl]phenyl}ethanamide (158169-73-4), (3.26) (2E)-2-{2-[({[(1E)-1-(3-{[(E)-1-fluoro-2-phenylethenyl]oxy}phenyl)ethylidene]amino}oxy)methyl]phenyl}-2-(methoxyimino)-N-methylethanamide (326896-28-0), (3.27) (2E)-2-{2-[({[(2E,3E)-4-(2,6-dichlorophenyl)but-3-en-2-ylidene]amino}oxy)methyl]phenyl}-2-(methoxyimino)-N-methylethanamide, (3.28) 2-chloro-N-(1,1,3-trimethyl-2,3-dihydro-1H-inden-4-yl)pyridine-3-carboxamide (119899-14-8), (3.29) 5-methoxy-2-methyl-4-(2-{[({(1E)-1-[3-(trifluoromethyl)phenyl]ethylidene}amino)oxy]methyl}phenyl)-2,4-dihydro-3H-1,2,4-triazol-3-one, (3.30) methyl (2E)-2-{2-[({cyclopropyl [(4-methoxyphenyl)imino]methyl}sulfanyl)methyl]phenyl}-3-methoxyprop-2-enoate (149601-03-6), (3.31) N-(3-ethyl-3,5,5-trimethyl cyclohexyl)-3-(formylamino)-2-hydroxybenzamide (226551-21-9), (3.32) 2-{2-[(2,5-dimethylphenoxy)methyl]phenyl}-2-methoxy-N-methylacetamide (173662-97-0) and (3.33) (2R)-2-{2-[(2,5-dimethylphenoxy)methyl]phenyl}-2-methoxy-N-methylacetamide (394657-24-0).

(4) Inhibitors of the mitosis and cell division, for example (4.1) benomyl (17804-35-2), (4.2) carbendazim (10605-21-7), (4.3) chlorfenazole (3574-96-7), (4.4) diethofencarb (87130-20-9), (4.5) ethaboxam (162650-77-3), (4.6) fluopicolide (239110-15-7), (4.7) fuberidazole (3878-19-1), (4.8) pencycuron (66063-05-6), (4.9) thiabendazole (148-79-8), (4.10) thiophanate-methyl (23564-05-8), (4.11) thiophanate (23564-06-9), (4.12) zoxamide (156052-68-5), (4.13) 5-chloro-7-(4-methylpiperidin-1-yl)-6-(2,4,6-trifluorophenyl)[1,2,4]triazolo[1,5-a]pyrimidine (214706-53-3) and (4.14) 3-chloro-5-(6-chloropyridin-3-yl)-6-methyl-4-(2,4,6-trifluorophenyl)pyridazine (1002756-87-7).

(5) Compounds capable to have a multisite action, like for example (5.1) bordeaux mixture (8011-63-0), (5.2) captafol (2425-06-1), (5.3) captan (133-06-2) (WO 02/12172), (5.4) chlorothalonil (1897-45-6), (5.5) copper hydroxide (20427-59-2), (5.6) copper naphthenate (1338-02-9), (5.7) copper oxide (1317-39-1), (5.8) copper oxychloride (1332-40-7), (5.9) copper(2+) sulfate (7758-98-7), (5.10) dichlofluanid (1085-98-9), (5.11) dithianon (3347-22-6), (5.12) dodine (2439-10-3), (5.13) dodine free base, (5.14) ferbam (14484-64-1), (5.15) fluorofolpet (719-96-0), (5.16) folpet (133-07-3), (5.17) guazatine (108173-90-6), (5.18) guazatine acetate, (5.19) iminoctadine (13516-27-3), (5.20) iminoctadine albesilate (169202-06-6), (5.21) iminoctadine triacetate (57520-17-9), (5.22) mancopper (53988-93-5), (5.23) mancozeb (8018-01-7), (5.24) maneb (12427-38-2), (5.25) metiram (9006-42-2), (5.26) metiram zinc (9006-42-2), (5.27) oxine-copper (10380-28-6), (5.28) propamidine (104-32-5), (5.29) propineb (12071-83-9), (5.30) sulphur and sulphur preparations including calcium polysulphide (7704-34-9), (5.31) thiram (137-26-8), (5.32) tolylfluanid (731-27-1), (5.33) zineb (12122-67-7) and (5.34) ziram (137-30-4).

(6) Compounds capable to induce a host defence, for example (6.1) acibenzolar-5-methyl (135158-54-2), (6.2) isotianil (224049-04-1), (6.3) probenazole (27605-76-1) and (6.4) tiadinil (223580-51-6).

(7) Inhibitors of the amino acid and/or protein biosynthesis, for example (7.1) andoprim (23951-85-1), (7.2) blasticidin-S (2079-00-7), (7.3) cyprodinil (121552-61-2), (7.4) kasugamycin (6980-18-3), (7.5) kasugamycin hydrochloride hydrate (19408-46-9), (7.6) mepanipyrim (110235-47-7), (7.7) pyrimethanil (53112-28-0) and (7.8) 3-(5-fluoro-3,3,4,4-tetramethyl-3,4-dihydroisoquinolin-1-yl)quinoline (861647-32-7) (WO2005070917).

(8) Inhibitors of the ATP production, for example (8.1) fentin acetate (900-95-8), (8.2) fentin chloride (639-58-7), (8.3) fentin hydroxide (76-87-9) and (8.4) silthiofam (175217-20-6).

(9) Inhibitors of the cell wall synthesis, for example (9.1) benthiavalicarb (177406-68-7), (9.2) dimethomorph (110488-70-5), (9.3) flumorph (211867-47-9), (9.4) iprovalicarb (140923-17-7), (9.5) mandipropamid (374726-62-2), (9.6) polyoxins (11113-80-7), (9.7) polyoxorim (22976-86-9), (9.8) validamycin A (37248-47-8) and (9.9) valifenalate (283159-94-4; 283159-90-0).

(10) Inhibitors of the lipid and membrane synthesis, for example (10.1) biphenyl (92-52-4), (10.2) chloroneb (2675-77-6), (10.3) dicloran (99-30-9), (10.4) edifenphos (17109-49-8), (10.5) etridiazole (2593-15-9), (10.6) iodocarb (55406-53-6), (10.7) iprobenfos (26087-47-8), (10.8) isoprothiolane (50512-35-1), (10.9) propamocarb (25606-41-1), (10.10) propamocarb hydrochloride (25606-41-1), (10.11) prothiocarb (19622-08-3), (10.12) pyrazophos (13457-18-6), (10.13) quintozene (82-68-8), (10.14) tecnazene (117-18-0) and (10.15) tolclofos-methyl (57018-04-9).

(11) Inhibitors of the melanine biosynthesis, for example (11.1) carpropamid (104030-54-8), (11.2) diclocymet (139920-32-4), (11.3) fenoxanil (115852-48-7), (11.4) phthalide (27355-22-2), (11.5) pyroquilon (57369-32-1), (11.6) tricyclazole (41814-78-2) and (11.7) 2,2,2-trifluoroethyl {3-methyl-1-[(4-methylbenzoyl)amino]butan-2-yl}carbamate (851524-22-6) (WO2005042474).

(12) Inhibitors of the nucleic acid synthesis, for example (12.1) benalaxyl (71626-11-4), (12.2) benalaxyl-M (kiralaxyl) (98243-83-5), (12.3) bupirimate (41483-43-6), (12.4) clozylacon (67932-85-8), (12.5) dimethirimol (5221-53-4), (12.6) ethirimol (23947-60-6), (12.7) furalaxyl (57646-30-7), (12.8) hymexazol (10004-44-1), (12.9) metalaxyl (57837-19-1), (12.10) metalaxyl-M (mefenoxam) (70630-17-0), (12.11) ofurace (58810-48-3), (12.12) oxadixyl (77732-09-3) and (12.13) oxolinic acid (14698-29-4).

(13) Inhibitors of the signal transduction, for example (13.1) chlozolinate (84332-86-5), (13.2) fenpiclonil (74738-17-3), (13.3) fludioxonil (131341-86-1), (13.4) iprodione (36734-19-7), (13.5) procymidone (32809-16-8), (13.6) quinoxyfen (124495-18-7) and (13.7) vinclozolin (50471-44-8).

(14) Compounds capable to act as an uncoupler, for example (14.1) binapacryl (485-31-4), (14.2) dinocap (131-72-6), (14.3) ferimzone (89269-64-7), (14.4) fluazinam (79622-59-6) and (14.5) meptyldinocap (131-72-6).

(15) Further compounds, for example (15.1) benthiazole (21564-17-0), (15.2) bethoxazin (163269-30-5), (15.3) capsimycin (70694-08-5), (15.4) carvone (99-49-0), (15.5) chinomethionat (2439-01-2), (15.6) pyriofenone (chlazafenone) (688046-61-9), (15.7) cufraneb (11096-18-7), (15.8) cyflufenamid (180409-60-3), (15.9) cymoxanil (57966-95-7), (15.10) cyprosulfamide (221667-31-8), (15.11) dazomet (533-74-4), (15.12) debacarb (62732-91-6), (15.13) dichlorophen (97-23-4), (15.14) diclomezine (62865-36-5), (15.15) difenzoquat (49866-87-7), (15.16) difenzoquat methylsulphate (43222-48-6), (15.17) diphenylamine (122-39-4), (15.18) ecomate, (15.19) fenpyrazamine (473798-59-3), (15.20) flumetover (154025-04-4), (15.21) fluoroimide (41205-21-4), (15.22) flusulfamide (106917-52-6), (15.23) flutianil (304900-25-2), (15.24) fosetyl-aluminium (39148-24-8), (15.25) fosetyl-calcium, (15.26) fosetyl-sodium (39148-16-8), (15.27) hexachlorobenzene (118-74-1), (15.28) irumamycin (81604-73-1), (15.29) methasulfocarb (66952-49-6), (15.30) methyl isothiocyanate (556-61-6), (15.31) metrafenone (220899-03-6), (15.32) mildiomycin (67527-71-3), (15.33) natamycin (7681-93-8), (15.34) nickel dimethyldithiocarbamate (15521-65-0), (15.35) nitrothal-isopropyl (10552-74-6), (15.36) octhilinone (26530-20-1), (15.37) oxamocarb (917242-12-7), (15.38) oxyfenthiin (34407-87-9), (15.39) pentachlorophenol and salts (87-86-5), (15.40) phenothrin, (15.41) phosphorous acid and its salts (13598-36-2), (15.42) propamocarb-fosetylate, (15.43) propanosine-sodium (88498-02-6), (15.44) proquinazid (189278-12-4), (15.45) pyrimorph (868390-90-3), (15.45e) (2 E)-3-(4-tert-butylphenyl)-3-(2-chloropyridin-4-yl)-1-(morpholin-4-yl)prop-2-en-1-one (1231776-28-5), (15.45z) (2 Z)-3-(4-tert-butylphenyl)-3-(2-chloropyridin-4-yl)-1-(morpholin-4-yl)prop-2-en-1-one (1231776-29-6), (15.46) pyrroInitrine (1018-71-9) (EP-A 1 559 320), (15.47) tebufloquin (376645-78-2), (15.48) tecloftalam (76280-91-6), (15.49) tolnifanide (304911-98-6), (15.50) triazoxide (72459-58-6), (15.51) trichlamide (70193-21-4), (15.52) zarilamid (84527-51-5), (15.53) (3S,6S,7R,8R)-8-benzyl-3-[({3-[(isobutyryloxy)methoxy]-4-methoxypyridin-2-yl}carbonyl)amino]-6-methyl-4,9-dioxo-1,5-dioxonan-7-yl 2-methylpropanoate (517875-34-2) (WO2003035617), (15.54) 1-(4-{4-[(5R)-5-(2,6-difluorophenyl)-4,5-dihydro-1,2-oxazol-3-yl]-1,3-thiazol-2-yl} piperidin-1-yl)-2-[5-methyl-3-(trifluoromethyl)-1H-pyrazol-1-yl]ethanone (1003319-79-6) (WO 2008013622), (15.55) 1-(4-{4-[(5S)-5-(2,6-difluorophenyl)-4,5-dihydro-1,2-oxazol-3-yl]-1,3-thiazol-2-yl} piperidin-1-yl)-2-[5-methyl-3-(trifluoromethyl)-1H-pyrazol-1-yl]ethanone (1003319-80-9) (WO 2008013622), (15.56) 1-(4-{4-[5-(2,6-difluorophenyl)-4,5-dihydro-1,2-oxazol-3-yl]-1,3-thiazol-2-yl} piperidin-1-yl)-2-[5-methyl-3-(trifluoromethyl)-1H-pyrazol-1-yl]ethanone (1003318-67-9) (WO 2008013622), (15.57) 1-(4-methoxyphenoxy)-3,3-dimethylbutan-2-yl1H-imidazole-1-carboxylate (111227-17-9), (15.58) 2,3,5,6-tetrachloro-4-(methylsulfonyl)pyridine (13108-52-6), (15.59) 2,3-dibutyl-6-chlorothieno[2,3-d]pyrimidin-4(3H)-one (221451-58-7), (15.60) 2,6-dimethyl-1H,5H-[1,4]dithiino[2,3-c:5,6-c′]dipyrrole-1,3,5,7(2H,6H)-tetrone, (15.61) 2-[5-methyl-3-(trifluoromethyl)-1H-pyrazol-1-yl]-1-(4-{4-[(5R)-5-phenyl-4,5-dihydro-1,2-oxazol-3-yl]-1,3-thiazol-2-yl}piperidin-1-yl)ethanone (1003316-53-7) (WO 2008013622), (15.62) 2[5-methyl-3-(trifluoromethyl)-1H-pyrazol-1-yl]-1-(4-{4-[(5S)-5-phenyl-4,5-dihydro-1,2-oxazol-3-yl]-1,3-thiazol-2-yl}piperidin-1-yl)ethanone (1003316-54-8) (WO 2008013622), (15.63) 2-[5-methyl-3-(trifluoromethyl)-1H-pyrazol-1-yl]-1-{4-[4-(5-phenyl-4,5-dihydro-1,2-oxazol-3-yl)-1,3-thiazol-2-yl]piperidin-1-yl}ethanone (1003316-51-5) (WO 2008013622), (15.64) 2-butoxy-6-iodo-3-propyl-4H-chromen-4-one, (15.65) 2-chloro-5-[2-chloro-1-(2,6-difluoro-4-methoxyphenyl)-4-methyl-1H-imidazol-5-yl]pyridine, (15.66) 2-phenylphenol and salts (90-43-7), (15.67) 3-(4,4,5-trifluoro-3,3-dimethyl-3,4-dihydroisoquinolin-1-yl)quinoline (861647-85-0) (WO2005070917), (15.68) 3,4,5-trichloropyridine-2,6-dicarbonitrile (17824-85-0), (15.69) 3-[5-(4-chlorophenyl)-2,3-dimethyl-1,2-oxazolidin-3-yl]pyridine, (15.70) 3-chloro-5-(4-chlorophenyl)-4-(2,6-difluorophenyl)-6-methylpyridazine, (15.71) 4-(4-chlorophenyl)-5-(2,6-difluorophenyl)-3,6-dimethylpyridazine, (15.72) 5-amino-1,3,4-thiadiazole-2-thiol, (15.73) 5-chloro-N′-phenyl-N′-(prop-2-yn-1-yl)thiophene-2-sulfonohydrazide (134-31-6), (15.74) 5-fluoro-2-[(4-fluorobenzyl)oxy]pyrimidin-4-amine (1174376-11-4) (WO2009094442), (15.75) 5-fluoro-2-[(4-methylbenzyl)oxy]pyrimidin-4-amine (1174376-25-0) (WO2009094442), (15.76) 5-methyl-6-octyl[1,2,4]triazolo[1,5-a]pyrimidin-7-amine, (15.77) ethyl (2Z)-3-amino-2-cyano-3-phenylprop-2-enoate, (15.78) N′-(4-{[3-(4-chlorobenzyl)-1,2,4-thiadiazol-5-yl]oxy}-2,5-dimethylphenyl)-N-ethyl-N-methylimidoformamide, (15.79) N-(4-chlorobenzyl)-3-[3-methoxy-4-(prop-2-yn-1-yloxy)phenyl]propanamide, (15.80) N-[(4-chlorophenyl)(cyano)methyl]-3-[3-methoxy-4-(prop-2-yn-1-yloxy)phenyl]propanamide, (15.81) N-[(5-bromo-3-chloropyridin-2-yl)methyl]-2,4-dichloropyridine-3-carboxamide, (15.82) N-[1-(5-bromo-3-chloropyridin-2-yl)ethyl]-2,4-dichloropyridine-3-carboxamide, (15.83) N-[1-(5-bromo-3-chloropyridin-2-yl)ethyl]-2-fluoro-4-iodopyridine-3-carboxamide, (15.84) N-{(E)-[(cyclopropylmethoxy)imino][6-(difluoromethoxy)-2,3-difluorophenyl]methyl}-2-phenylacetamide (221201-92-9), (15.85) N-{(Z)-[(cyclopropylmethoxy)imino][6-(difluoromethoxy)-2,3-difluorophenyl]methyl}-2-phenylacetamide (221201-92-9), (15.86) N′-{4-[(3-tert-butyl-4-cyano-1,2-thiazol-5-yl)oxy]-2-chloro-5-methylphenyl}-N-ethyl-N-methylimidoformamide, (15.87) N-methyl-2-(1-{[5-methyl-3-(trifluoromethyl)-1H-pyrazol-1-yl]acetyl}piperidin-4-yl)-N-(1,2,3,4-tetrahydronaphthalen-1-yl)-1,3-thiazole-4-carboxamide (922514-49-6) (WO 2007014290), (15.88) N-methyl-2-(1-{[5-methyl-3-(trifluoromethyl)-1H-pyrazol-1-yl]acetyl}piperidin-4-yl)-N-[(1R)-1,2,3,4-tetrahydronaphthalen-1-yl]-1,3-thiazole-4-carboxamide (922514-07-6) (WO 2007014290), (15.89) N-methyl-2-(1-{[5-methyl-3-(trifluoromethyl)-1H-pyrazol-1-yl]acetyl}piperidin-4-yl)-N-[(1S)-1,2,3,4-tetrahydronaphthalen-1-yl]-1,3-thiazole-4-carboxamide (922514-48-5) (WO 2007014290), (15.90) pentyl {6-[({[(1-methyl-1H-tetrazol-5-yl)(phenyl)methylidene]amino}oxy)methyl]pyridin-2-yl}carbamate, (15.91) phenazine-1-carboxylic acid, (15.92) quinolin-8-ol (134-31-6), (15.93) quinolin-8-ol sulfate (2:1) (134-31-6) and (15.94) tert-butyl {6-[({[(1-methyl-1H-tetrazol-5-yl)(phenyl)methylene]amino}oxy)methyl]pyridin-2-yl}carbamate.

(16) Further compounds, for example (16.1) 1-methyl-3-(trifluoromethyl)-N-[2′-(trifluoromethyl)biphenyl-2-yl]-1H-pyrazole-4-carboxamide, (16.2) N-(4′-chlorobiphenyl-2-yl)-3-(difluoromethyl)-1-methyl-1H-pyrazole-4-carboxamide, (16.3) N-(2′,4′-dichlorobiphenyl-2-yl)-3-(difluoromethyl)-1-methyl-1H-pyrazole-4-carboxamide, (16.4) 3-(difluoromethyl)-1-methyl-N-[4′-(trifluoromethyl)biphenyl-2-yl]-1H-pyrazole-4-carboxamide, (16.5) N-(2′,5′-difluorobiphenyl-2-yl)-1-methyl-3-(trifluoromethyl)-1H-pyrazole-4-carboxamide, (16.6) 3-(difluoromethyl)-1-methyl-N-[4′-(prop-1-yn-1-yl)biphenyl-2-yl]-1H-pyrazole-4-carboxamide (known from WO 2004/058723), (16.7) 5-fluoro-1,3-dimethyl-N-[4′-(prop-1-yn-1-yl)biphenyl-2-yl]-1H-pyrazole-4-carboxamide (known from WO 2004/058723), (16.8) 2-chloro-N-[4′-(prop-1-yn-1-yl)biphenyl-2-yl]pyridine-3-carboxamide (known from WO 2004/058723), (16.9) 3-(difluoromethyl)-N-[4′-(3,3-dimethylbut-1-yn-1-yl)biphenyl-2-yl]-1-methyl-1H-pyrazole-4-carboxamide (known from WO 2004/058723), (16.10) N-[4′-(3,3-dimethylbut-1-yn-1-yl)biphenyl-2-yl]-5-fluoro-1,3-dimethyl-H-pyrazole-4-carboxamide (known from WO 2004/058723), (16.11) 3-(difluoromethyl)-N-(4′-ethynylbiphenyl-2-yl)-1-methyl-1H-pyrazole-4-carboxamide (known from WO 2004/058723), (16.12) N-(4′-ethynylbiphenyl-2-yl)-5-fluoro-1,3-dimethyl-1H-pyrazole-4-carboxamide (known from WO 2004/058723), (16.13) 2-chloro-N-(4′-ethynylbiphenyl-2-yl)pyridine-3-carboxamide (known from WO 2004/058723), (16.14) 2-chloro-N-[4′-(3,3-dimethylbut-1-yn-1-yl)biphenyl-2-yl]pyridine-3-carboxamide (known from WO 2004/058723), (16.15) 4-(difluoromethyl)-2-methyl-N-[4′-(trifluoromethyl)biphenyl-2-yl]-1,3-thiazole-5-carboxamide (known from WO 2004/058723), (16.16) 5-fluoro-N-[4′-(3-hydroxy-3-methylbut-1-yn-1-yl)biphenyl-2-yl]-1,3-dimethyl-1H-pyrazole-4-carboxamide (known from WO 2004/058723), (16.17) 2-chloro-N-[4′-(3-hydroxy-3-methylbut-1-yn-1-yl)biphenyl-2-yl]pyridine-3-carboxamide (known from WO 2004/058723), (16.18) 3-(difluoromethyl)-N-[4′-(3-methoxy-3-methylbut-1-yn-1-yl)biphenyl-2-yl]-1-methyl-1H-pyrazole-4-carboxamide (known from WO 2004/058723), (16.19) 5-fluoro-N-[4′-(3-methoxy-3-methylbut-1-yn-1-yl)biphenyl-2-yl]-1,3-dimethyl-1H-pyrazole-4-carboxamide (known from WO 2004/058723), (16.20) 2-chloro-N-[4′-(3-methoxy-3-methylbut-1-yn-1-yl)biphenyl-2-yl]pyridine-3-carboxamide (known from WO 2004/058723), (16.21) (5-bromo-2-methoxy-4-methylpyridin-3-yl)(2,3,4-trimethoxy-6-methylphenyl)methanone (known from EP-A 1 559 320), (16.22) N-[2-(4-{[3-(4-chlorophenyl)prop-2-yn-1-yl]oxy}-3-methoxyphenyl)ethyl]-N2-(methylsulfonyl)valinamide (220706-93-4), (16.23) 4-oxo-4-[(2-phenylethyl)amino]butanoic acid and (16.24) but-3-yn-1-yl {6-[({[(Z)-(1-methyl-1H-tetrazol-5-yl)(phenyl)methylene]amino}oxy)methyl]pyridin-2-yl}carbamate.

All named mixing partners of the classes (1) to (16) can, if their functional groups enable this, optionally form salts with suitable bases or acids.

Examples of bactericides which may be mentioned are:

bronopol, dichlorophen, nitrapyrin, nickel dimethyldithiocarbamate, kasugamycin, octhilinone, furancarboxylic acid, oxytetracycline, probenazole, streptomycin, tecloftalam, copper sulphate and other copper preparations.

The active ingredients specified herein by their “common name” are known and described, for example, in the Pesticide Manual (“The Pesticide Manual”, 14th Ed., British Crop Protection Council 2006) or can be searched in the internet (e.g. http://www.alanwood.net/pesticides).

(1) Acetylcholinesterase (AChE) inhibitors, for example

carbamates, e.g. Alanycarb, Aldicarb, Bendiocarb, Benfuracarb, Butocarboxim, Butoxycarboxim, Carbaryl, Carbofuran, Carbosulfan, Ethiofencarb, Fenobucarb, Formetanate, Furathiocarb, Isoprocarb, Methiocarb, Methomyl, Metolcarb, Oxamyl, Pirimicarb, Propoxur, Thiodicarb, Thiofanox, Triazamate, Trimethacarb, XMC, and Xylylcarb; or organophosphates, e.g. Acephate, Azamethiphos, Azinphos-ethyl, Azinphos-methyl, Cadusafos, Chlorethoxyfos, Chlorfenvinphos, Chlormephos, Chlorpyrifos, Chlorpyrifos-methyl, Coumaphos, Cyanophos, Demeton-5-methyl, Diazinon, Dichlorvos/DDVP, Dicrotophos, Dimethoate, Dimethylvinphos, Disulfoton, EPN, Ethion, Ethoprophos, Famphur, Fenamiphos, Fenitrothion, Fenthion, Fosthiazate, Heptenophos, Imicyafos, Isofenphos, Isopropyl O-(methoxyaminothio-phosphoryl) salicylate, Isoxathion, Malathion, Mecarbam, Methamidophos, Methidathion, Mevinphos, Monocrotophos, Naled, Omethoate, Oxydemeton-methyl, Parathion, Parathion-methyl, Phenthoate, Phorate, Phosalone, Phosmet, Phosphamidon, Phoxim, Pirimiphos-methyl, Profenofos, Propetamphos, Prothiofos, Pyraclofos, Pyridaphenthion, Quinalphos, Sulfotep, Tebupirimfos, Temephos, Terbufos, Tetrachlorvinphos, Thiometon, Triazophos, Trichlorfon, and Vamidothion.

(2) GABA-gated chloride channel antagonists, for example

cyclodiene organochlorines, e.g. Chlordane and Endosulfan; or

phenylpyrazoles (fiproles), e.g. Ethiprole and Fipronil.

(3) Sodium channel modulators/voltage-dependent sodium channel blockers, for example

pyrethroids, e.g. Acrinathrin, Allethrin, d-cis-trans Allethrin, d-trans Allethrin, Bifenthrin, Bioallethrin, Bioallethrin S-cyclopentenyl isomer, Bioresmethrin, Cycloprothrin, Cyfluthrin, beta-Cyfluthrin, Cyhalothrin, lambda-Cyhalothrin, gamma-Cyhalothrin, Cypermethrin, alpha-Cypermethrin, beta-Cypermethrin, theta-Cypermethrin, zeta-Cypermethrin, Cyphenothrin [(1R)-trans isomers], Deltamethrin, Empenthrin [(EZ)-(1R) isomers), Esfenvalerate, Etofenprox, Fenpropathrin, Fenvalerate, Flucythrinate, Flumethrin, tau-Fluvalinate, Halfenprox, Imiprothrin, Kadethrin, Permethrin, Phenothrin [(1R)-trans isomer), Prallethrin, Pyrethrine (pyrethrum), Resmethrin, Silafluofen, Tefluthrin, Tetramethrin, Tetramethrin [(1R) isomers)], Tralomethrin, and Transfluthrin; or

DDT; or Methoxychlor.

(4) Nicotinic acetylcholine receptor (nAChR) agonists, for example

neonicotinoids, e.g. Acetamiprid, Clothianidin, Dinotefuran, Imidacloprid, Nitenpyram, Thiacloprid, and Thiamethoxam; or

Nicotine.

(5) Nicotinic acetylcholine receptor (nAChR) allosteric activators, for example

spinosyns, e.g. Spinetoram and Spinosad.

(6) Chloride channel activators, for example

avermectins/milbemycins, e.g. Abamectin, Emamectin benzoate, Lepimectin, and Milbemectin.

(7) Juvenile hormone mimics, for example

juvenile hormon analogues, e.g. Hydroprene, Kinoprene, and Methoprene; or

Fenoxycarb; or Pyriproxyfen.

(8) Miscellaneous non-specific (multi-site) inhibitors, for example

alkyl halides, e.g. Methyl bromide and other alkyl halides; or

Chloropicrin; or Sulfuryl fluoride; or Borax; or Tartar emetic.

(9) Selective homopteran feeding blockers, e.g. Pymetrozine; or Flonicamid.

(10) Mite growth inhibitors, e.g. Clofentezine, Hexythiazox, and Diflovidazin; or

Etoxazole.

(11) Microbial disruptors of insect midgut membranes, e.g. Bacillus thuringiensis subspecies israelensis, Bacillus sphaericus, Bacillus thuringiensis subspecies aizawai, Bacillus thuringiensis subspecies kurstaki, Bacillus thuringiensis subspecies tenebrionis, and BT crop proteins: Cry1Ab, Cry1Ac, Cry1Fa, Cry2Ab, mCry3A, Cry3Ab, Cry3Bb, Cry34/35Abl.

(12) Inhibitors of mitochondrial ATP synthase, for example Diafenthiuron; or

organotin miticides, e.g. Azocyclotin, Cyhexatin, and Fenbutatin oxide; or

Propargite; or Tetradifon.

(13) Uncouplers of oxidative phoshorylation via disruption of the proton gradient, for example Chlorfenapyr, DNOC, and Sulfluramid.

(14) Nicotinic acetylcholine receptor (nAChR) channel blockers, for example Bensultap, Cartap hydrochloride, Thiocyclam, and Thiosultap-sodium.

(15) Inhibitors of chitin biosynthesis, type 0, for example Bistrifluoron, Chlorfluazuron, Diflubenzuron, Flucycloxuron, Flufenoxuron, Hexaflumuron, Lufenuron, Novaluron, Noviflumuron, Teflubenzuron, and Triflumuron.

(16) Inhibitors of chitin biosynthesis, type 1, for example Buprofezin.

(17) Moulting disruptors, for example Cyromazine.

(18) Ecdysone receptor agonists, for example Chromafenozide, Halofenozide, Methoxyfenozide, and Tebufenozide.

(19) Octopamine receptor agonists, for example Amitraz.

(20) Mitochondrial complex III electron transport inhibitors, for example Hydramethylnon; or Acequinocyl; or Fluacrypyrim.

(21) Mitochondrial complex I electron transport inhibitors, for example

METI acaricides, e.g. Fenazaquin, Fenpyroximate, Pyrimidifen, Pyridaben, Tebufenpyrad, and Tolfenpyrad; or

Rotenone (Derris).

(22) Voltage-dependent sodium channel blockers, e.g. Indoxacarb; or Metaflumizone.

(23) Inhibitors of acetyl CoA carboxylase, for example

tetronic and tetramic acid derivatives, e.g. Spirodiclofen, Spiromesifen, and Spirotetramat.

(24) Mitochondrial complex IV electron transport inhibitors, for example

phosphines, e.g. Aluminium phosphide, Calcium phosphide, Phosphine, and Zinc phosphide; or

Cyanide.

(25) Mitochondrial complex II electron transport inhibitors, for example Cyenopyrafen.

(28) Ryanodine receptor modulators, for example

diamides, e.g. Chlorantraniliprole, Cyantraniliprole and Flubendiamide.

Further active ingredients with unknown or uncertain mode of action, for example Amidoflumet, Azadirachtin, Benclothiaz, Benzoximate, Bifenazate, Bromopropylate, Chinomethionat, Cryolite, Cyantraniliprole (Cyazypyr), Cyflumetofen, Dicofol, Diflovidazin, Fluensulfone, Flufenerim, Flufiprole, Fluopyram, Fufenozide, Imidaclothiz, Iprodione, Meperfluthrin, Pyridalyl, Pyrifluquinazon, Tetramethylfluthrin, and iodomethane; furthermore products based on Bacillus firmus (including but not limited to strain CNCM 1-1582, such as, for example, VOTiVO™, BioNem) or one of the following known active compounds: 3-bromo-N-{2-bromo-4-chloro-6-[(1-cyclopropylethyl)carbamoyl]phenyl}-1-(3-chloropyridin-2-yl)-1H-pyrazole-5-carboxamide (known from WO2005/077934), 4-{[(6-bromopyridin-3-yl)methyl](2-fluoroethyl)amino}furan-2(5H)-one (known from WO2007/115644), 4-{[(6-fluoropyridin-3-yl)methyl](2,2-difluoroethyl)amino}furan-2(5H)-one (known from WO2007/115644), 4-{[(2-chloro-1,3-thiazol-5-yl)methyl](2-fluoroethyl)amino}furan-2(5H)-one (known from WO2007/115644), 4-{[(6-chlorpyridin-3-yl)methyl](2-fluoroethyl)amino}furan-2(5H)-one (known from WO2007/115644), Flupyradifurone, 4-{[(6-chlor-5-fluoropyridin-3-yl)methyl](methyl)amino}furan-2(5H)-one (known from WO2007/115643), 4-{[(5,6-dichloropyridin-3-yl)methyl](2-fluoroethyl)amino}furan-2(5H)-one (known from WO2007/115646), 4-{[(6-chloro-5-fluoropyridin-3-yl)methyl](cyclopropyl)amino}furan-2(5H)-one (known from WO2007/115643), 4-{[(6-chloropyridin-3-yl)methyl](cyclopropyl)amino}furan-2(5H)-one (known from EP-A-0 539 588), 4-{[(6-chlorpyridin-3-yl)methyl](methyl)amino}furan-2(5H)-one (known from EP-A-0 539 588), {[1-(6-chloropyridin-3-yl)ethyl](methyl)oxido-λ⁴-sulfanylidene}cyanamide (known from WO2007/149134) and its diastereomers {[(1R)-1-(6-chloropyridin-3-yl)ethyl](methyl)oxido-λ⁴-sulfanylidene}cyanamide (A) and {[(1S)-1-(6-chloropyridin-3-yl)ethyl](methyl)oxido-λ⁴-sulfanylidene}cyanamide (B) (also known from WO2007/149134) as well as Sulfoxaflor and its diastereomers [(R)-methyl(oxido) {(1R)-1-[6-(trifluoromethyl)pyridin-3-yl]ethyl}-λ⁴-sulfanylidene]cyanamide (A1) and [(S)-methyl(oxido){(1S)-1-[6-(trifluoromethyl)pyridin-3-yl]ethyl}-λ⁴-sulfanylidene]cyanamide (A2), referred to as group of diastereomers A (known from WO2010/074747, WO2010/074751), [(R)-methyl(oxido) {(1S)-1-[6-(trifluoromethyl)pyridin-3-yl]ethyl}-λ⁴-sulfanylidene]cyanamide (B1) and [(S)-methyl(oxido) {(1R)-1-[6-(trifluoromethyl)pyridin-3-yl]ethyl}-λ⁴-sulfanylidene]cyanamide (B2), referred to as group of diastereomers B (also known from WO2010/074747, WO2010/074751), and 11-(4-chloro-2,6-dimethylphenyl)-12-hydroxy-1,4-dioxa-9-azadispiro[4.2.4.2]tetradec-11-en-10-one (known from WO2006/089633), 3-(4′-fluoro-2,4-dimethylbiphenyl-3-yl)-4-hydroxy-8-oxa-1-azaspiro[4.5]dec-3-en-2-one (known from WO2008/067911), 1-{2-fluoro-4-methyl-5-[(2,2,2-trifluorethyl)sufinyl]phenyl}-3-(trifluoromethyl)-1H-1,2,4-triazol-5-amine (known from WO2006/043635), [(3S,4aR,12R,12aS,12bS)-3-[(cyclopropylcarbonyl)oxy]-6,12-dihydroxy-4,12b-dimethyl-11-oxo-9-(pyridin-3-yl)-1,3,4,4a,5,6,6a,12,12a,12b-decahydro-2H,11H-benzo[f]pyrano[4,3-b]chromen-4-yl]methyl cyclopropanecarboxylate (known from WO2008/066153), 2-cyano-3-(difluoromethoxy)-N,N-dimethylbenzenesulfonamide (known from WO2006/056433), 2-cyano-3-(difluoromethoxy)-N-methylbenzenesulfonamide (known from WO2006/100288), 2-cyano-3-(difluoromethoxy)-N-ethylbenzenesulfonamide (known from WO2005/035486), 4-(difluoromethoxy)-N-ethyl-N-methyl-1,2-benzothiazol-3-amine 1,1-dioxide (known from WO2007/057407), N-[1-(2,3-dimethylphenyl)-2-(3,5-dimethylphenyl)ethyl]-4,5-dihydro-1,3-thiazol-2-amine (known from WO2008/104503), {1′-[(2E)-3-(4-chlorophenyl)prop-2-en-1-yl]-5-fluorospiro[indole-3,4′-piperidin]-1(2H)-yl}(2-chloropyridin-4-yl)methanone (known from WO2003/106457), 3-(2,5-dimethylphenyl)-4-hydroxy-8-methoxy-1,8-diazaspiro[4.5]dec-3-en-2-one (known from WO2009/049851), 3-(2,5-dimethylphenyl)-8-methoxy-2-oxo-1,8-diazaspiro[4.5]dec-3-en-4-yl ethyl carbonate (known from WO2009/049851), 4-(but-2-yn-1-yloxy)-6-(3,5-dimethylpiperidin-1-yl)-5-fluoropyrimidine (known from WO2004/099160), (2,2,3,3,4,4,5,5-octafluoropentyl)(3,3,3-trifluoropropyl)malononitrile (known from WO2005/063094), (2,2,3,3,4,4,5,5-octafluoropentyl)(3,3,4,4,4-pentafluorobutyl)malononitrile (known from WO2005/063094), 8-[2-(cyclopropylmethoxy)-4-(trifluoromethyl)phenoxy]-3-[6-(trifluoromethyl)pyridazin-3-yl]-3-azabicyclo[3.2.1]octane (known from WO2007/040280), Flometoquin, PF1364 (CAS-Reg. No. 1204776-60-2) (known from JP2010/018586), 5-[5-(3,5-dichlorophenyl)-5-(trifluoromethyl)-4,5-dihydro-1,2-oxazol-3-yl]-2-(1H-1,2,4-triazol-1-yl)benzonitrile (known from WO2007/075459), 5-[5-(2-chloropyridin-4-yl)-5-(trifluoromethyl)-4,5-dihydro-1,2-oxazol-3-yl]-2-(1H-1,2,4-triazol-1-yl)benzonitrile (known from WO2007/075459), 4-[5-(3,5-dichlorophenyl)-5-(trifluoromethyl)-4,5-dihydro-1,2-oxazol-3-yl]-2-methyl-N-{2-oxo-2-[(2,2,2-trifluoroethyl)amino]ethyl}benzamide (known from WO2005/085216), 4-{[(6-chloropyridin-3-yl)methyl](cyclopropyl)amino}-1,3-oxazol-2(5H)-one, 4-{[(6-chloropyridin-3-yl)methyl](2,2-difluoroethyl)amino}-1,3-oxazol-2(5H)-one, 4-{[(6-chloropyridin-3-yl)methyl](ethyl)amino}-1,3-oxazol-2(5H)-one, 4-{[(6-chloropyridin-3-yl)methyl](methyl)amino}-1,3-oxazol-2(5H)-one (all known from WO2010/005692), NNI-0711 (known from WO2002/096882), 1-acetyl-N-[4-(1,1,1,3,3,3-hexafluoro-2-methoxypropan-2-yl)-3-isobutylphenyl]-N-isobutyryl-3,5-dimethyl-1H-pyrazole-4-carboxamide (known from WO2002/096882), methyl 2-[2-({[3-bromo-1-(3-chloropyridin-2-yl)-1H-pyrazol-5-yl]carbonyl}amino)-5-chloro-3-methylbenzoyl]-2-methylhydrazinecarboxylate (known from WO2005/085216), methyl 2-[2-({[3-bromo-1-(3-chloropyridin-2-yl)-1H-pyrazol-5-yl]carbonyl}amino)-5-cyano-3-methylbenzoyl]-2-ethylhydrazinecarboxylate (known from WO2005/085216), methyl 2-[2-({[3-bromo-1-(3-chloropyridin-2-yl)-1H-pyrazol-5-yl]carbonyl}amino)-5-cyano-3-methylbenzoyl]-2-methylhydrazinecarboxylate (known from WO2005/085216), methyl 2-[3,5-dibromo-2-({[3-bromo-1-(3-chloropyridin-2-yl)-1H-pyrazol-5-yl]carbonyl}amino)benzoyl]-1,2-diethylhydrazinecarboxylate (known from WO2005/085216), methyl 2-[3,5-dibromo-2-({[3-bromo-1-(3-chloropyridin-2-yl)-1H-pyrazol-5-yl]carbonyl}amino)benzoyl]-2-ethylhydrazinecarboxylate (known from WO2005/085216), (5RS,7RS;5RS,7SR)-1-(6-chloro-3-pyridylmethyl)-1,2,3,5,6,7-hexahydro-7-methyl-8-nitro-5-propoxyimidazo[1,2-a]pyridine (known from WO2007/101369, N-[2-(5-amino-1,3,4-thiadiazol-2-yl)-4-chloro-6-methylphenyl]-3-bromo-1-(3-chloropyridin-2-yl)-1H-pyrazole-5-carboxamide (known from CN102057925), and methyl 2-[3,5-dibromo-2-({[3-bromo-1-(3-chloropyridin-2-yl)-1H-pyrazol-5-yl]carbonyl}amino)benzoyl]-2-ethyl-1-methylhydrazinecarboxylate (known from WO2011/049233).

Examples of molluscicides which may be mentioned are metaldehyde and methiocarb.

Examples of safeners which may be mentioned are:
(1) Heterocyclic carboxylic acid derivates, for example dichlorophenylpyrazolin-3-carboxylic acid derivatives, e.g. 1-(2,4-dichlorophenyl)-5-(ethoxycarbonyl)-5-methyl-4,5-dihydro-1H-pyrazole-3-carboxylic acid, diethyl 1-(2,4-dichlorophenyl)-4,5-dihydro-5-methyl-1H-pyrazole-3,5-dicarboxylate (“mefenpyr-diethyl”), and similar compounds known from WO 91/07874; for example dichlorophenylpyrazolecarboxylic acid derivatives, e.g. ethyl 1-(2,4-dichlorophenyl)-5-methyl-1H-pyrazole-3-carboxylate, ethyl 1-(2,4-dichlorophenyl)-5-isopropyl-1H-pyrazole-3-carboxylate, ethyl 5-tert-butyl-1-(2,4-dichlorophenyl)-1H-pyrazole-3-carboxylate and similar compounds known from EP-A 0 333 131 and EP-A 0 269 806; for example 1,5-diphenylpyrazole-3-carboxylic acid derivatives, e.g. ethyl 1-(2,4-dichlorophenyl)-5-phenyl-1H-pyrazole-3-carboxylate, methyl 1-(2-chlorophenyl)-5-phenyl-1H-pyrazole-3-carboxylate, and similar compounds known from EP-A 0 268 554; for example triazolecarboxylic acid derivatives, e.g. fenchlorazole, fenchlorazole-ethyl, and similar compounds known from EP-A 0 174 562 and EP-A 0 346 620; for example 2-isoxazoline-3-carboxylic acid derivatives, e.g. ethyl 5-(2,4-dichlorobenzyl)-4,5-dihydro-1,2-oxazole-3-carboxylate, ethyl 5-phenyl-4,5-dihydro-1,2-oxazole-3-carboxylate and similar compounds known from WO 91/08202, or 5,5-diphenyl-4,5-dihydro-1,2-oxazole-3-carboxylic acid, ethyl 5,5-diphenyl-4,5-dihydro-1,2-oxazole-3-carboxylate (“isoxadifen-ethyl”), propyl 5,5-diphenyl-4,5-dihydro-1,2-oxazole-3-carboxylate, ethyl 5-(4-fluorophenyl)-5-phenyl-4,5-dihydro-1,2-oxazole-3-carboxylate known from WO 95/07897.
(2) Derivatives of 8-quinolinol, for example derivatives of (quinolin-8-yloxy)acetic acid, e.g. heptan-2-yl [(5-chloroquinolin-8-yl)oxy]acetate (“cloquintocet-mexyl”), 4-methylpentan-2-yl [(5-chloroquinolin-8-yl)oxy]acetate, 4-(allyloxy)butyl [(5-chloroquinolin-8-yl)oxy]acetate, 1-(allyloxy)propan-2-yl [(5-chloroquinolin-8-yl)oxy]acetate, ethyl [(5-chloroquinolin-8-yl)oxy]acetate, methyl [(5-chloroquinolin-8-yl)oxy]acetate, allyl [(5-chloroquinolin-8-yl)oxy]acetate, 2-{[propylideneamino]oxy}ethyl [(5-chloroquinolin-8-yl)oxy]acetate, 2-oxopropyl [(5-chloroquinolin-8-yl)oxy]acetate, and similar compounds known from EP-A 0 086 750, EP-A 0 094 349, EP-A 0 191 736 or EP-A 0 492 366, as well as [(5-chloroquinolin-8-yl)oxy]acetic acid, its hydrates and salts, e.g. the lithium, sodium, potassium, calcium, magnesium, aluminum, iron, ammonium, quartanary ammonium, sulfonium or phosphonium salts as known from WO 02/34048; for example derivatives of [(5-chloroquinolin-8-yl)oxy]malonic acid, e.g diethyl [(5-chloroquinolin-8-yl)oxy]malonate, diallyl [(5-chloroquinolin-8-yl)oxy]malonate, ethyl methyl [(5-chloroquinolin-8-yl)oxy]malonate, and similar compounds known from EP-A 0 582 198.
(3) Dichloroacetamides, which are often used as pre-emergence safeners (soil active safeners), e.g. “dichlormid” (N,N-diallyl-2,2-dichloroacetamide), “R-29148” (3-dichloroacetyl-2,2,5-trimethyl-1,3-oxazolidine) and “R-28725” (3-dichloroacetyl-2,2,-dimethyl-1,3-oxazolidine) both of the company Stauffer, “benoxacor” (4-dichloroacetyl-3,4-dihydro-3-methyl-2H-1,4-benzoxazine), “PPG-1292” (N-allyl-N-[(1,3-dioxolan-2-yl)-methyl]-dichloroacetamide) of PPG Industries, “DKA-24” (N-allyl-N-[(allylaminocarbonyl)methyl]-dichloroacetamide) of Sagro-Chem, “AD-67” or “MON 4660” (3-dichloroacetyl-1-oxa-3-aza-spiro[4,5]decane) of Nitrokemia and Monsanto, “TI-35” (1-dichloroacetyl-azepane) of TRI-Chemical RT, “diclonon” (dicyclonon) or “BAS145138” or “LAB 145138” (3-dichloroacetyl-2,5,5-trimethyl-1,3-diazabicyclo[4.3.0]nonane) of BASF, “Furilazol” or “MON 13900” [(RS)-3-dichloroacetyl-5-(2-furyl)-2,2-dimethyloxazolidine], as well as there (R)-isomer.
(4) Acylsulfonamides, for example N-acylsulfonamide of the formula (II)

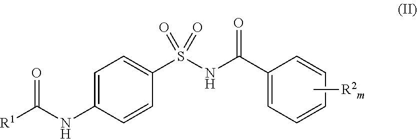

or its salts (known from WO 97/45016), wherein
R¹ represents (C₁-C₆)alkyl, which is unsubstituted or mono- to trisubstituted by substituents selected from the group consisting of halogen, (C₁-C₄)alkoxy, (C₁-C₆)haloalkoxy and (C₁-C₄)alkylthio;
R² represents halogen, (C₁-C₄)alkyl, (C₁-C₄)alkoxy, CF₃;
m is 1 or 2;
or for example 4-(benzoylsulfamoyl)benzamides of the formula (III)

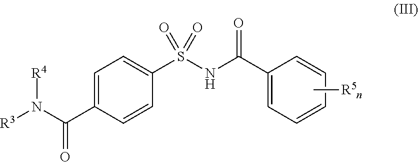

or its salts (known from WO 99/16744), wherein
R³, R⁴ independently of one another represent hydrogen, (C₁-C₆)alkyl, (C₃-C₆)alkenyl, (C₃-C₆)alkynyl, (C₃-C₆)cycloalkyl,
R⁵ represents halogen, (C₁-C₄)alkyl, (C₁-C₄)haloalkyl or (C₁-C₄)alkoxy
n is 1 or 2,
in particular compounds of formula (III), wherein
R³=cyclopropyl, R⁴=hydrogen and R⁵ₙ=2-OMe, (“cyprosulfamide”),
R³=cyclopropyl, R⁴=hydrogen and R⁵ₙ=5-C₁₋₂-OMe,
R³=ethyl, R⁴=hydrogen and R⁵ₙ=2-OMe,
R³=isopropyl, R⁴=hydrogen and R⁵ₙ=5-C₁₋₂-OMe,
R³=isopropyl, R⁴=hydrogen and R⁵ₙ=2-OMe.
or for example benzoylsulfamoylphenylureas of the formula (IV)

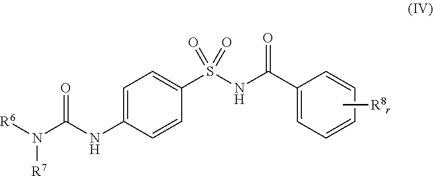

(known from EP-A 0 365 484), wherein
R⁶, R⁷ independently of one another represent hydrogen, (C₁-C₈)alkyl, (C₃-C₆)alkenyl, (C₃-C₆)alkynyl,
R⁸ represents halogen, (C₁-C₄)alkyl, (C₁-C₄)alkoxy, CF₃
r is 1 or 2;
in particular
1-[4-(N-2-methoxybenzoylsulfamoyl)phenyl]-3-methyl urea,
1-[4-(N-2-methoxybenzoylsulfamoyl)phenyl]-3,3-dimethyl urea,
1-[4-(N-4,5-dimethylbenzoylsulfamoyl)phenyl]-3-methyl urea.
(5) Hydroxyaromatic compounds and aromatic-aliphatic carboxylic acid derivatives, e.g. ethyl 3,4,5-triacetoxybenzoate, 4-hydroxy-3,5-dimethoxybenzoic acid, 3,5-dihydroxybenzoic acid, 2,4-di-hydroxybenzoic acid, 4-fluoro-2-hydroxybenzoic acid, 2-hydroxycinnamic acid, 2,4-dichlorocinnamic acid (cf. WO 2004/084631, WO 2005/015994, WO 2005/016001).
(6) 1,2-Dihydrochinoxalin-2-ones, e.g. 1-methyl-3-(2-thienyl)-1,2-dihydrochinoxalin-2-one, 1-methyl-3-(2-thienyl)-1,2-dihydrochinoxalin-2-thione, 1-(2-aminoethyl)-3-(2-thienyl)-1,2-dihydrochinoxalin-2-one hydrochlorid, 1-(2-methylsulfonylaminoethyl)-3-(2-thienyl)-1,2-dihydrochinoxalin-2-one (cf. WO 2005/112630).
(7) Diphenylmethoxyacetic acid derivatives, e.g. methyl (diphenylmethoxy)acetate (CAS-Reg. No. 41858-19-9), ethyl (diphenylmethoxy)acetate or (diphenylmethoxy)acetic acid (cf. WO 98/38856).
(8) Compounds of formula (V)

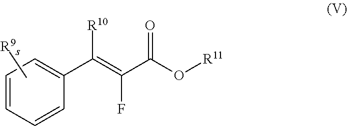

or its salts (known from WO 98/27049), wherein
R⁹ represents halogen, (C₁-C₄)alkyl, (C₁-C₄)haloalkyl, (C₁-C₄)alkoxy, (C₁-C₄)haloalkoxy,
R¹⁰ represents hydrogen or (C₁-C₄)alkyl,
R¹⁰ represents hydrogen, in each case unsubstituted or mono- to trisubstituted (C₁-C₈)alkyl, (C₂-C₄)alkenyl, (C₂-C₄)alkynyl, or aryl, where the substituents are selected from the group consisting of halogen and (C₁-C₈)alkoxy,
s is 0, 1 or 2.
(9) 3-(5-Tetrazolylcarbonyl)-2-chinolones, e.g. 1,2-dihydro-4-hydroxy-1-ethyl-3-(5-tetrazolylcarbo-nyl)-2-chinolone (CAS-Reg. No. 219479-18-2), 1,2-dihydro-4-hydroxy-1-methyl-3-(5-tetrazolyl-carbonyl)-2-chinolone (CAS-Reg. No. 95855-00-8) (cf. WO 99/00020).
(10) Compounds of the formulae (VI-a) and (VI-b)

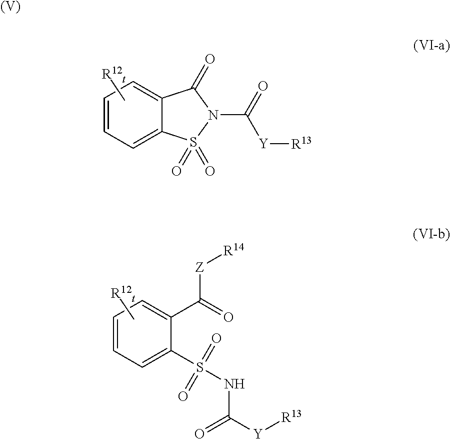

(known from WO 2007/023719 and WO 2007/023764), wherein
R¹² represents halogen, (C₁-C₄)alkyl, methoxy, nitro, cyano, CF₃, OCF₃,
Y, Z independently represent O or S,
t is 0, 1, 2, 3 or 4,
R¹³ represents (C₁-C₁₆)alkyl, (C₂-C₆)alkenyl, aryl, benzyl, halogenobenzyl,
R¹⁴ represents hydrogen or (C₁-C₆)alkyl.
(11) Oxyimino compounds, known as seed treatment agents, e.g. “oxabetrinil” [(Z)-1,3-dioxolan-2-ylmethoxyimino(phenyl)acetonitril], “fluxofenim” [1-(4-chlorophenyl)-2,2,2-trifluoro-1-ethanone-O-(1,3-dioxolan-2-ylmethyl)-oxime], and “cyometrinil” or “CGA-43089” [(Z)-cyanomethoxyimino(phenyl)acetonitril], all known as seed treatment safener for sorghum against damage by metolachlor.
(12) Isothiochromanones, e.g. methyl [(3-oxo-1H-2-benzothiopyran-4(3H)-ylidene)methoxy]acetate (CAS-Reg. No. 205121-04-6) and similar compounds known from WO 98/13361.
(13) Compounds from the group consisting of “naphthalic anhydrid” (1,8-naphthalinedicarboxylic acid anhydride), which is known as seed treatment safener for corn (maize) against damage by thiocarbamate herbicides, “fenclorim” (4,6-dichloro-2-phenylpyrimidine), which is known as seed treatment safener in sown rice against damage by pretilachlor, “flurazole” (benzyl-2-chloro-4-trifluoromethyl-1,3-thiazol-5-carboxylate), which is known as seed treatment safener for sorghum against damage by alachlor and metolachlor, “CL 304415” (CAS-Reg. No. 31541-57-8), (4-carboxy-3,4-dihydro-2H-1-benzopyran-4-acetic acid) of American Cyanamid, which is known as safener for corn (maize) against damage by imidazolinones, “MG 191” (CAS-Reg. No. 96420-72-3) (2-dichloromethyl-2-methyl-1,3-dioxolane) of Nitrokemia, known as safener for corn (maize), “MG-838” (CAS-Reg. No. 133993-74-5), (2-propenyl 1-oxa-4-azaspiro[4.5]decane-4-carbodithioate) of Nitrokemia, “Disulfoton” (O,O-diethyl-S-2-ethylthioethyl phosphorodithioate), “dietholate” (0,0-diethyl-O-phenylphosphorothioate), “mephenate” (4-chlorophenyl-methylcarbamate).
(14) Compounds, which besides herbicidal activity als exhibit Safener activity in crops like rice, e.g. “Dimepiperate” or “MY-93” (S-1-methyl-1-phenylethyl-piperidin-1-carbothioate), which is known as safener for rice against damage by molinate, “daimuron” or “SK 23” [1-(1-methyl-1-phenylethyl)-3-p-tolyl-urea], which is known as safener for rice against damage by imazosulfuron, “cumyluron”=“JC-940” [3-(2-chlorophenylmethyl)-1-(1-methyl-1-phenyl-ethyl)urea](cf. JP-A 60-087254), which is known as safener for rice against damage by some herbicides, “methoxyphenon” or “NK 049” (3,3′-dimethyl-4-methoxy-benzophenone), which is known as safener for rice against damage by some herbicides, “CSB” [1-bromo-4-(chloromethylsulfonyl)benzene] of Kumiai (CAS-Reg. No. 54091-06-4), which is known as safener for rice against damage by some herbicides.
(15) Compounds, which are mainly used as herbicides, but which exhibit also safener activity on some crops, e.g. (2,4-dichlorophenoxy)acetic acid (2,4-D), (4-chlorophenoxy)acetic acid, (R,S)-2-(4-chlor-o-tolyloxy)propionic acid (mecoprop), 4-(2,4-dichlorophenoxy)butyric acid (2,4-DB), (4-chloro-o-tolyloxy)acetic acid (MCPA), 4-(4-chloro-o-tolyloxy)butyric acid, 4-(4-chlorophenoxy)butyric acid, 3,6-dichloro-2-methoxybenzoic acid (dicamba), 1-(ethoxycarbonyl)ethyl-3,6-dichloro-2-methoxybenzoate (lactidichlor-ethyl).

Examples of plant growth regulators which may be mentioned are chlorocholine chloride and ethephon.

Examples of plant nutrients which may be mentioned are customary inorganic or organic fertilizers for supplying plants with macro- and/or micronutrients.

In a preferred embodiment the present invention relates to the use of a composition comprising fluopyram and one or more of the following insecticides:

Carbamates, preferably Aldicarb, Methiocarb, Oxamyl and Thiodicarb;

Organophosphates, preferably Fenamiphos, Fosthiazate, Ethoprofos, Imicyafos;

Fiproles, preferably Fipronil and Ethiprole;

Chlornicotinyls (Neonicotinoids), preferably Imidacloprid, Clothianidin, Thiacloprid and Thiamethoxam;

Pyrethroids, preferably Beta-Cyfluthrin, Lambda-Cyhalothrin, Deltamethrin, Tefluthrin, Transfluthrin;

Ryanodine receptor modulators (Anthranilamids), preferably Rynaxypyr (Chlorantraniliprole), Cyazypyr (Cyantraniliprole);

Macrolids (Spinosyns), preferably, Spinosad, Spinetoram;

Avermectins/milbemycins, preferably Abamectin;

Tetronic and tetramic acid derivatives (Ketoenols), preferably Spirotetramat, Spirodiclofen and Spiromesifen;

Miscellaneous non-specific (multi-site) inhibitors, preferably Flonicamid

Active ingredients with unknown or uncertain mode of action, preferably 4-[(2,2-difluoroethyl)amino]furan-2(5H)-one-2-chloro-5-Ethylpyridin (1:1), Sulfoxaflor.

In a preferred embodiment the present invention relates to the use of a composition comprising fluopyram and one or more of the following fungicides

(2.1) bixafen (581809-46-3), (2.2) boscalid (188425-85-6), (2.8) fluxapyroxad (907204-31-3), (2.9) (2.11) isopyrazam (mixture of syn-epimeric racemate 1RS,4SR,9RS and anti-epimeric racemate 1RS,4SR,9SR) (881685-58-1), (2.12) isopyrazam (anti-epimeric racemate 1RS,4SR,9SR), (2.13) isopyrazam (anti-epimeric enantiomer 1R,4S,9S), (2.14) isopyrazam (anti-epimeric enantiomer 1S,4R,9R), (2.15) isopyrazam (syn epimeric racemate 1RS,4SR,9RS), (2.16) isopyrazam (syn-epimeric enantiomer 1R,4S,9R), (2.17) isopyrazam (syn-epimeric enantiomer 1S,4R,9S), (2.20) penflufen (494793-67-8), (2.21) penthiopyrad (183675-82-3), (2.22) sedaxane (874967-67-6), (2.23) thifluzamide (130000-40-7), (2.24) 1-methyl-N-[2-(1,1,2,2-tetrafluoroethoxy)phenyl]-3-(trifluoromethyl)-1H-pyrazole-4-carboxamide, (2.25) 3-(difluoromethyl)-1-methyl-N-[2-(1,1,2,2-tetrafluoroethoxy)phenyl]-1H-pyrazole-4-carboxamide, (2.26) 3-(difluoromethyl)-N-[4-fluoro-2-(1,1,2,3,3,3-hexafluoropropoxy)phenyl]-1-methyl-1H-pyrazole-4-carboxamide, (2.27) N-[1-(2,4-dichlorophenyl)-1-methoxypropan-2-yl]-3-(difluoromethyl)-1-methyl-1H-pyrazole-4-carboxamide (1092400-95-7) (WO 2008148570), (2.28) 5,8-difluoro-N-[2-(2-fluoro-4-{[4-(trifluoromethyl)pyridin-2-yl]oxy}phenyl)ethyl]quinazolin-4-amine (1210070-84-0) (WO2010025451), (2.29) N-[9-(dichloromethylene)-1,2,3,4-tetrahydro-1,4-methanonaphthalen-5-yl]-3-(difluoromethyl)-1-methyl-1H-pyrazole-4-carboxamide, (2.30) N-[(1S,4R)-9-(dichloromethylene)-1,2,3,4-tetrahydro-1,4-methanonaphthalen-5-yl]-3-(difluoromethyl)-1-methyl-1H-pyrazole-4-carboxamide and (2.31) N—[(1R,4S)-9-(dichloromethylene)-1,2,3,4-tetrahydro-1,4-methanonaphthalen-5-yl]-3-(difluoromethyl)-1-methyl-1H-pyrazole-4-carboxamide,
(7.7) pyrimethanil (53112-28-0), (3.22) trifloxystrobin (141517-21-7).

In conjunction with the present invention “controlling” denotes a preventive or curative reduction of the nematode infestation in comparison to the untreated crop, more preferably the infestation is essentially repelled, most preferably the infestation is totally suppressed.

Pathosystems

Fluopyram and compositions comprising fluopyram is particularly useful in controlling nematodes in coffee belonging to at least one species selected from the group of the phytoparasitic nematodes consisting of Pratylenchus brachyurus, Pratylenchus coffeae, Meloidogyne exigua, Meloidogyne incognita, Meloidogyne coffeicola, Helicotylenchus spp. and also consisting of Meloidogyne paranaensis, Rotylenchus spp., Xiphinema spp., Tylenchorhynchus spp., Scutellonema spp.

Fluopyram and compositions comprising fluopyram is particularly useful in controlling nematodes in potato belonging to at least one species selected from the group of the phytoparasitic nematodes consisting of Pratylenchus brachyurus, Pratylenchus pratensis, Pratylenchus scribneri, Pratylenchus penetrans, Pratylenchus coffeae, Ditylenchus dipsaci and also consisting of Pratylenchus alleni, Pratylenchus andinus, Pratylenchus cerealis, Pratylenchus crenatus, Pratylenchus hexincisus, Pratylenchus loosi, Pratylenchus neglectus, Pratylenchus teres, Pratylenchus thornei, Pratylenchus vulnus, Belonolaimus longicaudatus, Trichodorus cylindricus, Trichodorus primitivus, Trichodorus proximus, Trichodorus similis, Trichodorus sparsus, Paratrichodorus minor, Paratrichodorus allius, Paratrichodorus nanus, Paratrichodorus teres, Meloidogyne arenaria, Meloidogyne hapla, Meloidogyne thamesi, Meloidogyne incognita, Meloidogyne chitwoodi, Meloidogyne javanica, Nacobbus aberrans, Globodera rostochiensis, Globodera pallida, Ditylenchus destructor, Radopholus similis, Rotylenchulus reniformis, Neotylenchus vigissi, Paraphelenchus pseudoparietinus, Aphelenchoides fragariae, Meloinema spp.

Fluopyram and compositions comprising fluopyram is particularly useful in controlling nematodes in tomato belonging to at least one species selected from the group of the phytoparasitic nematodes consisting of Meloidogyne arenaria, Meloidogyne hapla, Meloidogyne javanica, Meloidogyne incognita, Pratylenchus penetrans and also consisting of Pratylenchus brachyurus, Pratylenchus coffeae, Pratylenchus scribneri, Pratylenchus vulnus, Paratrichodorus minor, Meloidogyne exigua, Nacobbus aberrans, Globodera solanacearum, Dolichodorus heterocephalus, Rotylenchulus reniformis.

Fluopyram and compositions comprising fluopyram is particularly useful in controlling nematodes in tomato belonging to at least one species selected from the group of the phytoparasitic nematodes consisting of Helicotylenchulus sp., Meloidogyne arenaria, Meloidogyne hapla, Meloidogyne javanica, Meloidogyne incognita, Pratylenchus penetrans and also consisting of Pratylenchus brachyurus, Pratylenchus coffeae, Pratylenchus scribneri, Pratylenchus vulnus, Paratrichodorus minor, Meloidogyne exigua, Nacobbus aberrans, Globodera solanacearum, Dolichodorus heterocephalus, Rotylenchulus reniformis.

Fluopyram and compositions comprising fluopyram is particularly useful in controlling nematodes in pepper belonging to at least one species selected from the group of the phytoparasitic nematodes consisting of Pratylenchus brachyurus, Pratylenchus pratensis, Pratylenchus scribneri, Pratylenchus penetrans, Pratylenchus coffeae, Ditylenchus dipsaci and also consisting of Pratylenchus alleni, Pratylenchus andinus, Pratylenchus cerealis, Pratylenchus crenatus, Pratylenchus hexincisus, Pratylenchus loosi, Pratylenchus neglectus, Pratylenchus teres, Pratylenchus thornei, Pratylenchus vulnus, Belonolaimus longicaudatus, Trichodorus cylindricus, Trichodorus primitivus, Trichodorus proximus, Trichodorus similis, Trichodorus sparsus, Paratrichodorus minor, Paratrichodorus allius, Paratrichodorus nanus, Paratrichodorus teres, Meloidogyne arenaria, Meloidogyne hapla, Meloidogyne thamesi, Meloidogyne incognita, Meloidogyne chitwoodi, Meloidogyne javanica, Nacobbus aberrans, Globodera rostochiensis, Globodera pallida, Ditylenchus destructor, Radopholus similis, Rotylenchulus reniformis, Neotylenchus vigissi, Paraphelenchus pseudoparietinus, Aphelenchoides fragariae, Meloinema spp.

Fluopyram and compositions comprising fluopyram is particularly useful in controlling nematodes in carrots belonging to at least one species selected from the group of the phytoparasitic nematodes consisting of Pratylenchus brachyurus, Pratylenchus pratensis, Pratylenchus scribneri, Pratylenchus penetrans, Pratylenchus coffeae, Ditylenchus dipsaci and also consisting of Pratylenchus alleni, Pratylenchus andinus, Pratylenchus cerealis, Pratylenchus crenatus, Pratylenchus hexincisus, Pratylenchus loosi, Pratylenchus neglectus, Pratylenchus teres, Pratylenchus thornei, Pratylenchus vulnus, Belonolaimus longicaudatus, Trichodorus cylindricus, Trichodorus primitivus, Trichodorus proximus, Trichodorus similis, Trichodorus sparsus, Paratrichodorus minor, Paratrichodorus allius, Paratrichodorus nanus, Paratrichodorus teres, Meloidogyne arenaria, Meloidogyne hapla, Meloidogyne thamesi, Meloidogyne incognita, Meloidogyne chitwoodi, Meloidogyne javanica, Nacobbus aberrans, Globodera rostochiensis, Globodera pallida, Ditylenchus destructor, Radopholus similis, Rotylenchulus reniformis, Neotylenchus vigissi, Paraphelenchus pseudoparietinus, Aphelenchoides fragariae, Meloinema spp.

Fluopyram and compositions comprising fluopyram is particularly useful in controlling nematodes in onions belonging to at least one species selected from the group of the phytoparasitic nematodes consisting of Pratylenchus brachyurus, Pratylenchus pratensis, Pratylenchus scribneri, Pratylenchus penetrans, Pratylenchus coffeae, Ditylenchus dipsaci and also consisting of Pratylenchus alleni, Pratylenchus andinus, Pratylenchus cerealis, Pratylenchus crenatus, Pratylenchus hexincisus, Pratylenchus loosi, Pratylenchus neglectus, Pratylenchus teres, Pratylenchus thornei, Pratylenchus vulnus, Belonolaimus longicaudatus, Trichodorus cylindricus, Trichodorus primitivus, Trichodorus proximus, Trichodorus similis, Trichodorus sparsus, Paratrichodorus minor, Paratrichodorus allius, Paratrichodorus nanus, Paratrichodorus teres, Meloidogyne arenaria, Meloidogyne hapla, Meloidogyne thamesi, Meloidogyne incognita, Meloidogyne chitwoodi, Meloidogyne javanica, Nacobbus aberrans, Globodera rostochiensis, Globodera pallida, Ditylenchus destructor, Radopholus similis, Rotylenchulus reniformis, Neotylenchus vigissi, Paraphelenchus pseudoparietinus, Aphelenchoides fragariae, Meloinema spp.

Fluopyram and compositions comprising fluopyram is particularly useful in controlling nematodes in cucurbits belonging to at least one species selected from the group of the phytoparasitic nematodes consisting of Meloidogyne arenaria, Meloidogyne hapla, Meloidogyne javanica, Meloidogyne incognita, Rotylenchulus reniformis and also consisting of Pratylenchus thornei.

Fluopyram and compositions comprising fluopyram is particularly useful in controlling nematodes in cucurbits belonging to at least one species selected from the group of the phytoparasitic nematodes consisting of Meloidogyne arenaria, Meloidogyne hapla, Meloidogyne javanica, Rotylenchulus reniformis and also consisting of Pratylenchus thornei.

Fluopyram and compositions comprising fluopyram is particularly useful in controlling nematodes in cotton belonging to at least one species selected from the group of the phytoparasitic nematodes consisting of Belonolaimus longicaudatus, Meloidogyne incognita, Hoplolaimus columbus, Hoplolaimus galeatus, Rotylenchulus reniformis.

Fluopyram and compositions comprising fluopyram is particularly useful in controlling nematodes in corn belonging to at least one species selected from the group of the phytoparasitic nematodes, especially consisting of Belonolaimus longicaudatus, Paratrichodorus minor and also consisting of Pratylenchus brachyurus, Pratylenchus delattrei, Pratylenchus hexincisus, Pratylenchus penetrans, Pratylenchus zeae, (Belonolaimus gracilis), Belonolaimus nortoni, Longidorus breviannulatus, Meloidogyne arenaria, Meloidogyne arenaria thamesi, Meloidogyne graminis, Meloidogyne incognita, Meloidogyne incognita acrita, Meloidogyne javanica, Meloidogyne naasi, Heterodera avenae, Heterodera oryzae, Heterodera zeae, Punctodera chalcoensis, Ditylenchus dipsaci, Hoplolaimus aegyptii, Hoplolaimus magnistylus, Hoplolaimus galeatus, Hoplolaimus indicus, Helicotylenchus digonicus, Helicotylenchus dihystera, Helicotylenchus pseudorobustus, Xiphinema americanum, Dolichodorus heterocephalus, Criconemella ornata, Criconemella onoensis, Radopholus similis, Rotylenchulus borealis, Rotylenchulus parvus, Tylenchorhynchus agri, Tylenchorhynchus clarus, Tylenchorhynchus claytoni, Tylenchorhynchus maximus, Tylenchorhynchus nudus, Tylenchorhynchus vulgaris, Quinisulcius acutus, Paratylenchus minutus, Hemicycliophora parvana, Aglenchus agricola, Anguina tritici, Aphelenchoides arachidis, Scutellonema brachyurum, Subanguina radiciola.

Fluopyram and compositions comprising fluopyram is particularly useful in controlling nematodes in soybean belonging to at least one species selected from the group of the phytoparasitic nematodes, especially consisting of Pratylenchus brachyurus, Pratylenchus pratensis, Pratylenchus penetrans, Pratylenchus scribneri, Belonolaimus longicaudatus, Heterodera glycines, Hoplolaimus columbus and also consisting of Pratylenchus coffeae, Pratylenchus hexincisus, Pratylenchus neglectus, Pratylenchus crenatus, Pratylenchus alleni, Pratylenchus agilis, Pratylenchus zeae, Pratylenchus vulnus, (Belonolaimus gracilis), Meloidogyne arenaria, Meloidogyne incognita, Meloidogyne javanica, Meloidogyne hapla, Hoplolaimus columbus, Hoplolaimus galeatus, Rotylenchulus reniformis.

Fluopyram and compositions comprising fluopyram is very particularly useful in controlling nematodes in soybean belonging to at least one species selected from the group of the phytoparasitic nematodes, especially consisting of Pratylenchus brachyurus, Pratylenchus pratensis, Pratylenchus penetrans, Pratylenchus scribneri, Belonolaimus longicaudatus, Hoplolaimus columbus and also consisting of Pratylenchus coffeae, Pratylenchus hexincisus, Pratylenchus neglectus, Pratylenchus crenatus, Pratylenchus alleni, Pratylenchus agilis, Pratylenchus zeae, Pratylenchus vulnus, (Belonolaimus gracilis), Meloidogyne arenaria, Meloidogyne incognita, Meloidogyne javanica, Meloidogyne hapla, Hoplolaimus columbus, Hoplolaimus galeatus, Rotylenchulus reniformis.

Fluopyram and compositions comprising fluopyram is particularly useful in controlling nematodes in tobacco belonging to at least one species selected from the group of the phytoparasitic nematodes, especially consisting of Meloidogyne incognita, Meloidogyne javanica and also consisting of Pratylenchus brachyurus, Pratylenchus pratensis, Pratylenchus hexincisus, Pratylenchus penetrans, Pratylenchus neglectus, Pratylenchus crenatus, Pratylenchus thornei, Pratylenchus vulnus, Pratylenchus zeae, Longidorus elongatu, Paratrichodorus lobatus, Trichodorus spp., Meloidogyne arenaria, Meloidogyne hapla, Globodera tabacum, Globodera solanacearum, Globodera virginiae, Ditylenchus dipsaci, Rotylenchus spp., Helicotylenchus spp., Xiphinema americanum, Criconemella spp., Rotylenchulus reniformis, Tylenchorhynchus claytoni, Paratylenchus spp., Tetylenchus nicotianae.

Fluopyram and compositions comprising fluopyram is particularly useful in controlling nematodes in citrus belonging to at least one species selected from the group of the phytoparasitic nematodes, especially consisting of Pratylenchus coffeae and also consisting of Pratylenchus brachyurus, Pratylenchus vulnus, Belonolaimus longicaudatus, Paratrichodorus minor, Paratrichodorus porosus, Trichodorus Meloidogyne incognita, Meloidogyne incognita acrita, Meloidogyne javanica, Rotylenchus macrodoratus, Xiphinema americanum, Xiphinema brevicolle, Xiphinema index, Criconemella spp., Hemicriconemoides, (Radopholus similis), Radopholus citrophilus, Hemicycliophora arenaria, Hemicycliophora nudata, Tylenchulus semipenetrans.

Fluopyram and compositions comprising fluopyram is particularly useful in controlling nematodes in banana belonging to at least one species selected from the group of the phytoparasitic nematodes, especially consisting of Pratylenchus coffeae, Radopholus similis and also consisting of Pratylenchus giibbicaudatus, Pratylenchus loosi, Meloidogyne spp., Helicotylenchus multicinctus, Helicotylenchus dihystera, Rotylenchulus spp.

Fluopyram and compositions comprising fluopyram is particularly useful in controlling nematodes in pine apple belonging to at least one species selected from the group of the phytoparasitic nematodes, especially consisting of Pratylenchus zeae, Pratylenchus pratensis, Pratylenchus brachyurus, Pratylenchus goodeyi., Meloidogyne spp., Rotylenchulus reniformis and also consisting of Longidorus elongatus, Longidorus laevicapitatus, Trichodorus primitivus, Trichodorus minor, Heterodera spp., Ditylenchus myceliophagus, Hoplolaimus californicus, Hoplolaimus pararobustus, Hoplolaimus indicus, Helicotylenchus dihystera, Helicotylenchus nannus, Helicotylenchus multicinctus, Helicotylenchus erythrine, Xiphinema dimorphicaudatum, Radopholus similis, Tylenchorhynchus digitatus, Tylenchorhynchus ebriensis, Paratylenchus minutus, Scutellonema clathricaudatum, Scutellonema bradys, Psilenchus tumidus, Psilenchus magnidens, Pseudohalenchus minutus, Criconemoides ferniae, Criconemoides onoense, Criconemoides ornatum.

Fluopyram and compositions comprising fluopyram is particularly useful in controlling nematodes in sugarcane belonging to at least one species selected from the group of the phytoparasitic nematodes, especially consisting of Pratylenchus brachyurus, Pratylenchus pratensis, Pratylenchus scribneri, Pratylenchus penetrans, Pratylenchus coffeae, Ditylenchus dipsaci and also consisting of Pratylenchus alleni, Pratylenchus andinus, Pratylenchus cerealis, Pratylenchus crenatus, Pratylenchus hexincisus, Pratylenchus loosi, Pratylenchus neglectus, Pratylenchus teres, Pratylenchus thornei, Pratylenchus vulnus, Meloidogyne arenaria, Meloidogyne acronea, Meloidogyne artiella, Meloidogyne incognita, Meloidogyne graminicola, Meloidogyne javanica, Meloidogyne thamesi, Meloidogyne hapla, Meloidogyne ethiopica, Meloidogyne africana, Meloidogyne kikuyensis, Helicotylenchus digonicus, Helicotylenchus dihystera, Helicotylenchus pseudorobustus, Rotylenchulus borealis, Rotylenchulus parvus, Rotylenchulus reniformis, Scutellonema brachyurum.

Fluopyram and compositions comprising fluopyram is particularly useful in controlling nematodes in grapes belonging to at least one species selected from the group of the phytoparasitic nematodes, especially consisting of Pratylenchus vulnus, Meloidogyne arenaria, Meloidogyne incognita, Meloidogyne javanica, Xiphinema americanum, Xiphinema index and also consisting of Pratylenchus pratensis, Pratylenchus scribneri, Pratylenchus neglectus, Pratylenchus brachyurus, Pratylenchus thornei, Tylenchulus semipenetrans.

Fluopyram and compositions comprising fluopyram is particularly useful in controlling nematodes in tree crops—pome fruits, belonging to at least one species selected from the group of the phytoparasitic nematodes, especially consisting of Pratylenchus penetrans and also consisting of Pratylenchus vulnus, Longidorus elongatus, Meloidogyne incognita, Meloidogyne hapla.

Fluopyram and compositions comprising fluopyram is particularly useful in controlling nematodes in tree crops—stone fruits, belonging to at least one species selected from the group of the phytoparasitic nematodes, especially consisting of Pratylenchus penetrans, Pratylenchus vulnus, Meloidogyne arenaria, Meloidogyne hapla, Meloidogyne javanica, Meloidogyne incognita, Criconemella xenoplax and also consisting of Pratylenchus brachyurus, Pratylenchus coffeae, Pratylenchus scribneri, Pratylenchus zeae, Belonolaimus longicaudatus, Helicotylenchus dihystera, Xiphinema americanum, Criconemella curvata, Tylenchorhynchus claytoni, Paratylenchus hamatus, Paratylenchus projectus, Scutellonema brachyurum, Hoplolaimus galeatus.

Fluopyram and compositions comprising fluopyram is particularly useful in controlling nematodes in tree crops—nuts, belonging to at least one species selected from the group of the phytoparasitic nematodes, especially consisting of Trichodorus spp., Criconemella rusium and also consisting of Pratylenchus vulnus, Paratrichodorus spp., Meloidogyne incognita, Helicotylenchus spp., Tylenchorhynchus spp., Cacopaurus pestis.

Definition of Plant Parts

According to the invention all plants and plant parts can be treated. By plants is meant all plants and plant populations such as desirable and undesirable wild plants, cultivars and plant varieties (whether or not protectable by plant variety or plant breeder's rights). Cultivars and plant varieties can be plants obtained by conventional propagation and breeding methods which can be assisted or supplemented by one or more biotechnological methods such as by use of double haploids, protoplast fusion, random and directed mutagenesis, molecular or genetic markers or by bioengineering and genetic engineering methods. By plant parts is meant all above ground and below ground parts and organs of plants such as shoot, leaf, blossom and root, whereby for example leaves, needles, stems, branches, blossoms, fruiting bodies, fruits and seed as well as roots, tubers, corms and rhizomes are listed. Crops and vegetative and generative propagating material, for example cuttings, corms, rhizomes, tubers, runners and seeds also belong to plant parts.

As already mentioned above, it is possible to treat all plants and their parts according to the invention. In one embodiment, wild plant species and plant cultivars, or those obtained by conventional biological breeding, such as crossing or protoplast fusion, and parts thereof, are treated. In a further embodiment, transgenic plants and plant cultivars obtained by genetic engineering, if appropriate in combination with conventional methods (Genetically Modified Organisms), and parts thereof are treated. The term “parts” or “parts of plants” or “plant parts” has been explained above.

GMOs

Plants of the plant cultivars which are in each case commercially available or in use can be treated according to the invention. Plant cultivars are to be understood as meaning plants having novel properties (“traits”) which can be obtained by conventional breeding, by mutagenesis or by recombinant DNA techniques. This can be varieties, bio- and genotypes.

The transgenic plants or plant cultivars (i.e. those obtained by genetic engineering) which can be treated according to the invention include all plants which, in the genetic modification, received genetic material which imparted particularly advantageous useful traits to these plants. Examples of such properties are better plant growth, increased tolerance to high or low temperatures, increased tolerance to drought or to water or soil salt content, increased flowering performance, easier harvesting, accelerated maturation, higher harvest yields, better quality and/or a higher nutritional value of the harvested products, better storage stability and/or processability of the harvested products. Further and particularly emphasized examples of such properties are a better defense of the plants against animal and microbial pests, such as against nematodes, insects, mites, phytopathogenic fungi, bacteria and/or viruses, and also increased tolerance of the plants to certain herbicidal active compounds. Particular emphasis is given to vegetables, in particular tomato and cucurbits, potato, corn, soy, cotton, tobacco, coffee, fruits, in particular citrus fruits, pine apples and bananas, and grapes.

The method of treatment according to the invention can be used in the treatment of genetically modified organisms (GMOs), e.g. plants or seeds. Genetically modified plants (or transgenic plants) are plants of which a heterologous gene has been stably integrated into genome. The expression “heterologous gene” essentially means a gene which is provided or assembled outside the plant and when introduced in the nuclear, chloroplastic or mitochondrial genome gives the transformed plant new or improved agronomic or other properties by expressing a protein or polypeptide of interest or by downregulating or silencing other gene(s) which are present in the plant (using for example, antisense technology, cosuppression technology or RNA interference—RNAi—technology). A heterologous gene that is located in the genome is also called a transgene. A transgene that is defined by its particular location in the plant genome is called a transformation or transgenic event.

Depending on the plant species or plant cultivars, their location and growth conditions (soils, climate, vegetation period, diet), the treatment according to the invention may also result in superadditive (“synergistic”) effects. Thus, for example, reduced application rates and/or a widening of the activity spectrum and/or an increase in the activity of the active compounds and compositions which can be used according to the invention, better plant growth, increased tolerance to high or low temperatures, increased tolerance to drought or to water or soil salt content, increased flowering performance, easier harvesting, accelerated maturation, higher harvest yields, bigger fruits, larger plant height, greener leaf color, earlier flowering, higher quality and/or a higher nutritional value of the harvested products, higher sugar concentration within the fruits, better storage stability and/or processability of the harvested products are possible, which exceed the effects which were actually to be expected.

At certain application rates, fluopyram and compositions comprising fluopyram according to the invention may also have a strengthening effect in plants. Accordingly, they are also suitable for mobilizing the defense system of the plant against attack by unwanted microorganisms. This may, if appropriate, be one of the reasons of the enhanced activity of fluopyram and compositions comprising fluopyram according to the invention, for example against nematodes. Plant-strengthening (resistance-inducing) substances are to be understood as meaning, in the present context, those substances or combinations of substances which are capable of stimulating the defense system of plants in such a way that, when subsequently inoculated with unwanted microorganisms, the treated plants display a substantial degree of resistance to these microorganisms. In the present case, unwanted microorganisms are to be understood as meaning phytopathogenic fungi, bacteria and viruses. Thus, fluopyram and compositions comprising fluopyram according to the invention can be employed for protecting plants against attack by the abovementioned pathogens within a certain period of time after the treatment. The period of time within which protection is effected generally extends from 1 to 10 days, preferably 1 to 7 days, after the treatment of the plants with the active compounds. At certain application rates, fluopyram and compositions comprising fluopyram according to the invention may also have a yield-increasing effect in plants.

Plants and plant cultivars which are preferably to be treated according to the invention include all plants which have genetic material which impart particularly advantageous, useful traits to these plants (whether obtained by breeding and/or biotechnological means).

Plants and plant cultivars which are also preferably to be treated according to the invention are resistant against one or more biotic stresses, i.e. said plants show a better defense against animal and microbial pests, such as against insects, mites, phytopathogenic fungi, bacteria, viruses and/or viroids.

Plants and plant cultivars which may also be treated according to the invention are those plants which are resistant to one or more abiotic stresses. Abiotic stress conditions may include, for example, drought, cold temperature exposure, heat exposure, osmotic stress, flooding, increased soil salinity, increased mineral exposure, ozone exposure, high light exposure, limited availability of nitrogen nutrients, limited availability of phosphorus nutrients, shade avoidance.

Plants and plant cultivars which may also be treated according to the invention, are those plants characterized by enhanced yield characteristics. Increased yield in said plants can be the result of, for example, improved plant physiology, growth and development, such as water use efficiency, water retention efficiency, improved nitrogen use, enhanced carbon assimilation, improved photosynthesis, increased germination efficiency and accelerated maturation. Yield can furthermore be affected by improved plant architecture (under stress and non-stress conditions), including but not limited to, early flowering, flowering control for hybrid seed production, seedling vigor, plant size, internode number and distance, root growth, seed size, fruit size, pod size, pod or ear number, seed number per pod or ear, seed mass, enhanced seed filling, reduced seed dispersal, reduced pod dehiscence and lodging resistance. Further yield traits include seed composition, such as carbohydrate content, protein content, oil content and composition, nutritional value, reduction in anti-nutritional compounds, improved processability and better storage stability.

Plants that may be treated according to the invention are hybrid plants that already express the characteristic of heterosis or hybrid vigor which results in generally higher yield, vigor, health and resistance towards biotic and abiotic stresses). Such plants are typically made by crossing an inbred male-sterile parent line (the female parent) with another inbred male-fertile parent line (the male parent). Hybrid seed is typically harvested from the male sterile plants and sold to growers. Male sterile plants can sometimes (e.g. in corn) be produced by detasseling, i.e. the mechanical removal of the male reproductive organs (or males flowers) but, more typically, male sterility is the result of genetic determinants in the plant genome. In that case, and especially when seed is the desired product to be harvested from the hybrid plants it is typically useful to ensure that male fertility in the hybrid plants is fully restored. This can be accomplished by ensuring that the male parents have appropriate fertility restorer genes which are capable of restoring the male fertility in hybrid plants that contain the genetic determinants responsible for male-sterility. Genetic determinants for male sterility may be located in the cytoplasm. Examples of cytoplasmic male sterility (CMS) were for instance described in Brassica species (WO 92/05251, WO 95/09910, WO 98/27806, WO 05/002324, WO 06/021972 and U.S. Pat. No. 6,229,072). However, genetic determinants for male sterility can also be located in the nuclear genome. Male sterile plants can also be obtained by plant biotechnology methods such as genetic engineering. A particularly useful means of obtaining male-sterile plants is described in WO 89/10396 in which, for example, a ribonuclease such as barnase is selectively expressed in the tapetum cells in the stamens.

Fertility can then be restored by expression in the tapetum cells of a ribonuclease inhibitor such as barstar (e.g. WO 91/02069).

Plants or plant cultivars (obtained by plant biotechnology methods such as genetic engineering) which may be treated according to the invention are herbicide-tolerant plants, i.e. plants made tolerant to one or more given herbicides. Such plants can be obtained either by genetic transformation, or by selection of plants containing a mutation imparting such herbicide tolerance.

Herbicide-resistant plants are for example glyphosate-tolerant plants, i.e. plants made tolerant to the herbicide glyphosate or salts thereof. Plants can be made tolerant to glyphosate through different means. For example, glyphosate-tolerant plants can be obtained by transforming the plant with a gene encoding the enzyme 5-enolpyruvylshikimate-3-phosphate synthase (EPSPS). Examples of such EPSPS genes are the AroA gene (mutant CT7) of the bacterium Salmonella typhimurium (Comai et al., 1983, Science 221, 370-371), the CP4 gene of the bacterium Agrobacterium sp. (Barry et al., 1992, Curr. Topics Plant Physiol. 7, 139-145), the genes encoding a Petunia EPSPS (Shah et al., 1986, Science 233, 478-481), a Tomato EPSPS (Gasser et al., 1988, J. Biol. Chem. 263, 4280-4289), or an Eleusine EPSPS (WO 01/66704). It can also be a mutated EPSPS as described in for example EP 0837944, WO 00/66746, WO 00/66747 or WO02/26995. Glyphosate-tolerant plants can also be obtained by expressing a gene that encodes a glyphosate oxido-reductase enzyme as described in U.S. Pat. Nos. 5,776,760 and 5,463,175. Glyphosate-tolerant plants can also be obtained by expressing a gene that encodes a glyphosate acetyl transferase enzyme as described in for example WO 02/36782, WO 03/092360, WO 05/012515 and WO 07/024,782. Glyphosate-tolerant plants can also be obtained by selecting plants containing naturally-occurring mutations of the above-mentioned genes, as described in for example WO 01/024615 or WO 03/013226. Plants expressing EPSPS genes that confer glyphosate tolerance are described in e.g. U.S. patent application Ser. No. 11/517,991, 10/739,610, 12/139,408, 12/352,532, 11/312,866, 11/315,678, 12/421,292, 11/400,598, 11/651,752, 11/681,285, 11/605,824, 12/468,205, 11/760,570, 11/762,526, 11/769,327, 11/769,255, 11/943,801 or 12/362,774. Plants comprising other genes that confer glyphosate tolerance, such as decarboxylase genes, are described in e.g. U.S. patent application Ser. No. 11/588,811, 11/185,342, 12/364,724, 11/185,560 or 12/423,926.

Other herbicide resistant plants are for example plants that are made tolerant to herbicides inhibiting the enzyme glutamine synthase, such as bialaphos, phosphinothricin or glufosinate. Such plants can be obtained by expressing an enzyme detoxifying the herbicide or a mutant glutamine synthase enzyme that is resistant to inhibition, e.g. described in U.S. patent application Ser. No. 11/760,602. One such efficient detoxifying enzyme is an enzyme encoding a phosphinothricin acetyltransferase (such as the bar or pat protein from Streptomyces species). Plants expressing an exogenous phosphinothricin acetyltransferase are for example described in U.S. Pat. Nos. 5,561,236; 5,648,477; 5,646,024; 5,273,894; 5,637,489; 5,276,268; 5,739,082; 5,908,810 and 7,112,665.

Further herbicide-tolerant plants are also plants that are made tolerant to the herbicides inhibiting the enzyme hydroxyphenylpyruvatedioxygenase (HPPD). Hydroxyphenylpyruvatedioxygenases HPPD is an are enzymes that catalyze the reaction in which para-hydroxyphenylpyruvate (HPP) is transformed into homogentisate. Plants tolerant to HPPD-inhibitors can be transformed with a gene encoding a naturally-occurring resistant HPPD enzyme, or a gene encoding a mutated or chimeric HPPD enzyme as described in WO 96/38567, WO 99/24585, and WO 99/24586, WO 2009/144079, WO 2002/046387, or U.S. Pat. No. 6,768,044. Tolerance to HPPD-inhibitors can also be obtained by transforming plants with genes encoding certain enzymes enabling the formation of homogentisate despite the inhibition of the native HPPD enzyme by the HPPD-inhibitor. Such plants and genes are described in WO 99/34008 and WO 02/36787. Tolerance of plants to HPPD inhibitors can also be improved by transforming plants with a gene encoding an enzyme having_prephenate deshydrogenase (PDH) activity in addition to a gene encoding an HPPD-tolerant enzyme, as described in WO 2004/024928. Further, plants can be made more tolerant to HPPD-inhibitor herbicides by adding into their genome a gene encoding an enzyme capable of metabolizing or degrading HPPD inhibitors, such as the CYP450 enzymes shown in WO 2007/103567 and WO 2008/150473.

Still further herbicide resistant plants are plants that are made tolerant to acetolactate synthase (ALS) inhibitors. Known ALS-inhibitors include, for example, sulfonylurea, imidazolinone, triazolopyrimidines, pryimidinyoxy(thio)benzoates, and/or sulfonylaminocarbonyltriazolinone herbicides. Different mutations in the ALS enzyme (also known as acetohydroxyacid synthase, AHAS) are known to confer tolerance to different herbicides and groups of herbicides, as described for example in Tranel and Wright (2002, Weed Science 50:700-712), but also, in U.S. Pat. Nos. 5,605,011, 5,378,824, 5,141,870, and 5,013,659. The production of sulfonylurea-tolerant plants and imidazolinone-tolerant plants is described in U.S. Pat. Nos. 5,605,011; 5,013,659; 5,141,870; 5,767,361; 5,731,180; 5,304,732; 4,761,373; 5,331,107; 5,928,937; and 5,378,824; and international publication WO 96/33270. Other imidazolinone-tolerant plants are also described in for example WO 2004/040012, WO 2004/106529, WO 2005/020673, WO 2005/093093, WO 2006/007373, WO 2006/015376, WO 2006/024351, and WO 2006/060634. Further sulfonylurea- and imidazolinone-tolerant plants are also described in for example WO 07/024,782 and U.S. Patent Application No. 61/288,958.

Other plants tolerant to imidazolinone and/or sulfonylurea can be obtained by induced mutagenesis, selection in cell cultures in the presence of the herbicide or mutation breeding as described for example for soybeans in U.S. Pat. No. 5,084,082, for rice in WO 97/41218, for sugar beet in U.S. Pat. No. 5,773,702 and WO 99/057965, for lettuce in U.S. Pat. No. 5,198,599, or for sunflower in WO 01/065922.

Plants or plant cultivars (obtained by plant biotechnology methods such as genetic engineering) which may also be treated according to the invention are insect-resistant transgenic plants, i.e. plants made resistant to attack by certain target insects. Such plants can be obtained by genetic transformation, or by selection of plants containing a mutation imparting such insect resistance.

An “insect-resistant transgenic plant”, as used herein, includes any plant containing at least one transgene comprising a coding sequence encoding:

1) an insecticidal crystal protein from Bacillus thuringiensis or an insecticidal portion thereof, such as the insecticidal crystal proteins listed by Crickmore et al. (1998, Microbiology and Molecular Biology Reviews, 62: 807-813), updated by Crickmore et al. (2005) at the Bacillus thuringiensis toxin nomenclature, online at: http://www.lifesci.sussex.ac.uk/Home/Neil_Crickmore/Bt/), or insecticidal portions thereof, e.g., proteins of the Cry protein classes Cry1Ab, Cry1Ac, Cry1B, Cry1C, Cry1D, Cry1F, Cry2Ab, Cry3Aa, or Cry3Bb or insecticidal portions thereof (e.g. EP 1999141 and WO 2007/107302), or such proteins encoded by synthetic genes as e.g. described in and U.S. patent application Ser. No. 12/249,016; or

2) a crystal protein from Bacillus thuringiensis or a portion thereof which is insecticidal in the presence of a second other crystal protein from Bacillus thuringiensis or a portion thereof, such as the binary toxin made up of the Cry34 and Cry35 crystal proteins (Moellenbeck et al. 2001, Nat. Biotechnol. 19: 668-72; Schnepf et al. 2006, Applied Environm. Microbiol. 71, 1765-1774) or the binary toxin made up of the Cry1A or Cry1F proteins and the Cry2Aa or Cry2Ab or Cry2Ae proteins (U.S. patent application Ser. No. 12/214,022 and EP 08010791.5); or

3) a hybrid insecticidal protein comprising parts of different insecticidal crystal proteins from Bacillus thuringiensis, such as a hybrid of the proteins of 1) above or a hybrid of the proteins of 2) above, e.g., the Cry1A.105 protein produced by corn event MON89034 (WO 2007/027777); or

4) a protein of any one of 1) to 3) above wherein some, particularly 1 to 10, amino acids have been replaced by another amino acid to obtain a higher insecticidal activity to a target insect species, and/or to expand the range of target insect species affected, and/or because of changes introduced into the encoding DNA during cloning or transformation, such as the Cry3Bb1 protein in corn events MON863 or MON88017, or the Cry3A protein in corn event MIR604; or

5) an insecticidal secreted protein from Bacillus thuringiensis or Bacillus cereus, or an insecticidal portion thereof, such as the vegetative insecticidal (VIP) proteins listed at:

http://www.lifesci.sussex.ac.uk/home/Neil_Crickmore/Bt/vip.html, e.g., proteins from the VIP3Aa protein class; or

6) a secreted protein from Bacillus thuringiensis or Bacillus cereus which is insecticidal in the presence of a second secreted protein from Bacillus thuringiensis or B. cereus, such as the binary toxin made up of the VIP1A and VIP2A proteins (WO 94/21795); or

7) a hybrid insecticidal protein comprising parts from different secreted proteins from Bacillus thuringiensis or Bacillus cereus, such as a hybrid of the proteins in 1) above or a hybrid of the proteins in 2) above; or

8) a protein of any one of 5) to 7) above wherein some, particularly 1 to 10, amino acids have been replaced by another amino acid to obtain a higher insecticidal activity to a target insect species, and/or to expand the range of target insect species affected, and/or because of changes introduced into the encoding DNA during cloning or transformation (while still encoding an insecticidal protein), such as the VIP3Aa protein in cotton event COT102; or

9) a secreted protein from Bacillus thuringiensis or Bacillus cereus which is insecticidal in the presence of a crystal protein from Bacillus thuringiensis, such as the binary toxin made up of VIP3 and Cry 1A or Cry1F (U.S. Patent Appl. Nos. 61/126,083 and 61/195,019), or the binary toxin made up of the VIP3 protein and the Cry2Aa or Cry2Ab or Cry2Ae proteins (U.S. patent application Ser. No. 12/214,022 and EP 08010791.5).

10) a protein of 9) above wherein some, particularly 1 to 10, amino acids have been replaced by another amino acid to obtain a higher insecticidal activity to a target insect species, and/or to expand the range of target insect species affected, and/or because of changes introduced into the encoding DNA during cloning or transformation (while still encoding an insecticidal protein)

Of course, an insect-resistant transgenic plant, as used herein, also includes any plant comprising a combination of genes encoding the proteins of any one of the above classes 1 to 10. In one embodiment, an insect-resistant plant contains more than one transgene encoding a protein of any one of the above classes 1 to 10, to expand the range of target insect species affected when using different proteins directed at different target insect species, or to delay insect resistance development to the plants by using different proteins insecticidal to the same target insect species but having a different mode of action, such as binding to different receptor binding sites in the insect.

An “insect-resistant transgenic plant”, as used herein, further includes any plant containing at least one transgene comprising a sequence producing upon expression a double-stranded RNA which upon ingestion by a plant insect pest inhibits the growth of this insect pest, as described e.g. in WO 2007/080126, WO 2006/129204, WO 2007/074405, WO 2007/080127 and WO 2007/035650.

Plants or plant cultivars (obtained by plant biotechnology methods such as genetic engineering) which may also be treated according to the invention are tolerant to abiotic stresses. Such plants can be obtained by genetic transformation, or by selection of plants containing a mutation imparting such stress resistance. Particularly useful stress tolerance plants include:

1) plants which contain a transgene capable of reducing the expression and/or the activity of poly(ADP-ribose) polymerase (PARP) gene in the plant cells or plants as described in WO 00/04173, WO/2006/045633, EP 04077984.5, or EP 06009836.5.

2) plants which contain a stress tolerance enhancing transgene capable of reducing the expression and/or the activity of the PARG encoding genes of the plants or plants cells, as described e.g. in WO 2004/090140.

3) plants which contain a stress tolerance enhancing transgene coding for a plant-functional enzyme of the nicotineamide adenine dinucleotide salvage synthesis pathway including nicotinamidase, nicotinate phosphoribosyltransferase, nicotinic acid mononucleotide adenyl transferase, nicotinamide adenine dinucleotide synthetase or nicotine amide phosphorybosyltransferase as described e.g. in EP 04077624.7, WO 2006/133827, PCT/EP07/002,433, EP 1999263, or WO 2007/107326.

Plants or plant cultivars (obtained by plant biotechnology methods such as genetic engineering) which may also be treated according to the invention show altered quantity, quality and/or storage-stability of the harvested product and/or altered properties of specific ingredients of the harvested product such as:

1) transgenic plants which synthesize a modified starch, which in its physical-chemical characteristics, in particular the amylose content or the amylose/amylopectin ratio, the degree of branching, the average chain length, the side chain distribution, the viscosity behaviour, the gelling strength, the starch grain size and/or the starch grain morphology, is changed in comparison with the synthesised starch in wild type plant cells or plants, so that this is better suited for special applications. Said transgenic plants synthesizing a modified starch are disclosed, for example, in EP 0571427, WO 95/04826, EP 0719338, WO 96/15248, WO 96/19581, WO 96/27674, WO 97/11188, WO 97/26362, WO 97/32985, WO 97/42328, WO 97/44472, WO 97/45545, WO 98/27212, WO 98/40503, WO99/58688, WO 99/58690, WO 99/58654, WO 00/08184, WO 00/08185, WO 00/08175, WO 00/28052, WO 00/77229, WO 01/12782, WO 01/12826, WO 02/101059, WO 03/071860, WO 2004/056999, WO 2005/030942, WO 2005/030941, WO 2005/095632, WO 2005/095617, WO 2005/095619, WO 2005/095618, WO 2005/123927, WO 2006/018319, WO 2006/103107, WO 2006/108702, WO 2007/009823, WO 00/22140, WO 2006/063862, WO 2006/072603, WO 02/034923, EP 06090134.5, EP 06090228.5, EP 06090227.7, EP 07090007.1, EP 07090009.7, WO 01/14569, WO 02/79410, WO 03/33540, WO 2004/078983, WO 01/19975, WO 95/26407, WO 96/34968, WO 98/20145, WO 99/12950, WO 99/66050, WO 99/53072, U.S. Pat. No. 6,734,341, WO 00/11192, WO 98/22604, WO 98/32326, WO 01/98509, WO 01/98509, WO 2005/002359, U.S. Pat. No. 5,824,790, U.S. Pat. No. 6,013,861, WO 94/04693, WO 94/09144, WO 94/11520, WO 95/35026, WO 97/20936

2) transgenic plants which synthesize non starch carbohydrate polymers or which synthesize non starch carbohydrate polymers with altered properties in comparison to wild type plants without genetic modification. Examples are plants producing polyfructose, especially of the inulin and levan-type, as disclosed in EP 0663956, WO 96/01904, WO 96/21023, WO 98/39460, and WO 99/24593, plants producing alpha-1,4-glucans as disclosed in WO 95/31553, US 2002031826, U.S. Pat. No. 6,284,479, U.S. Pat. No. 5,712,107, WO 97/47806, WO 97/47807, WO 97/47808 and WO 00/14249, plants producing alpha-1,6 branched alpha-1,4-glucans, as disclosed in WO 00/73422, plants producing alternan, as disclosed in e.g. WO 00/47727, WO 00/73422, EP 06077301.7, U.S. Pat. No. 5,908,975 and EP 0728213,

3) transgenic plants which produce hyaluronan, as for example disclosed in WO 2006/032538, WO 2007/039314, WO 2007/039315, WO 2007/039316, JP 2006304779, and WO 2005/012529.

4) transgenic plants or hybrid plants, such as onions with characteristics such as ‘high soluble solids content’, ‘low pungency’ (LP) and/or ‘long storage’ (LS), as described in U.S. patent application Ser. Nos. 12/020,360 and 61/054,026.

Plants or plant cultivars (that can be obtained by plant biotechnology methods such as genetic engineering) which may also be treated according to the invention are plants, such as cotton plants, with altered fiber characteristics. Such plants can be obtained by genetic transformation, or by selection of plants contain a mutation imparting such altered fiber characteristics and include:
a) Plants, such as cotton plants, containing an altered form of cellulose synthase genes as described in WO 98/00549
b) Plants, such as cotton plants, containing an altered form of rsw2 or rsw3 homologous nucleic acids as described in WO 2004/053219
c) Plants, such as cotton plants, with increased expression of sucrose phosphate synthase as described in WO 01/17333
d) Plants, such as cotton plants, with increased expression of sucrose synthase as described in WO 02/45485
e) Plants, such as cotton plants, wherein the timing of the plasmodesmatal gating at the basis of the fiber cell is altered, e.g. through downregulation of fiber-selective 13-1,3-glucanase as described in WO 2005/017157, or as described in EP 08075514.3 or U.S. Patent Appl. No. 61/128,938
f) Plants, such as cotton plants, having fibers with altered reactivity, e.g. through the expression of N-acetylglucosaminetransferase gene including nodC and chitin synthase genes as described in WO 2006/136351

Plants or plant cultivars (that can be obtained by plant biotechnology methods such as genetic engineering) which may also be treated according to the invention are plants, such as oilseed rape or related Brassica plants, with altered oil profile characteristics. Such plants can be obtained by genetic transformation, or by selection of plants contain a mutation imparting such altered oil profile characteristics and include:

a) Plants, such as oilseed rape plants, producing oil having a high oleic acid content as described e.g. in U.S. Pat. No. 5,969,169, U.S. Pat. No. 5,840,946 or U.S. Pat. No. 6,323,392 or U.S. Pat. No. 6,063,947

b) Plants such as oilseed rape plants, producing oil having a low linolenic acid content as described in U.S. Pat. No. 6,270,828, U.S. Pat. No. 6,169,190, or U.S. Pat. No. 5,965,755

c) Plant such as oilseed rape plants, producing oil having a low level of saturated fatty acids as described e.g. in U.S. Pat. No. 5,434,283 or U.S. patent application Ser. No. 12/668,303

Plants or plant cultivars (that can be obtained by plant biotechnology methods such as genetic engineering) which may also be treated according to the invention are plants, such as potatoes which are virus-resistant, e.g. against potato virus Y (event SY230 and SY233 from Tecnoplant, Argentina), which are disease resistant, e.g. against potato late blight (e.g. RB gene), which show a reduction in cold-induced sweetening (carrying the Nt-Inhh, IIR-INV gene) or which possess a dwarf phenotype (Gene A-20 oxidase).

Plants or plant cultivars (that can be obtained by plant biotechnology methods such as genetic engineering) which may also be treated according to the invention are plants, such as oilseed rape or related Brassica plants, with altered seed shattering characteristics. Such plants can be obtained by genetic transformation, or by selection of plants contain a mutation imparting such altered seed shattering characteristics and include plants such as oilseed rape plants with delayed or reduced seed shattering as described in U.S. Patent Appl. No. 61/135,230, and EP 08075648.9, WO09/068,313 and WO10/006,732.

Particularly useful transgenic plants which may be treated according to the invention are plants containing transformation events, or combination of transformation events, that are the subject of petitions for non-regulated status, in the United States of America, to the Animal and Plant Health Inspection Service (APHIS) of the United States Department of Agriculture (USDA) whether such petitions are granted or are still pending. At any time this information is readily available from APHIS (4700 River Road Riverdale, Md. 20737, USA), for instance on its internet site (URL http://www.aphis.usda.gov/brs/not_reg.html). On the filing date of this application the petitions for nonregulated status that were pending with APHIS or granted by APHIS were those listed in table B which contains the following information:
Petition: the identification number of the petition. Technical descriptions of the transformation events can be found in the individual petition documents which are obtainable from APHIS, for example on the APHIS website, by reference to this petition number. These descriptions are herein incorporated by reference.
Extension of Petition: reference to a previous petition for which an extension is requested.
Institution: the name of the entity submitting the petition.
Regulated article: the plant species concerned.
Transgenic phenotype: the trait conferred to the plants by the transformation event.
Transformation event or line: the name of the event or events (sometimes also designated as lines or lines) for which nonregulated status is requested.
APHIS documents: various documents published by APHIS in relation to the Petition and which can be requested with APHIS.

Additional particularly useful plants containing single transformation events or combinations of transformation events are listed for example in the databases from various national or regional regulatory agencies (see for example http://gmoinfo.irc.it/gmp_browse.aspx and http://www.agbios.com/dbase.php).

The present invention relates also to the use of fluopyram and compositions comprising fluopyram for controlling nematodes in plants containing transformation events, or a combination of transformation events, and that are listed for example in the databases for various national or regional regulatory agencies including Event 1143-14A (cotton, insect control, not deposited, described in WO2006/128569); Event 1143-51B (cotton, insect control, not deposited, described in WO2006/128570); Event 1445 (cotton, herbicide tolerance, not deposited, described in US2002120964 or WO2002/034946); Event 17053 (rice, herbicide tolerance, deposited as PTA-9843, described in WO2010/117737); Event 17314 (rice, herbicide tolerance, deposited as PTA-9844, described in WO2010/117735); Event 281-24-236 (cotton, insect control—herbicide tolerance, deposited as PTA-6233, described in WO2005/103266 or US2005216969); Event 3006-210-23 (cotton, insect control—herbicide tolerance, deposited as PTA-6233, described in US2007143876 or WO2005/103266); Event 3272 (corn, quality trait, deposited as PTA-9972, described in WO2006098952 or US2006230473); Event 40416 (corn, insect control—herbicide tolerance, deposited as ATCC PTA-11508, described in WO2011/075593); Event 43A47 (corn, insect control—herbicide tolerance, deposited as ATCC PTA-11509, described in WO2011/075595); Event 5307 (corn, insect control, deposited as ATCC PTA-9561, described in WO2010/077816); Event ASR-368 (bent grass, herbicide tolerance, deposited as ATCC PTA-4816, described in US2006162007 or WO2004053062); Event B16 (corn, herbicide tolerance, not deposited, described in US2003126634); Event BPS-CV127-9 (soybean, herbicide tolerance, deposited as NCIMB No. 41603, described in WO2010/080829); Event CE43-67B (cotton, insect control, deposited as DSM ACC2724, described in US2009217423 or WO2006/128573); Event CE44-69D (cotton, insect control, not deposited, described in US20100024077); Event CE44-69D (cotton, insect control, not deposited, described in WO2006/128571); Event CE46-02A (cotton, insect control, not deposited, described in WO2006/128572); Event COT102 (cotton, insect control, not deposited, described in US2006130175 or WO2004039986); Event COT202 (cotton, insect control, not deposited, described in US2007067868 or WO2005054479); Event COT203 (cotton, insect control, not deposited, described in WO2005/054480); Event DAS40278 (corn, herbicide tolerance, deposited as ATCC PTA-10244, described in WO2011/022469); Event DAS-59122-7 (corn, insect control—herbicide tolerance, deposited as ATCC PTA 11384, described in US2006070139); Event DAS-59132 (corn, insect control—herbicide tolerance, not deposited, described in WO2009/100188); Event DAS68416 (soybean, herbicide tolerance, deposited as ATCC PTA-10442, described in WO2011/066384 or WO2011/066360); Event DP-098140-6 (corn, herbicide tolerance, deposited as ATCC PTA-8296, described in US2009137395 or WO2008/112019); Event DP-305423-1 (soybean, quality trait, not deposited, described in US2008312082 or WO2008/054747); Event DP-32138-1 (corn, hybridization system, deposited as ATCC PTA-9158, described in US20090210970 or WO2009/103049); Event DP-356043-5 (soybean, herbicide tolerance, deposited as ATCC PTA-8287, described in US20100184079 or WO2008/002872); Event EE-1 (brinjal, insect control, not deposited, described in WO2007/091277); Event FI117 (corn, herbicide tolerance, deposited as ATCC 209031, described in US2006059581 or WO1998/044140); Event GA21 (corn, herbicide tolerance, deposited as ATCC 209033, described in US2005086719 or WO1998/044140); Event GG25 (corn, herbicide tolerance, deposited as ATCC 209032, described in US2005188434 or WO1998/044140); Event GHB119 (cotton, insect control—herbicide tolerance, deposited as ATCC PTA-8398, described in WO2008/151780); Event GHB614 (cotton, herbicide tolerance, deposited as ATCC PTA-6878, described in US2010050282 or WO2007/017186); Event GJ11 (corn, herbicide tolerance, deposited as ATCC 209030, described in US2005188434 or WO1998/044140); Event GM RZ13 (sugar beet, virus resistance, deposited as NCIMB-41601, described in WO2010/076212); Event H7-1 (sugar beet, herbicide tolerance, deposited as NCIMB 41158 or NCIMB 41159, described in US2004172669 or WO2004/074492); Event JOPLIN1 (wheat, disease tolerance, not deposited, described in US2008064032); Event LL27 (soybean, herbicide tolerance, deposited as NCIMB41658, described in WO2006/108674 or US2008320616); Event LL55 (soybean, herbicide tolerance, deposited as NCIMB 41660, described in WO2006/108675 or US2008196127); Event LLcotton25 (cotton, herbicide tolerance, deposited as ATCC PTA-3343, described in WO2003013224 or US2003097687); Event LLRICE06 (rice, herbicide tolerance, deposited as ATCC-23352, described in U.S. Pat. No. 6,468,747 or WO2000/026345); Event LLRICE601 (rice, herbicide tolerance, deposited as ATCC PTA-2600, described in US20082289060 or WO2000/026356); Event LY038 (corn, quality trait, deposited as ATCC PTA-5623, described in US2007028322 or WO2005061720); Event MIR162 (corn, insect control, deposited as PTA-8166, described in US2009300784 or WO2007/142840); Event MIR604 (corn, insect control, not deposited, described in US2008167456 or WO2005103301); Event MON15985 (cotton, insect control, deposited as ATCC PTA-2516, described in US2004-250317 or WO2002/100163); Event MON810 (corn, insect control, not deposited, described in US2002102582); Event MON863 (corn, insect control, deposited as ATCC PTA-2605, described in WO2004/011601 or US2006095986); Event MON87427 (corn, pollination control, deposited as ATCC PTA-7899, described in WO2011/062904); Event MON87460 (corn, stress tolerance, deposited as ATCC PTA-8910, described in WO2009/111263 or US20110138504); Event MON87701 (soybean, insect control, deposited as ATCC PTA-8194, described in US2009130071 or WO2009/064652); Event MON87705 (soybean, quality trait—herbicide tolerance, deposited as ATCC PTA-9241, described in US20100080887 or WO2010/037016); Event MON87708 (soybean, herbicide tolerance, deposited as ATCC PTA9670, described in WO2011/034704); Event MON87754 (soybean, quality trait, deposited as ATCC PTA-9385, described in WO2010/024976); Event MON87769 (soybean, quality trait, deposited as ATCC PTA-8911, described in US20110067141 or WO2009/102873); Event MON88017 (corn, insect control—herbicide tolerance, deposited as ATCC PTA-5582, described in US2008028482 or WO2005/059103); Event MON88913 (cotton, herbicide tolerance, deposited as ATCC PTA-4854, described in WO2004/072235 or US2006059590); Event MON89034 (corn, insect control, deposited as ATCC PTA-7455, described in WO2007/140256 or US2008260932); Event MON89788 (soybean, herbicide tolerance, deposited as ATCC PTA-6708, described in US2006282915 or WO2006/130436); Event MS11 (oilseed rape, pollination control—herbicide tolerance, deposited as ATCC PTA-850 or PTA-2485, described in WO2001/031042); Event MS8 (oilseed rape, pollination control—herbicide tolerance, deposited as ATCC PTA-730, described in WO2001/041558 or US2003188347); Event NK603 (corn, herbicide tolerance, deposited as ATCC PTA-2478, described in US2007-292854); Event PE-7 (rice, insect control, not deposited, described in WO2008/114282); Event RF3 (oilseed rape, pollination control—herbicide tolerance, deposited as ATCC PTA-730, described in WO2001/041558 or US2003188347); Event RT73 (oilseed rape, herbicide tolerance, not deposited, described in WO2002/036831 or US2008070260); Event T227-1 (sugar beet, herbicide tolerance, not deposited, described in WO2002/44407 or US2009265817); Event T25 (corn, herbicide tolerance, not deposited, described in US2001029014 or WO2001/051654); Event T304-40 (cotton, insect control—herbicide tolerance, deposited as ATCC PTA-8171, described in US2010077501 or WO2008/122406); Event T342-142 (cotton, insect control, not deposited, described in WO2006/128568); Event TC1507 (corn, insect control—herbicide tolerance, not deposited, described in US2005039226 or WO2004/099447); Event VIP1034 (corn, insect control—herbicide tolerance, deposited as ATCC PTA-3925., described in WO2003/052073), Event 32316 (corn, insect control-herbicide tolerance, deposited as PTA-11507, described in WO2011/084632), Event 4114 (corn, insect control-herbicide tolerance, deposited as PTA-11506, described in WO2011/084621).

The present invention relates also to the use of fluopyram and compositions comprising fluopyram for controlling nematodes in plants carrying the one or more of the events listed in table A below:

| | Event | Company | Description | Crop | Patent Ref |
|---|---|---|---|---|---|
| A-1 | ASR368 | Scotts Seeds | Glyphosate tolerance derived by inserting a modified 5- | Agrostis stolonifera | US 2006-162007 |
| | | | enolpyruvylshikimate-3-phosphate synthase (EPSPS) | Creeping Bentgrass | |
| | | | encoding gene from Agrobacterium tumefaciens, parent line B99061 | | |
| A-2 | GM RZ13 | | Beet Necrotic Yellow Vein Virus (BNYVV) resistance | Beta vulgaris (sugar beet) | WO2010076212 |
| A-3 | H7-1 | Monsanto Company | Glyphosate herbicide tolerant sugar beet produced by | Beta vulgaris (sugar beet) | WO 2004-074492 |
| | | | inserting a gene encoding the enzyme 5- | | |
| | | | enolypyruvylshikimate-3-phosphate synthase (EPSPS) | | |
| | | | from the CP4 strain of Agrobacterium tumefaciens,; WO 2004-074492 | | |
| A-4 | T120-7 | Bayer CropScience (Aventis | Introduction of the PPT-acetyltransferase (PAT) encoding | Beta vulgaris (sugar beet) | |
| | | CropScience(AgrEvo)) | gene from Streptomyces viridochromogenes, an aerobic | | |
| | | | soil bacteria. PPT normally acts to inhibit glutamine | | |
| | | | synthetase, causing a fatal accumulation of ammonia. | | |
| | | | Acetylated PPT is inactive. | | |
| A-5 | GTSB77 | Novartis Seeds; Monsanto | Glyphosate herbicide tolerant sugar beet produced by | Beta vulgaris (sugar beet) | |
| | | Company | inserting a gene encoding the enzyme 5- | | |
| | | | enolypyruvylshikimate-3-phosphate synthase (EPSPS) | | |
| | | | from the CP4 strain of Agrobacterium tumefaciens. | | |
| A-6 | T227-1 | | Glyphosate tolerance; US 2004-117870 | Beta vulgaris (sugar beet) | US 2004-117870 |
| A-7 | 23-18-17, 23-198 | Monsanto Company | High laurate (12:0) and myristate (14:0) canola produced | Brassica napus (Argentine | |
| | | (formerly Calgene) | by inserting a thioesterase encoding gene from the | Canola) | |
| | | | California bay laurel (Umbellularia californica). | | |
| A-8 | 45A37, 46A40 | Pioneer Hi-Bred | High oleic acid and low linolenic acid canola produced | Brassica napus (Argentine | |
| | | International Inc. | through a combination of chemical mutagenesis to select | Canola) | |
| | | | for a fatty acid desaturase mutant with elevated oleic acid, | | |
| | | | and traditional back-crossing to introduce the low linolenic acid trait. | | |
| A-9 | 46A12, 46A16 | Pioneer Hi-Bred | Combination of chemical mutagenesis, to achieve the high | Brassica napus (Argentine | |
| | | International Inc. | oleic acid trait, and traditional breeding with registered | Canola) | |
| | | | canola varieties. | | |
| A- | GT200 | Monsanto Company | Glyphosate herbicide tolerant canola produced by | Brassica napus (Argentine | |
| 10 | | | inserting genes encoding the enzymes 5- | Canola) | |
| | | | enolypyruvylshikimate-3-phosphate synthase (EPSPS) | | |
| | | | from the CP4 strain of Agrobacterium tumefaciens and | | |
| | | | glyphosate oxidase from Ochrobactrum anthropi. | | |
| A- | GT73, RT73 | Monsanto Company | Glyphosate herbicide tolerant canola produced by | Brassica napus (Argentine | |
| 11 | | | inserting genes encoding the enzymes 5- | Canola) | |
| | | | enolypyruvylshikimate-3-phosphate synthase (EPSPS) | | |
| | | | from the CP4 strain of Agrobacterium tumefaciens and | | |
| | | | glyphosate oxidase from Ochrobactrum anthropi. | | |
| A- | HCN10 | Aventis CropScience | Introduction of the PPT-acetyltransferase (PAT) encoding | Brassica napus (Argentine | |
| 12 | | | gene from Streptomyces viridochromogenes, an aerobic | Canola) | |
| | | | soil bacteria. PPT normally acts to inhibit glutamine | | |
| | | | synthetase, causing a fatal accumulation of ammonia. | | |
| | | | Acetylated PPT is inactive. | | |
| A- | HCN92 | Bayer CropScience (Aventis | Introduction of the PPT-acetyltransferase (PAT) encoding | Brassica napus (Argentine | |
| 13 | | Crop Science(AgrEvo)) | gene from Streptomyces viridochromogenes, an aerobic | Canola) | |
| | | | soil bacteria. PPT normally acts to inhibit glutamine | | |
| | | | synthetase, causing a fatal accumulation of ammonia. | | |
| | | | Acetylated PPT is inactive. | | |
| A- | MS1, RF1 | Aventis CropScience | Male-sterility, fertility restoration, pollination control | Brassica napus (Argentine | |
| 14 | =>PGS1 | (formerly Plant Genetic | system displaying glufosinate herbicide tolerance. MS | Canola) | |
| | | Systems) | lines contained the barnase gene from Bacillus | | |
| | | | amyloliquefaciens, RF lines contained the barstar gene | | |
| | | | from the same bacteria, and both lines contained the | | |
| | | | phosphinothricin N-acetyltransferase (PAT) encoding | | |
| | | | gene from Streptomyces hygroscopicus. | | |
| A- | MS1, RF2 | Aventis CropScience | Male-sterility, fertility restoration, pollination control | Brassica napus (Argentine | |
| 15 | =>PGS2 | (formerly Plant Genetic | system displaying glufosinate herbicide tolerance. MS | Canola) | |
| | | Systems) | lines contained the barnase gene from Bacillus | | |
| | | | amyloliquefaciens, RF lines contained the barstar gene | | |
| | | | from the same bacteria, and both lines contained the | | |
| | | | phosphinothricin N-acetyltransferase (PAT) encoding | | |
| | | | gene from Streptomyces hygroscopicus. | | |
| A- | MS8 × RF3 | Bayer CropScience (Aventis | Male-sterility, fertility restoration, pollination control | Brassica napus (Argentine | |
| 16 | | CropScience(AgrEvo)) | system displaying glufosinate herbicide tolerance. MS | Canola) | |
| | | | lines contained the barnase gene from Bacillus | | |
| | | | amyloliquefaciens, RF lines contained the barstar gene | | |
| | | | from the same bacteria, and both lines contained the | | |
| | | | phosphinothricin N-acetyltransferase (PAT) encoding | | |
| | | | gene from Streptomyces hygroscopicus. | | |
| A- | MS-B2 | | Male sterility; WO 01/31042 | Brassica napus (Argentine | |
| 17 | | | | Canola) | |
| A- | MS-BN1/RF-BN1 | | Male sterility/restoration; WO 01/41558 | Brassica napus (Argentine | |
| 18 | | | | Canola) | |
| A- | NS738, NS1471, | Pioneer Hi-Bred | Selection of somaclonal variants with altered acetolactate | Brassica napus (Argentine | |
| 19 | NS1473 | International Inc. | synthase (ALS) enzymes, following chemical mutagenesis. | Canola) | |
| | | | Two lines (P1, P2) were initially selected with | | |
| | | | modifications at different unlinked loci. NS738 contains | | |
| | | | the P2 mutation only. | | |
| A- | OXY-235 | Aventis CropScience | Tolerance to the herbicides bromoxynil and ioxynil by | Brassica napus (Argentine | |
| 20 | | (formerly Rhone Poulenc | incorporation of the nitrilase gene from Klebsiella | Canola) | |
| | | Inc.) | pneumoniae. | | |
| A- | PHY14, PHY35 | Aventis CropScience | Male sterility was via insertion of the barnase ribonuclease | Brassica napus (Argentine | |
| 21 | | (formerly Plant Genetic | gene from Bacillus amyloliquefaciens; fertility restoration | Canola) | |
| | | Systems) | by insertion of the barstar RNase inhibitor; PPT resistance | | |
| | | | was via PPT-acetyltransferase (PAT) from Streptomyces | | |
| | | | hygroscopicus. | | |
| A- | PHY36 | Aventis CropScience | Male sterility was via insertion of the barnase ribonuclease | Brassica napus (Argentine | |
| 22 | | (formerly Plant Genetic | gene from Bacillus amyloliquefaciens; fertility restoration | Canola) | |
| | | Systems) | by insertion of the barstar RNase inhibitor; PPT resistance | | |
| | | | was via PPT-acetyltransferase (PAT) from Streptomyces | | |
| | | | hygroscopicus. | | |
| A- | RT73 | | Glyphosate resistance; WO 02/36831 | Brassica napus (Argentine | WO 02/36831 |
| 23 | | | | Canola) | |
| A- | T45 (HCN28) | Bayer CropScience (Aventis | Introduction of the PPT-acetyltransferase (PAT) encoding | Brassica napus (Argentine | |
| 24 | | Crop Science(AgrEvo)) | gene from Streptomyces viridochromogenes, an aerobic | Canola) | |
| | | | soil bacteria. PPT normally acts to inhibit glutamine | | |
| | | | synthetase, causing a fatal accumulation of ammonia. | | |
| | | | Acetylated PPT is inactive. | | |
| A- | HCR-1 | Bayer CropScience (Aventis | Introduction of the glufosinate ammonium herbicide | Brassica rapa (Polish | |
| 25 | | Crop Science(AgrEvo)) | tolerance trait from transgenic B. napus line T45. This trait | Canola) | |
| | | | is mediated by the phosphinothricin acetyltransferase | | |
| | | | (PAT) encoding gene from S. viridochromogenes. | | |
| A- | ZSR500/502 | Monsanto Company | Introduction of a modified 5-enol-pyruvylshikimate-3- | Brassica rapa (Polish | |
| 26 | | | phosphate synthase (EPSPS) and a gene from | Canola) | |
| | | | Achromobacter sp that degrades glyphosate by conversion | | |
| | | | to aminomethylphosphonic acid (AMPA) and glyoxylate | | |
| | | | by interspecific crossing with GT73. | | |
| A- | EE-1 | | Insect resistance (Cry1Ac) | Brinjal | WO 2007/091277 |
| 27 | | | | | |
| A- | 55-1/63-1 | Cornell University | Papaya ringspot virus (PRSV) resistant papaya produced | Carica papaya (Papaya) | |
| 28 | | | by inserting the coat protein (CP) encoding sequences | | |
| | | | from this plant potyvirus. | | |
| A- | X17-2 | University of Florida | Papaya ringspot virus (PRSV) resistant papaya produced | Carica papaya (Papaya) | |
| 29 | | | by inserting the coat protein (CP) encoding sequences | | |
| | | | from PRSV isolate H1K with a thymidine inserted after | | |
| | | | the initiation codon to yield a frameshift. Also contains | | |
| | | | nptII as a selectable marker. | | |
| A- | RM3-3, RM3-4, | Bejo Zaden BV | Male sterility was via insertion of the barnase ribonuclease | Cichorium intybus (Chicory) | |
| 30 | RM3-6 | | gene from Bacillus amyloliquefaciens; PPT resistance was | | |
| | | | via the bar gene from S. hygroscopicus, which encodes the | | |
| | | | PAT enzyme. | | |
| A- | A, B | Agritope Inc. | Reduced accumulation of S-adenosylmethionine (SAM), | Cucumis melo (Melon) | |
| 32 | | | and consequently reduced ethylene synthesis, by | | |
| | | | introduction of the gene encoding S-adenosylmethionine | | |
| | | | hydrolase. | | |
| A- | CZW-3 | Asgrow (USA); Seminis | Cucumber mosiac virus (CMV), zucchini yellows mosaic | Cucurbita pepo (Squash) | |
| 33 | | Vegetable Inc. (Canada) | (ZYMV) and watermelon mosaic virus (WMV) 2 resistant | | |
| | | | squash (Curcurbita pepo) produced by inserting the coat | | |
| | | | protein (CP) encoding sequences from each of these plant | | |
| | | | viruses into the host genome. | | |
| A- | ZW20 | Upjohn (USA); Seminis | Zucchini yellows mosaic (ZYMV) and watermelon mosaic | Cucurbita pepo (Squash) | |
| 34 | | Vegetable Inc. (Canada) | virus (WMV) 2 resistant squash (Curcurbita pepo) | | |
| | | | produced by inserting the coat protein (CP) encoding | | |
| | | | sequences from each of these plant potyviruses into the | | |
| | | | host genome. | | |
| A- | 66 | Florigene Pty Ltd. | Delayed senescence and sulfonylurea herbicide tolerant | Dianthus | |
| 35 | | | carnations produced by inserting a truncated copy of the | caryophyllus (Carnation) | |
| | | | carnation aminocyclopropane cyclase (ACC) synthase | | |
| | | | encoding gene in order to suppress expression of the | | |
| | | | endogenous unmodified gene, which is required for | | |
| | | | normal ethylene biosynthesis. Tolerance to sulfonyl urea | | |
| | | | herbicides was via the introduction of a chlorsulfuron | | |
| | | | tolerant version of the acetolactate synthase (ALS) | | |
| | | | encoding gene from tobacco. | | |
| A- | 4, 11, 15, 16 | Florigene Pty Ltd. | Modified colour and sulfonylurea herbicide tolerant | Dianthus | |
| 36 | | | carnations produced by inserting two anthocyanin | caryophyllus (Carnation) | |
| | | | biosynthetic genes whose expression results in a | | |
| | | | violet/mauve colouration. Tolerance to sulfonyl urea | | |
| | | | herbicides was via the introduction of a chlorsulfuron | | |
| | | | tolerant version of the acetolactate synthase (ALS) | | |
| | | | encoding gene from tobacco. | | |
| A- | 959A, 988A, | Florigene Pty Ltd. | Introduction of two anthocyanin biosynthetic genes to | Dianthus | |
| 37 | 1226A, 1351A, | | result in a violet/mauve colouration; Introduction of a | caryophyllus (Carnation) | |
| | 1363A, 1400A | | variant form of acetolactate synthase (ALS). | | |
| A- | 3560.4.3.5 | | Glyphosate/ALS inhibitor-tolerance; WO 2008002872 | Glycine max L. (Soybean) | WO 2008002872, |
| 38 | | | | | US2010184079 |
| A- | A2704-12, A2704- | Bayer CropScience (Aventis | Glufosinate ammonium herbicide tolerant soybean | Glycine max L. (Soybean) | WO 2006/108674 |
| 39 | 21 | CropScience(AgrEvo)) | produced by inserting a modified phosphinothricin | | |
| | | | acetyltransferase (PAT) encoding gene from the soil | | |
| | | | bacterium Streptomyces viridochromogenes.; WO | | |
| | | | 2006/108674 | | |
| A- | A5547-127 | Bayer CropScience (Aventis | Glufosinate ammonium herbicide tolerant soybean | Glycine max L. (Soybean) | |
| 40 | | CropScience(AgrEvo)) | produced by inserting a modified phosphinothricin | | |
| | | | acetyltransferase (PAT) encoding gene from the soil | | |
| | | | bacterium Streptomyces viridochromogenes. | | |
| A- | A5547-35 | Bayer CropScience (Aventis | Glufosinate tolerance; WO 2006/108675 | Glycine max L. (Soybean) | WO 2006/108675 |
| 41 | | CropScience(AgrEvo)) | | | |
| A- | DP-305423-1 | Pioneer Hi-Bred | High oleic acid/ALS inhibitor tolerance; | Glycine max L. (Soybean) | WO 2008/054747 |
| 42 | | International Inc. | | | |
| A- | DP356043 | Pioneer Hi-Bred | Soybean event with two herbicide tolerance genes: | Glycine max L. (Soybean) | |
| 43 | | International Inc. | glyphosate N-acetlytransferase, which detoxifies | | |
| | | | glyphosate, and a modified acetolactate synthase (A | | |
| A- | G94-1, G94-19, | DuPont Canada Agricultural | High oleic acid soybean produced by inserting a second | Glycine max L. (Soybean) | |
| 44 | G168 | Products | copy of the fatty acid desaturase (GmFad2-1) encoding | | |
| | | | gene from soybean, which resulted in “silencing” of the | | |
| | | | endogenous host gene. | | |
| A- | GTS 40-3-2 | Monsanto Company | Glyphosate tolerant soybean variety produced by inserting | Glycine max L. (Soybean) | |
| 45 | | | a modified 5-enolpyruvylshikimate-3-phosphate synthase | | |
| | | | (EPSPS) encoding gene from the soil bacterium | | |
| | | | Agrobacterium tumefaciens. | | |
| A- | GU262 | Bayer CropScience (Aventis | Glufosinate ammonium herbicide tolerant soybean | Glycine max L. (Soybean) | |
| 46 | | Crop Science(AgrEvo)) | produced by inserting a modified phosphinothricin | | |
| | | | acetyltransferase (PAT) encoding gene from the soil | | |
| | | | bacterium Streptomyces viridochromogenes. | | |
| A- | MON87701 | Monsanto Company | insect resistance (CryIac); WO 2009064652 | Glycine max L. (Soybean) | WO 2009064652 |
| 47 | | | | | |
| A- | MON87705 | Monsanto Company | altered fatty acid levels (mid-oleic and low saturate); WO | Glycine max L. (Soybean) | WO 2010037016 |
| 48 | | | 2010037016 | | |
| A- | MON87754 | Monsanto Company | increased oil content; | Glycine max L. (Soybean) | WO 2010024976 |
| 49 | | | | | |
| A- | MON87769 | Monsanto Company | stearidonic acid (SDA) comprising oil; | Glycine max L. (Soybean) | WO 2009102873 |
| 50 | | | | | |
| A- | MON89788 | Monsanto Company | Glyphosate-tolerant soybean produced by inserting a | Glycine max L. (Soybean) | WO2006130436 |
| 51 | | | modified 5-enolpyruvylshikimate-3-phosphate synthase | | |
| | | | (EPSPS) encoding aroA (epsps) gene from Agrobacterium | | |
| | | | tumefaciens CP4; | | |
| A- | MON89788, | Monsanto Company | Glyphosate tolerance, WO2006130436 | Glycine max L. (Soybean) | |
| 52 | MON19788 | | | | |
| A- | OT96-15 | Agriculture & Agri-Food | Low linolenic acid soybean produced through traditional | Glycine max L. (Soybean) | |
| 53 | | Canada | cross-breeding to incorporate the novel trait from a | | |
| | | | naturally occurring fanl gene mutant that was selected for | | |
| | | | low linolenic acid. | | |
| A- | W62, W98 | Bayer CropScience (Aventis | Glufosinate ammonium herbicide tolerant soybean | Glycine max L. (Soybean) | |
| 54 | | CropScience(AgrEvo)) | produced by inserting a modified phosphinothricin | | |
| | | | acetyltransferase (PAT) encoding gene from the soil | | |
| | | | bacterium Streptomyces hygroscopicus. | | |
| A- | 15985 | Monsanto Company | Insect resistant cotton derived by transformation of the | Gossypium hirsutum | |
| 55 | | | DP50B parent variety, which contained event 531 | L. (Cotton) | |
| | | | (expressing Cry1Ac protein), with purified plasmid DNA | | |
| | | | containing the cry2Ab gene from B. thuringiensis subsp. | | |
| | | | kurstaki. | | |
| A- | 1143-14A | | Insect resistance (Cry1Ab) | Gossypium hirsutum | WO 2006/128569 |
| 56 | | | | L. (Cotton) | |
| A- | 1143-51B | | Insect resistance (Cry1Ab) | Gossypium hirsutum | WO 2006/128570 |
| 57 | | | | L. (Cotton) | |
| A- | 19-51A | DuPont Canada Agricultural | Introduction of a variant form of acetolactate synthase | Gossypium hirsutum | |
| 58 | | Products | (ALS). | L. (Cotton) | |
| A- | 281-24-236 | DOW AgroSciences LLC | Insect-resistant cotton produced by inserting the cry1F | Gossypium hirsutum | |
| 59 | | | gene from Bacillus thuringiensis var. aizawai. The PAT | L. (Cotton) | |
| | | | encoding gene from Streptomyces viridochromogenes was | | |
| | | | introduced as a selectable marker. | | |
| A- | 3006-210-23 | DOW AgroSciences LLC | Insect-resistant cotton produced by inserting the cry1Ac | Gossypium hirsutum | |
| 60 | | | gene from Bacillus thuringiensis subsp. kurstaki. The PAT | L. (Cotton) | |
| | | | encoding gene from Streptomyces viridochromogenes was | | |
| | | | introduced as a selectable marker. | | |
| A- | 31807/31808 | Calgene Inc. | Insect-resistant and bromoxynil herbicide tolerant cotton | Gossypium hirsutum | |
| 61 | | | produced by inserting the cry1Ac gene from Bacillus | L. (Cotton) | |
| | | | thuringiensis and a nitrilase encoding gene from Klebsiella | | |
| | | | pneumoniae. | | |
| A- | BXN | Calgene Inc. | Bromoxynil herbicide tolerant cotton produced by | Gossypium hirsutum | |
| 62 | | | inserting a nitrilase encoding gene from Klebsiella | L. (Cotton) | |
| | | | pneumoniae. | | |
| A- | CE43-67B | | Insect resistance (Cry1Ab) | Gossypium hirsutum | WO |
| 63 | | | | L. (Cotton) | 2006/128573, US |
| | | | | | 2011020828 |
| A- | CE44-69D | | Insect resistance (Cry1Ab) | Gossypium hirsutum | WO 2006/128571 |
| 64 | | | | L. (Cotton) | |
| A- | CE46-02A | | Insect resistance (Cry1Ab) | Gossypium hirsutum | WO 2006/128572 |
| 65 | | | | L. (Cotton) | |
| A- | Cot102 | Syngenta Seeds, Inc. | Insect-resistant cotton produced by inserting the vip3A(a) | Gossypium hirsutum | US 2006-130175, |
| 66 | | | gene from Bacillus thuringiensis AB88. The APH4 | L. (Cotton) | WO2004039986, |
| | | | encoding gene from E. coli was introduced as a selectable | | US 2010298553 |
| | | | marker.; | | |
| A- | COT202 | Syngenta Seeds, Inc. | Insect resistance (VIP3A) | Gossypium hirsutum | US2009181399 |
| 67 | | | | L. (Cotton) | |
| A- | Cot202 | Syngenta Seeds, Inc. | Insect resistance (VIP3) | Gossypium hirsutum | US 2007-067868 |
| 68 | | | | L. (Cotton) | |
| A- | Cot67B | Syngenta Seeds, Inc. | Insect-resistant cotton produced by inserting a full-length | Gossypium hirsutum | |
| 69 | | | cry1Ab gene from Bacillus thuringiensis. The APH4 | L. (Cotton) | |
| | | | encoding gene from E. coli was introduced as a selectable | | |
| | | | marker. | | |
| A- | DAS-21Ø23-5 × | DOW AgroSciences LLC | WideStrike ™, a stacked insect-resistant cotton derived | Gossypium hirsutum | |
| 70 | DAS-24236-5 | | from conventional cross-breeding of parental lines 3006- | L. (Cotton) | |
| | | | 210-23 (OECD identifier: DAS-21Ø23-5) and 281-24-236 | | |
| | | | (OECD identifier: DAS-24236-5). | | |
| A- | DAS-21Ø23-5 × | DOW AgroSciences LLC | Stacked insect-resistant and glyphosate-tolerant cotton | Gossypium hirsutum | |
| 71 | DAS-24236-5 × | and Pioneer Hi-Bred | derived from conventional cross-breeding of WideStrike | L. (Cotton) | |
| | MON88913 | International Inc. | cotton (OECD identifier: DAS-21Ø23-5 × DAS-24236-5) | | |
| | | | with MON88913, known as RoundupReady Flex (OECD | | |
| | | | identifier: MON-88913-8). | | |
| A- | DAS-21Ø23-5 × | DOW AgroSciences LLC | WideStrike ™/Roundup Ready ® cotton, a stacked insect- | Gossypium hirsutum | |
| 72 | DAS-24236-5 × | | resistant and glyphosate-tolerant cotton derived from | L. (Cotton) | |
| | MON-Ø1445-2 | | conventional cross-breeding of WideStrike cotton (OECD | | |
| | | | identifier: DAS-21Ø23-5 × DAS-24236-5) with | | |
| | | | MON1445 (OECD identifier: MON-Ø1445-2). | | |
| A- | EE-GH3 | | Glyphosate tolerance | Gossypium hirsutum | WO 2007/017186 |
| 73 | | | | L. (Cotton) | |
| A- | EE-GH5 | | Insect resistance (Cry1Ab) | Gossypium hirsutum | WO 2008/122406 |
| 74 | | | | L. (Cotton) | |
| A- | EE-GH6 | | Insect resistance (cry2Ae) | Gossypium hirsutum | WO2008151780, |
| 75 | | | | L. (Cotton) | US2010218281 |
| A- | event 281-24-236 | | Insect resistance (Cry1F) | Gossypium hirsutum | WO 2005/103266 |
| 76 | | | | L. (Cotton) | |
| A- | Event-1 | JK Agri Genetics Ltd (India) | Insect-resistant cotton produced by inserting the cry1Ac | Gossypium hirsutum | |
| 77 | | | gene from Bacillus thuringiensis subsp. kurstaki HD-73 | L. (Cotton) | |
| | | | (B.t.k.). | | |
| A- | event3006-210-23 | | Insect resistance (Cry1Ac) | Gossypium hirsutum | WO 2005/103266 |
| 78 | | | | L. (Cotton) | |
| A- | GBH614 | Bayer CropScience (Aventis | Glyphosate herbicide tolerant cotton produced by inserting | Gossypium hirsutum | |
| 79 | | CropScience(AgrEvo)) | 2mepsps gene into variety Coker312 by Agrobacterium | L. (Cotton) | |
| | | | under the control of Ph4a748At and TPotpC | | |
| A- | LLCotton25 | Bayer CropScience (Aventis | Glufosinate ammonium herbicide tolerant cotton produced | Gossypium hirsutum | |
| 80 | | CropScience(AgrEvo)) | by inserting a modified phosphinothricin acetyltransferase | L. (Cotton) | |
| | | | (PAT) encoding gene from the soil bacterium | | |
| | | | Streptomyces hygroscopicus; WO 2003013224, WO | | |
| | | | 2007/017186 | | |
| A- | LLCotton25 × | Bayer CropScience (Aventis | Stacked herbicide tolerant and insect resistant cotton | Gossypium hirsutum | |
| 81 | MON15985 | CropScience(AgrEvo)) | combining tolerance to glufosinate ammonium herbicide | L. (Cotton) | |
| | | | from LLCotton25 (OECD identifier: ACS-GHØØ1-3) | | |
| | | | with resistance to insects from MON15985 (OECD | | |
| | | | identifier: MON-15985-7) | | |
| A- | MON 15985 | | Insect resistance (Cry1A/Cry2Ab) | Gossypium hirsutum | US 2004-250317 |
| 82 | | | | L. (Cotton) | |
| A- | MON1445/1698 | Monsanto Company | Glyphosate herbicide tolerant cotton produced by inserting | Gossypium hirsutum | |
| 83 | | | a naturally glyphosate tolerant form of the enzyme 5- | L. (Cotton) | |
| | | | enolpyruvyl shikimate-3-phosphate synthase (EPSPS) | | |
| | | | from A. tumefaciens strain CP4. | | |
| A- | MON15985 × | Monsanto Company | Stacked insect resistant and glyphosate tolerant cotton | Gossypium hirsutum | |
| 84 | MON88913 | | produced by conventional cross-breeding of the parental | L. (Cotton) | |
| | | | lines MON88913 (OECD identifier: MON-88913-8) and | | |
| | | | 15985 (OECD identifier: MON-15985-7). Glyphosate | | |
| | | | tolerance is derived from MON88913 which contains two | | |
| | | | genes encoding the enzyme 5-enolypyruvylshikimate-3- | | |
| | | | phosphate synthase (EPSPS) from the CP4 strain of | | |
| | | | Agrobacterium tumefaciens. Insect resistance is derived | | |
| | | | MON15985 which was produced by transformation of the | | |
| | | | DP50B parent variety, which contained event 531 | | |
| | | | (expressing Cry1Ac protein), with purified plasmid DNA | | |
| | | | containing the cry2Ab gene from B. thuringiensis subsp. | | |
| | | | kurstaki. | | |
| A- | MON-15985-7 × | Monsanto Company | Stacked insect resistant and herbicide tolerant cotton | Gossypium hirsutum | |
| 85 | MON-Ø1445-2 | | derived from conventional cross-breeding of the parental | L. (Cotton) | |
| | | | lines 15985 (OECD identifier: MON-15985-7) and | | |
| | | | MON1445 (OECD identifier: MON-Ø1445-2). | | |
| A- | MON531/757/1076 | Monsanto Company | Insect-resistant cotton produced by inserting the cry1Ac | Gossypium hirsutum | |
| 86 | | | gene from Bacillus thuringiensis subsp. kurstaki HD-73 | L. (Cotton) | |
| | | | (B.t.k.). | | |
| A- | LLcotton25 | | Glufosinate resistance | Gossypium hirsutum | WO 2003013224 |
| 87 | | | | L. (Cotton) | |
| A- | MON88913 | Monsanto Company | Glyphosate herbicide tolerant cotton produced by inserting | Gossypium hirsutum | WO 2004/072235 |
| 88 | | | two genes encoding the enzyme 5-enolypyruvylshikimate- | L. (Cotton) | |
| | | | 3-phosphate synthase (EPSPS) from the CP4 strain of | | |
| | | | Agrobacterium tumefaciens,; WO 2004/072235 | | |
| A- | MON-ØØ531-6 × | Monsanto Company | Stacked insect resistant and herbicide tolerant cotton | Gossypium hirsutum | |
| 89 | MON-Ø1445-2 | | derived from conventional cross-breeding of the parental | L. (Cotton) | |
| | | | lines MON531 (OECD identifier: MON-ØØ531-6) and | | |
| | | | MON1445 (OECD identifier: MON-Ø1445-2). | | |
| A- | PV-GHGT07 | | Glyphosate tolerance | Gossypium hirsutum | US 2004-148666 |
| 90 | (1445) | | | L. (Cotton) | |
| A- | T304-40 | | Insect-resistance (Cry1Ab) | Gossypium hirsutum | WO2008/122406, |
| 91 | | | | L. (Cotton) | US2010077501 |
| A- | T342-142 | | Insect resistance (Cry1Ab) | Gossypium hirsutum | WO 2006/128568 |
| 92 | | | | L. (Cotton) | |
| A- | X81359 | BASF Inc. | Tolerance to imidazolinone herbicides by selection of a | Helianthus | |
| 93 | | | naturally occurring mutant. | annuus (Sunflower) | |
| A- | RH44 | BASF Inc. | Selection for a mutagenized version of the enzyme | Lens culinaris (Lentil) | |
| 94 | | | acetohydroxyacid synthase (AHAS), also known as | | |
| | | | acetolactate synthase (ALS) or acetolactate pyruvate- | | |
| | | | lyase. | | |
| A- | FP967 | University of Saskatchewan, | A variant form of acetolactate synthase (ALS) was | Linum usitatissimum | |
| 95 | | Crop Dev. Centre | obtained from a chlorsulfuron tolerant line of A. thaliana | L. (Flax, Linseed) | |
| | | | and used to transform flax. | | |
| A- | 5345 | Monsanto Company | Resistance to lepidopteran pests through the introduction | Lycopersicon | |
| 96 | | | of the cry1Ac gene from Bacillus thuringiensis subsp. | esculentum (Tomato) | |
| | | | Kurstaki. | | |
| A- | 8338 | Monsanto Company | Introduction of a gene sequence encoding the enzyme 1- | Lycopersicon | |
| 97 | | | amino-cyclopropane-1-carboxylic acid deaminase (ACCd) | esculentum (Tomato) | |
| | | | that metabolizes the precursor of the fruit ripening | | |
| | | | hormone ethylene. | | |
| A- | 1345-4 | DNA Plant Technology | Delayed ripening tomatoes produced by inserting an | Lycopersicon | |
| 98 | | Corporation | additional copy of a truncated gene encoding 1- | esculentum (Tomato) | |
| | | | aminocyclopropane-1-carboxyllic acid (ACC) synthase, | | |
| | | | which resulted in downregulation of the endogenous ACC | | |
| | | | synthase and reduced ethylene accumulation. | | |
| A- | 35 1 N | Agritope Inc. | Introduction of a gene sequence encoding the enzyme S- | Lycopersicon | |
| 99 | | | adenosylmethionine hydrolase that metabolizes the | esculentum (Tomato) | |
| | | | precursor of the fruit ripening hormone ethylene | | |
| A- | B, Da, F | Zeneca Seeds | Delayed softening tomatoes produced by inserting a | Lycopersicon | |
| 100 | | | truncated version of the polygalacturonase (PG) encoding | esculentum (Tomato) | |
| | | | gene in the sense or anti-sense orientation in order to | | |
| | | | reduce expression of the endogenous PG gene, and thus | | |
| | | | reduce pectin degradation. | | |
| A- | FLAVR SAVR | Calgene Inc. | Delayed softening tomatoes produced by inserting an | Lycopersicon | |
| 101 | | | additional copy of the polygalacturonase (PG) encoding | esculentum (Tomato) | |
| | | | gene in the anti-sense orientation in order to reduce | | |
| | | | expression of the endogenous PG gene and thus reduce | | |
| | | | pectin degradation. | | |
| A- | J101, J163 | Monsanto Company and | Glyphosate herbicide tolerant alfalfa (lucerne) produced | Medicago sativa (Alfalfa) | |
| 102 | | Forage Genetics | by inserting a gene encoding the enzyme 5- | | |
| | | International | enolypyruvylshikimate-3-phosphate synthase (EPSPS) | | |
| | | | from the CP4 strain of Agrobacterium tumefaciens. | | |
| A- | C/F/93/08-02 | Societe National | Tolerance to the herbicides bromoxynil and ioxynil by | Nicotiana tabacum | |
| 103 | | d'Exploitation des Tabacs et | incorporation of the nitrilase gene from Klebsiella | L. (Tobacco) | |
| | | Allumettes | pneumoniae. | | |
| A- | Vector 21-41 | Vector Tobacco Inc. | Reduced nicotine content through introduction of a second | Nicotiana tabacum | |
| 104 | | | copy of the tobacco quinolinic acid | L. (Tobacco) | |
| | | | phosphoribosyltransferase (QTPase) in the antisense | | |
| | | | orientation. The NPTII encoding gene from E. coli was | | |
| | | | introduced as a selectable marker to identify | | |
| | | | transformants. | | |
| A- | CL121, CL141, | BASF Inc. | Tolerance to the imidazolinone herbicide, imazethapyr, | Oryza sativa (Rice) | |
| 105 | CFX51 | | induced by chemical mutagenesis of the acetolactate | | |
| | | | synthase (ALS) enzyme using ethyl methanesulfonate | | |
| | | | (EMS). | | |
| A- | GAT-OS2 | | Glufosinate tolerance | Oryza sativa (Rice) | WO 01/83818 |
| 106 | | | | | |
| A- | GAT-OS3 | | Glufosinate tolerance | Oryza sativa (Rice) | US 2008-289060 |
| 107 | | | | | |
| A- | IMINTA-1, | BASF Inc. | Tolerance to imidazolinone herbicides induced by | Oryza sativa (Rice) | |
| 108 | IMINTA-4 | | chemical mutagenesis of the acetolactate synthase (ALS) | | |
| | | | enzyme using sodium azide. | | |
| A- | LLRICE06, | Aventis CropScience | Glufosinate ammonium herbicide tolerant rice produced | Oryza sativa (Rice) | |
| 109 | LLRICE62 | | by inserting a modified phosphinothricin acetyltransferase | | |
| | | | (PAT) encoding gene from the soil bacterium | | |
| | | | Streptomyces hygroscopicus). | | |
| A- | LLRICE601 | Bayer Crop Science (Aventis | Glufosinate ammonium herbicide tolerant rice produced | Oryza sativa (Rice) | |
| 110 | | CropScience(AgrEvo)) | by inserting a modified phosphinothricin acetyltransferase | | |
| | | | (PAT) encoding gene from the soil bacterium | | |
| | | | Streptomyces hygroscopicus). | | |
| A- | PE-7 | | Insect resistance (Cry1Ac) | Oryza sativa (Rice) | WO 2008/114282 |
| 111 | | | | | |
| A- | PWC16 | BASF Inc. | Tolerance to the imidazolinone herbicide, imazethapyr, | Oryza sativa (Rice) | |
| 112 | | | induced by chemical mutagenesis of the acetolactate | | |
| | | | synthase (ALS) enzyme using ethyl methanesulfonate | | |
| | | | (EMS). | | |
| A- | TT51 | | Insect resistance (Cry1Ab/Cry1Ac) | Oryza sativa (Rice) | CN1840655 |
| 113 | | | | | |
| A- | C5 | United States Department of | Plum pox virus (PPV) resistant plum tree produced | Prunus domestica (Plum) | |
| 114 | | Agriculture - Agricultural | through Agrobacterium-mediated transformation with a | | |
| | | Research Service | coat protein (CP) gene from the virus. | | |
| A- | ATBT04-6, | Monsanto Company | Colorado potato beetle resistant potatoes produced by | Solanum tuberosum | |
| 115 | ATBT04-27, | | inserting the cry3A gene from Bacillus thuringiensis | L. (Potato) | |
| | ATBT04-30, | | (subsp. Tenebrionis). | | |
| | ATBT04-31, | | | | |
| | ATBT04-36, | | | | |
| | SPBT02-5, | | | | |
| | SPBT02-7 | | | | |
| A- | BT6, BT10, BT12, | Monsanto Company | Colorado potato beetle resistant potatoes produced by | Solanum tuberosum | |
| 116 | BT16, BT17, | | inserting the cry3A gene from Bacillus thuringiensis | L. (Potato) | |
| | BT18, BT23 | | (subsp. Tenebrionis). | | |
| A- | RBMT15-101, | Monsanto Company | Colorado potato beetle and potato virus Y (PVY) resistant | Solanum tuberosum | |
| 117 | SEMT15-02, | | potatoes produced by inserting the cry3A gene from | L. (Potato) | |
| | SEMT15-15 | | Bacillus thuringiensis (subsp. Tenebrionis) and the coat | | |
| | | | protein encoding gene from PVY. | | |
| A- | RBMT21-129, | Monsanto Company | Colorado potato beetle and potato leafroll virus (PLRV) | Solanum tuberosum | |
| 118 | RBMT21-350, | | resistant potatoes produced by inserting the cry3A gene | L. (Potato) | |
| | RBMT22-082 | | from Bacillus thuringiensis (subsp. Tenebrionis) and the | | |
| | | | replicase encoding gene from PLRV. | | |
| A- | EH92-527 | BASF Plant Science | Crop composition; Amflora; Unique EU identifier: BPS- | Solanum tuberosum | |
| 119 | | | 25271-9 | L. (Potato) | |
| A- | AP205CL | BASF Inc. | Selection for a mutagenized version of the enzyme | Triticum aestivum (Wheat) | |
| 120 | | | acetohydroxyacid synthase (AHAS), also known as | | |
| | | | acetolactate synthase (ALS) or acetolactate pyruvate- | | |
| | | | lyase. | | |
| A- | AP602CL | BASF Inc. | Selection for a mutagenized version of the enzyme | Triticum aestivum (Wheat) | |
| 121 | | | acetohydroxyacid synthase (AHAS), also known as | | |
| | | | acetolactate synthase (ALS) or acetolactate pyruvate- | | |
| | | | lyase. | | |
| A- | BW255-2, | BASF Inc. | Selection for a mutagenized version of the enzyme | Triticum aestivum (Wheat) | |
| 122 | BW238-3 | | acetohydroxyacid synthase (AHAS), also known as | | |
| | | | acetolactate synthase (ALS) or acetolactate pyruvate- | | |
| | | | lyase. | | |
| A- | BW7 | BASF Inc. | Tolerance to imidazolinone herbicides induced by | Triticum aestivum (Wheat) | |
| 123 | | | chemical mutagenesis of the acetohydroxyacid synthase | | |
| | | | (AHAS) gene using sodium azide. | | |
| A- | Event 1 | | Fusarium resistance (trichothecene 3-O-acetyltransferase); | Triticum aestivum (Wheat) | |
| 124 | | | CA 2561992 | | |
| A- | JOPLIN1 | | disease (fungal) resistance (trichothecene 3-O- | Triticum aestivum (Wheat) | |
| 125 | | | acetyltransferase); US 2008064032 | | |
| A- | MON71800 | Monsanto Company | Glyphosate tolerant wheat variety produced by inserting a | Triticum aestivum (Wheat) | |
| 126 | | | modified 5-enolpyruvylshikimate-3-phosphate synthase | | |
| | | | (EPSPS) encoding gene from the soil bacterium | | |
| | | | Agrobacterium tumefaciens, strain CP4. | | |
| A- | SWP965001 | Cyanamid Crop Protection | Selection for a mutagenized version of the enzyme | Triticum aestivum (Wheat) | |
| 127 | | | acetohydroxyacid synthase (AHAS), also known as | | |
| | | | acetolactate synthase (ALS) or acetolactate pyruvate- | | |
| | | | lyase. | | |
| A- | Teal 11A | BASF Inc. | Selection for a mutagenized version of the enzyme | Triticum aestivum (Wheat) | |
| 128 | | | acetohydroxyacid synthase (AHAS), also known as | | |
| | | | acetolactate synthase (ALS) or acetolactate pyruvate- | | |
| | | | lyase. | | |
| A- | 176 | Syngenta Seeds, Inc. | Insect-resistant maize produced by inserting the cry1Ab | Zea mays L. (Maize) | |
| 129 | | | gene from Bacillus thuringiensis subsp. kurstaki. The | | |
| | | | genetic modification affords resistance to attack by the | | |
| | | | European corn borer (ECB). | | |
| A- | 3272 | | Self processing corn (alpha-amylase) | Zea mays L. (Maize) | US 2006-230473, |
| 130 | | | | | US2010063265 |
| A- | 3751IR | Pioneer Hi-Bred | Selection of somaclonal variants by culture of embryos on | Zea mays L. (Maize) | |
| 131 | | International Inc. | imidazolinone containing media. | | |
| A- | 676, 678, 680 | Pioneer Hi-Bred | Male-sterile and glufosinate ammonium herbicide tolerant | Zea mays L. (Maize) | |
| 132 | | International Inc. | maize produced by inserting genes encoding DNA adenine | | |
| | | | methylase and phosphinothricin acetyltransferase (PAT) | | |
| | | | from Escherichia coli and Streptomyces | | |
| | | | viridochromogenes, respectively. | | |
| A- | ACS-ZMØØ3-2 × | Bayer CropScience (Aventis | Stacked insect resistant and herbicide tolerant corn hybrid | Zea mays L. (Maize) | |
| 133 | MON-ØØ81Ø-6 | CropScience(AgrEvo)) | derived from conventional cross-breeding of the parental | | |
| | | | lines T25 (OECD identifier: ACS-ZMØØ3-2) and | | |
| | | | MON810 (OECD identifier: MON-ØØ81Ø-6). | | |
| A | B16 | | Glufosinate resistance | Zea mays L. (Maize) | US 2003-126634 |
| 134 | | | | | |
| A- | B16 (DLL25) | Dekalb Genetics Corporation | Glufosinate ammonium herbicide tolerant maize produced | Zea mays L. (Maize) | |
| 135 | | | by inserting the gene encoding phosphinothricin | | |
| | | | acetyltransferase (PAT) from Streptomyces | | |
| | | | hygroscopicus. | | |
| A- | BT11 (X4334CBR, | Syngenta Seeds, Inc. | Insect-resistant and herbicide tolerant maize produced by | Zea mays L. (Maize) | WO 2010148268 |
| 136 | X4734CBR) | | inserting the cry1Ab gene from Bacillus thuringiensis | | |
| | | | subsp. kurstaki, and the phosphinothricin N- | | |
| | | | acetyltransferase (PAT) encoding gene from S. viridochromogenes. | | |
| A- | BT11 × GA21 | Syngenta Seeds, Inc. | Stacked insect resistant and herbicide tolerant maize | Zea mays L. (Maize) | |
| 137 | | | produced by conventional cross breeding of parental lines | | |
| | | | BT11 (OECD unique identifier: SYN-BTØ11-1) and | | |
| | | | GA21 (OECD unique identifier: MON-ØØØ21-9). | | |
| A | BT11 × MIR162 | Syngenta Seeds, Inc. | Stacked insect resistant and herbicide tolerant maize | Zea mays L. (Maize) | |
| 138 | | | produced by conventional cross breeding of parental lines | | |
| | | | BT11 (OECD unique identifier: SYN-BTØ11-1) and | | |
| | | | MIR162 (OECD unique identifier: SYN-IR162-4). | | |
| | | | Resistance to the European Corn Borer and tolerance to | | |
| | | | the herbicide glufosinate ammonium (Liberty) is derived | | |
| | | | from BT11, which contains the cry1Ab gene from Bacillus | | |
| | | | thuringiensis subsp. kurstaki, and the phosphinothricin N- | | |
| | | | acetyltransferase (PAT) encoding gene from S. viridochromogenes. | | |
| | | | Resistance to other lepidopteran pests, | | |
| | | | including H. zea, S. frugiperda, A. ipsilon, and S. albicosta, | | |
| | | | is derived from MIR162, which contains the | | |
| | | | vip3Aa gene from Bacillus thuringiensis strain AB88. | | |
| A- | BT11 × MIR162 × | Syngenta Seeds, Inc. | Bacillus thuringiensis Cry1Ab delta-endotoxin protein and | Zea mays L. (Maize) | |
| 139 | MIR604 | | the genetic material necessary for its production (via | | |
| | | | elements of vector pZO1502) in Event Bt11 corn (OECD | | |
| | | | Unique Identifier: SYN-BTØ11-1) × Bacillus | | |
| | | | thuringiensis Vip3Aa20 insecticidal protein and the | | |
| | | | genetic material necessary for its production (via elements | | |
| | | | of vector pNOV1300) in Event MIR162 maize (OECD | | |
| | | | Unique Identifier: SYN-IR162-4) × modified Cry3A | | |
| | | | protein and the genetic material necessary for its | | |
| | | | production (via elements of vector pZM26) in Event | | |
| | | | MIR604 corn (OECD Unique Identifier: SYN-IR6Ø4-5). | | |
| A- | BT11 × MIR604 | Syngenta Seeds, Inc. | Stacked insect resistant and herbicide tolerant maize | Zea mays L. (Maize) | |
| 140 | | | produced by conventional cross breeding of parental lines | | |
| | | | BT11 (OECD unique identifier: SYN-BTØ11-1) and | | |
| | | | MIR604 (OECD unique identifier: SYN-IR6Ø5-5). | | |
| | | | Resistance to the European Corn Borer and tolerance to | | |
| | | | the herbicide glufosinate ammonium (Liberty) is derived | | |
| | | | from BT11, which contains the cry1Ab gene from Bacillus | | |
| | | | thuringiensis subsp. kurstaki, and the phosphinothricin N- | | |
| | | | acetyltransferase (PAT) encoding gene from S. viridochromogenes. | | |
| | | | Corn rootworm-resistance is derived | | |
| | | | from MIR604 which contains the mcry3A gene from | | |
| | | | Bacillus thuringiensis. | | |
| A- | BT11 × MIR604 × | Syngenta Seeds, Inc. | Stacked insect resistant and herbicide tolerant maize | Zea mays L. (Maize) | |
| 141 | GA21 | | produced by conventional cross breeding of parental lines | | |
| | | | BT11 (OECD unique identifier: SYN-BTØ11-1), MIR604 | | |
| | | | (OECD unique identifier: SYN-IR6Ø5-5) and GA21 | | |
| | | | (OECD unique identifier: MON-ØØØ21-9). Resistance to | | |
| | | | the European Corn Borer and tolerance to the herbicide | | |
| | | | glufosinate ammonium (Liberty) is derived from BT11, | | |
| | | | which contains the cry1Ab gene from Bacillus | | |
| | | | thuringiensis subsp. kurstaki, and the phosphinothricin N- | | |
| | | | acetyltransferase (PAT) encoding gene from S. viridochromogenes. | | |
| | | | Corn rootworm-resistance is derived | | |
| | | | from MIR604 which contains the mcry3A gene from | | |
| | | | Bacillus thuringiensis. Tolerance to glyphosate herbcicide | | |
| | | | is derived from GA21 which contains a a modified EPSPS | | |
| | | | gene from maize. | | |
| A- | CBH-351 | Aventis CropScience | Insect-resistant and glufosinate ammonium herbicide | Zea mays L. (Maize) | |
| 142 | | | tolerant maize developed by inserting genes encoding | | |
| | | | Cry9C protein from Bacillus thuringiensis subsp tolworthi | | |
| | | | and phosphinothricin acetyltransferase (PAT) from | | |
| | | | Streptomyces hygroscopicus. | | |
| A- | DAS-06275-8 | DOW AgroSciences LLC | Lepidopteran insect resistant and glufosinate ammonium | Zea mays L. (Maize) | |
| 143 | | | herbicide-tolerant maize variety produced by inserting the | | |
| | | | cry1F gene from Bacillus thuringiensis var aizawai and the | | |
| | | | phosphinothricin acetyltransferase (PAT) from | | |
| | | | Streptomyces hygroscopicus. | | |
| A- | DAS-59122-7 | DOW AgroSciences LLC | Corn rootworm-resistant maize produced by inserting the | Zea mays L. (Maize) | US 2006-070139, |
| 144 | | and Pioneer Hi-Bred | cry34Ab1 and cry35Ab1 genes from Bacillus thuringiensis | | US 2011030086 |
| | | International Inc. | strain PS149B1. The PAT encoding gene from | | |
| | | | Streptomyces viridochromogenes was introduced as a | | |
| | | | selectable marker; US 2006-070139 | | |
| A- | DAS-59122-7 × | DOW AgroSciences LLC | Stacked insect resistant and herbicide tolerant maize | Zea mays L. (Maize) | |
| 145 | NK603 | and Pioneer Hi-Bred | produced by conventional cross breeding of parental lines | | |
| | | International Inc. | DAS-59122-7 (OECD unique identifier: DAS-59122-7) | | |
| | | | with NK603 (OECD unique identifier: MON-ØØ6Ø3-6). | | |
| | | | Corn rootworm-resistance is derived from DAS-59122-7 | | |
| | | | which contains the cry34Ab1 and cry35Ab1 genes from | | |
| | | | Bacillus thuringiensis strain PS149B1. Tolerance to | | |
| | | | glyphosate herbcicide is derived from NK603. | | |
| A- | DAS-59122-7 × | DOW AgroSciences LLC | Stacked insect resistant and herbicide tolerant maize | Zea mays L. (Maize) | |
| 146 | TC1507 × NK603 | and Pioneer Hi-Bred | produced by conventional cross breeding of parental lines | | |
| | | International Inc. | DAS-59122-7 (OECD unique identifier: DAS-59122-7) | | |
| | | | and TC1507 (OECD unique identifier: DAS-Ø15Ø7-1) | | |
| | | | with NK603 (OECD unique identifier: MON-ØØ6Ø3-6). | | |
| | | | Corn rootworm-resistance is derived from DAS-59122-7 | | |
| | | | which contains the cry34Ab1 and cry35Ab1 genes from | | |
| | | | Bacillus thuringiensis strain PS149B1. Lepidopteran | | |
| | | | resistance and toleraance to glufosinate ammonium | | |
| | | | herbicide is derived from TC1507. Tolerance to | | |
| | | | glyphosate herbcicide is derived from NK603. | | |
| A- | DAS-Ø15Ø7-1 × | DOW AgroSciences LLC | Stacked insect resistant and herbicide tolerant corn hybrid | Zea mays L. (Maize) | |
| 147 | MON-ØØ6Ø3-6 | | derived from conventional cross-breeding of the parental | | |
| | | | lines 1507 (OECD identifier: DAS-Ø15Ø7-1) and NK603 | | |
| | | | (OECD identifier: MON-ØØ6Ø3-6). | | |
| A- | DBT418 | Dekalb Genetics Corporation | Insect-resistant and glufosinate ammonium herbicide | Zea mays L. (Maize) | |
| 148 | | | tolerant maize developed by inserting genes encoding | | |
| | | | Cry1AC protein from Bacillus thuringiensis subsp kurstaki | | |
| | | | and phosphinothricin acetyltransferase (PAT) from | | |
| | | | Streptomyces hygroscopicus | | |
| A- | DK404SR | BASF Inc. | Somaclonal variants with a modified acetyl-CoA- | Zea mays L. (Maize) | |
| 149 | | | carboxylase (ACCase) were selected by culture of | | |
| | | | embryos on sethoxydim enriched medium. | | |
| A- | DP-098140-6 | | Glyphosate tolerance/ALS inhibitor tolerance | Zea mays L. (Maize) | WO |
| 150 | | | | | 2008/112019, |
| | | | | | US2010240059 |
| A- | DP-Ø9814Ø-6 | Pioneer Hi-Bred | Corn line 98140 was genetically engineered to express the | Zea mays L. (Maize) | |
| 151 | (Event 98140) | International Inc. | GAT4621 (glyphosate acetyltransferase) and ZM-HRA | | |
| | | | (modified version of a maize acetolactate synthase) | | |
| | | | proteins. The GAT4621 protein, encoded by the gat4621 | | |
| | | | gene, confers tolerance to glyphosate-containing | | |
| | | | herbicides by acetylating glyphosate and thereby rendering | | |
| | | | it non-phytotoxic. The ZM-HRA protein, encoded by the | | |
| | | | zm-hra gene, confers tolerance to the ALS-inhibiting class | | |
| | | | of herbicides. | | |
| A- | Event 3272 | Syngenta Seeds, Inc. | Maize line expressing a heat stable alpha-amylase gene | Zea mays L. (Maize) | |
| 152 | | | amy797E for use in the dry-grind ethanol process. The | | |
| | | | phosphomannose isomerase gene from E. coli was used as | | |
| | | | a selectable marker. | | |
| A- | Event 98140 | Pioneer Hi-Bred | Maize event expressing tolerance to glyphosate herbicide, | Zea mays L. (Maize) | |
| 153 | | International Inc. | via expression of a modified bacterial glyphosate N- | | |
| | | | acetlytransferase, and ALS-inhibiting herbicides, vial | | |
| | | | expression of a modified form of the maize acetolactate | | |
| | | | synthase enzyme. | | |
| A- | EXP1910IT | Syngenta Seeds, Inc. | Tolerance to the imidazolinone herbicide, imazethapyr, | Zea mays L. (Maize) | |
| 154 | | (formerly Zeneca Seeds) | induced by chemical mutagenesis of the acetolactate | | |
| | | | synthase (ALS) enzyme using ethyl methanesulfonate | | |
| | | | (EMS). | | |
| A- | FI117 | | Glyphosate resistance | Zea mays L. (Maize) | U.S. Pat. No. 6,040,497 |
| 155 | | | | | |
| A- | GA21 | Monsanto Company | Glyphosate resistance: Introduction, by particle | Zea mays L. (Maize) | U.S. Pat. No. 6,040,497 |
| 156 | | | bombardment, of a modified 5-enolpyruvyl shikimate-3- | | |
| | | | phosphate synthase (EPSPS), an enzyme involved in the | | |
| | | | shikimate biochemical pathway for the production of the | | |
| | | | aromatic amino acids; | | |
| A- | GA21 × MON810 | Monsanto Company | Stacked insect resistant and herbicide tolerant corn hybrid | Zea mays L. (Maize) | |
| 157 | | | derived from conventional cross breeding of the parental | | |
| | | | lines GA21 (OECD identifider: MON-ØØØ21-9) and | | |
| | | | MON810 (OECD identifier: MON-ØØ81Ø-6). | | |
| A- | GAT-ZM1 | | Glufosinate tolerance | Zea mays L. (Maize) | WO 01/51654 |
| 158 | | | | | |
| A- | GG25 | | Glyphosate resistance | Zea mays L. (Maize) | U.S. Pat. No. 6,040,497 |
| 159 | | | | | |
| A- | GJ11 | | Glyphosate resistance; U.S. Pat. No. 6,040,497 | Zea mays L. (Maize) | |
| 160 | | | | | |
| A- | IT | Pioneer Hi-Bred | Tolerance to the imidazolinone herbicide, imazethapyr, | Zea mays L. (Maize) | |
| 161 | | International Inc. | was obtained by in vitro selection of somaclonal variants. | | |
| A- | LY038 | Monsanto Company | Altered amino acid composition, specifically elevated | Zea mays L. (Maize) | U.S. Pat. No. 7,157,281, |
| 162 | | | levels of lysine, through the introduction of the cordapA | | US2010212051; |
| | | | gene, derived from Corynebacterium glutamicum, | | US 2007028322 |
| | | | encoding the enzyme dihydrodipicolinate synthase | | |
| | | | (cDHDPS); | | |
| A- | MIR162 | | Insect resistance | Zea mays L. (Maize) | WO 2007142840 |
| 163 | | | | | |
| A- | MIR604 | Syngenta Seeds, Inc. | Corn rootworm resistant maize produced by | Zea mays L. (Maize) | EP 1 737 290 |
| 164 | | | transformation with a modified cry3A gene. The | | |
| | | | phosphomannose isomerase gene from E. coli was used as | | |
| | | | a selectable marker; (Cry3a055) | | |
| A- | MIR604 × GA21 | Syngenta Seeds, Inc. | Stacked insect resistant and herbicide tolerant maize | Zea mays L. (Maize) | |
| 165 | | | produced by conventional cross breeding of parental lines | | |
| | | | MIR604 (OECD unique identifier: SYN-IR6Ø5-5) and | | |
| | | | GA21 (OECD unique identifier: MON-ØØØ21-9). Corn | | |
| | | | rootworm-resistance is derived from MIR604 which | | |
| | | | contains the mcry3A gene from Bacillus thuringiensis. | | |
| | | | Tolerance to glyphosate herbcicide is derived from GA21. | | |
| A- | MON80100 | Monsanto Company | Insect-resistant maize produced by inserting the cry1Ab | Zea mays L. (Maize) | |
| 166 | | | gene from Bacillus thuringiensis subsp. kurstaki. The | | |
| | | | genetic modification affords resistance to attack by the | | |
| | | | European corn borer (ECB). | | |
| A- | MON802 | Monsanto Company | Insect-resistant and glyphosate herbicide tolerant maize | Zea mays L. (Maize) | |
| 167 | | | produced by inserting the genes encoding the Cry1Ab | | |
| | | | protein from Bacillus thuringiensis and the 5- | | |
| | | | enolpyruvylshikimate-3-phosphate synthase (EPSPS) from | | |
| | | | A. tumefaciens strain CP4. | | |
| A- | MON809 | Pioneer Hi-Bred | Resistance to European corn borer (Ostrinia nubilalis) by | Zea mays L. (Maize) | |
| 168 | | International Inc. | introduction of a synthetic cry1Ab gene. Glyphosate | | |
| | | | resistance via introduction of the bacterial version of a | | |
| | | | plant enzyme, 5-enolpyruvyl shikimate-3-phosphate | | |
| | | | synthase (EPSPS). | | |
| A- | MON810 | Monsanto Company | Insect-resistant maize produced by inserting a truncated | Zea mays L. (Maize) | US 2004-180373 |
| 169 | | | form of the cry1Ab gene from Bacillus thuringiensis | | |
| | | | subsp. kurstaki HD-1. The genetic modification affords | | |
| | | | resistance to attack by the European corn borer (ECB); | | |
| A- | MON810 × | Monsanto Company | Stacked insect resistant and glyphosate tolerant maize | Zea mays L. (Maize) | |
| 170 | MON88017 | | derived from conventional cross-breeding of the parental | | |
| | | | lines MON810 (OECD identifier: MON-ØØ81Ø-6) and | | |
| | | | MON88017 (OECD identifier: MON-88Ø17-3). European | | |
| | | | corn borer (ECB) resistance is derived from a truncated | | |
| | | | form of the cry1Ab gene from Bacillus thuringiensis | | |
| | | | subsp. kurstaki HD-1 present in MON810. Corn rootworm | | |
| | | | resistance is derived from the cry3Bb1 gene from Bacillus | | |
| | | | thuringiensis subspecies kumamotoensis strain EG4691 | | |
| | | | present in MON88017. Glyphosate tolerance is derived | | |
| | | | from a 5-enolpyruvylshikimate-3-phosphate synthase | | |
| | | | (EPSPS) encoding gene from Agrobacterium tumefaciens | | |
| | | | strain CP4 present in MON88017. | | |
| A- | MON832 | Monsanto Company | Introduction, by particle bombardment, of glyphosate | Zea mays L. (Maize) | |
| 171 | | | oxidase (GOX) and a modified 5-enolpyruvyl shikimate-3- | | |
| | | | phosphate synthase (EPSPS), an enzyme involved in the | | |
| | | | shikimate biochemical pathway for the production of the | | |
| | | | aromatic amino acids. | | |
| A- | MON863 | Monsanto Company | Corn root worm resistant maize produced by inserting the | Zea mays L. (Maize) | |
| 172 | | | cry3Bb1 gene from Bacillus thuringiensis subsp. | | |
| | | | kumamotoensis. | | |
| A- | MON863 × | Monsanto Company | Stacked insect resistant corn hybrid derived from | Zea mays L. (Maize) | |
| 173 | MON810 | | conventional cross-breeding of the parental lines MON863 | | |
| | | | (OECD identifier: MON-ØØ863-5) and MON810 (OECD | | |
| | | | identifier: MON-ØØ81Ø-6) | | |
| A- | MON863 × | Monsanto Company | Stacked insect resistant and herbicide tolerant corn hybrid | Zea mays L. (Maize) | |
| 174 | MON810 × NK603 | | derived from conventional cross-breeding of the stacked | | |
| | | | hybrid MON-ØØ863-5 × MON-ØØ81Ø-6 and NK603 | | |
| | | | (OECD identifier: MON-ØØ6Ø3-6). | | |
| A- | MON863 × NK603 | Monsanto Company | Stacked insect resistant and herbicide tolerant corn hybrid | Zea mays L. (Maize) | |
| 175 | | | derived from conventional cross breeding of the parental | | |
| | | | lines MON863 (OECD identifier: MON-ØØ863-5) and | | |
| | | | NK603 (OECD identifier: MON-ØØ6Ø3-6). | | |
| A- | MON87460 | | Drought tolerance; Water deficit tolerance; | Zea mays L. (Maize) | WO 2009/111263 |
| 176 | | | | | |
| A- | MON88017 | Monsanto Company | Corn rootworm-resistant maize produced by inserting the | Zea mays L. (Maize) | WO2005059103 |
| 177 | | | cry3Bb1 gene from Bacillus thuringiensis subspecies | | |
| | | | kumamotoensis strain EG4691. Glyphosate tolerance | | |
| | | | derived by inserting a 5-enolpyruvylshikimate-3- | | |
| | | | phosphate synthase (EPSPS) encoding gene from | | |
| | | | Agrobacterium tumefaciens strain CP4 (Glyphosate | | |
| | | | tolerance); | | |
| A- | MON89034 | Monsanto Company | Maize event expressing two different insecticidal proteins | Zea mays L. (Maize) | WO 2007140256 |
| 178 | | | from Bacillus thuringiensis providing resistance to number | | |
| | | | of lepidopteran pests; nsect resistance (Lepidoptera - | | |
| | | | Cry1A.105-Cry2Ab); | | |
| A- | MON89034 × | Monsanto Company | Stacked insect resistant and glyphosate tolerant maize | Zea mays L. (Maize) | |
| 179 | MON88017 | | derived from conventional cross-breeding of the parental | | |
| | | | lines MON89034 (OECD identifier: MON-89Ø34-3) and | | |
| | | | MON88017 (OECD identifier: MON-88Ø17-3). | | |
| | | | Resistance to Lepiopteran insects is derived from two | | |
| | | | crygenes present in MON89043. Corn rootworm | | |
| | | | resistance is derived from a single cry genes and | | |
| | | | glyphosate tolerance is derived from the 5- | | |
| | | | enolpyruvylshikimate-3-phosphate synthase (EPSPS) | | |
| | | | encoding gene from Agrobacterium tumefaciens present in | | |
| | | | MON88017. | | |
| A- | MON89034 × | Monsanto Company | Stacked insect resistant and herbicide tolerant maize | Zea mays L. (Maize) | |
| 180 | NK603 | | produced by conventional cross breeding of parental lines | | |
| | | | MON89034 (OECD identifier: MON-89034-3) with | | |
| | | | NK603 (OECD unique identifier: MON-ØØ6Ø3-6). | | |
| | | | Resistance to Lepiopteran insects is derived from two | | |
| | | | crygenes present in MON89043. Tolerance to glyphosate | | |
| | | | herbcicide is derived from NK603. | | |
| A- | MON89034 × | Monsanto Company | Stacked insect resistant and herbicide tolerant maize | Zea mays L. (Maize) | |
| 181 | TC1507 × | | produced by conventional cross breeding of parental lines: | | |
| | MON88017 × | | MON89034, TC1507, MON88017, and DAS-59122. | | |
| | DAS-59122-7 | | Resistance to the above-ground and below-ground insect | | |
| | | | pests and tolerance to glyphosate and glufosinate- | | |
| | | | ammonium containing herbicides. | | |
| A- | MON-ØØ6Ø3-6 × | Monsanto Company | Stacked insect resistant and herbicide tolerant corn hybrid | Zea mays L. (Maize) | |
| 182 | MON-ØØ81Ø-6 | | derived from conventional cross-breeding of the parental | | |
| | | | lines NK603 (OECD identifier: MON-ØØ6Ø3-6) and | | |
| | | | MON810 (OECD identifier: MON-ØØ81Ø-6). | | |
| A- | MON-ØØ81Ø-6 × | Monsanto Company | Stacked insect resistant and enhanced lysine content maize | Zea mays L. (Maize) | |
| 183 | LY038 | | derived from conventional cross-breeding of the parental | | |
| | | | lines MON810 (OECD identifier: MON-ØØ81Ø-6) and | | |
| | | | LY038 (OECD identifier: REN-ØØØ38-3). | | |
| A- | MON-ØØ863-5 × | Monsanto Company | Stacked insect resistant and herbicide tolerant corn hybrid | Zea mays L. (Maize) | |
| 184 | MON-ØØ6Ø3-6 | | derived from conventional cross-breeding of the parental | | |
| | | | lines MON863 (OECD identifier: MON-ØØ863-5) and | | |
| | | | NK603 (OECD identifier: MON-ØØ6Ø3-6). | | |
| A- | MON-ØØ863-5 × | Monsanto Company | Stacked insect resistant corn hybrid derived from | Zea mays L. (Maize) | |
| 185 | MON-ØØ81Ø-6 | | conventional cross-breeding of the parental lines MON863 | | |
| | | | (OECD identifier: MON-ØØ863-5) and MON810 (OECD | | |
| | | | identifier: MON-ØØ81Ø-6) | | |
| A- | MON-ØØ863-5 × | Monsanto Company | Stacked insect resistant and herbicide tolerant corn hybrid | Zea mays L. (Maize) | |
| 186 | MON-ØØ81Ø-6 × | | derived from conventional cross breeding of the stacked | | |
| | MON-ØØ6Ø3-6 | | hybrid MON-ØØ863-5 × MON-ØØ81Ø-6 and NK603 | | |
| | | | (OECD identifier: MON-ØØ6Ø3-6). | | |
| A- | MON-ØØØ21-9 × | Monsanto Company | Stacked insect resistant and herbicide tolerant corn hybrid | Zea mays L. (Maize) | |
| 187 | MON-ØØ81Ø-6 | | derived from conventional cross-breeding of the parental | | |
| | | | lines GA21 (OECD identifider: MON-ØØØ21-9) and | | |
| | | | MON810 (OECD identifier: MON-ØØ81Ø-6). | | |
| A- | MS3 | Bayer CropScience (Aventis | Male sterility caused by expression of the barnase | Zea mays L. (Maize) | |
| 188 | | CropScience(AgrEvo)) | ribonuclease gene from Bacillus amyloliquefaciens; PPT | | |
| | | | resistance was via PPT-acetyltransferase (PAT). | | |
| A- | MS6 | Bayer CropScience (Aventis | Male sterility caused by expression of the barnase | Zea mays L. (Maize) | |
| 189 | | CropScience(AgrEvo)) | ribonuclease gene from Bacillus amyloliquefaciens; PPT | | |
| | | | resistance was via PPT-acetyltransferase (PAT). | | |
| A- | NK603 | Monsanto Company | Introduction, by particle bombardment, of a modified 5- | Zea mays L. (Maize) | |
| 190 | | | enolpyruvyl shikimate-3-phosphate synthase (EPSPS), an | | |
| | | | enzyme involved in the shikimate biochemical pathway for | | |
| | | | the production of the aromatic amino acids. | | |
| A- | NK603 × MON810 | Monsanto Company | Stacked insect resistant and herbicide tolerant corn hybrid | Zea mays L. (Maize) | |
| 191 | | | derived from conventional cross breeding of the parental | | |
| | | | lines NK603 (OECD identifier: MON-ØØ6Ø3-6) and | | |
| | | | MON810 (OECD identifier: MON-ØØ81Ø-6). | | |
| A- | NK603 × T25 | Monsanto Company | Stacked glufosinate ammonium and glyphosate herbicide | Zea mays L. (Maize) | |
| 192 | | | tolerant maize hybrid derived from conventional cross- | | |
| | | | breeding of the parental lines NK603 (OECD identifier: | | |
| | | | MON-ØØ6Ø3-6) and T25 (OECD identifier: ACS- | | |
| | | | ZM003-2). | | |
| A- | PV-ZMGT32 | | Glyphosate tolerance | Zea mays L. (Maize) | US 2007-056056 |
| 193 | (NK603) | | | | |
| A- | E6611.32.1.38/ | Pioneer Hi-Bred | 1) MS45: anther-specific 5126 (Zea mays) promoter > | Zea mays L. (Maize) | WO 2009103049, |
| 194 | DP-32138-1/ | International Inc. | fertility restoration Ms45 (Zea mays) coding sequence > | | MX 2010008977 |
| | 32138 | | fertility restoration Ms45 (Zea mays) 3′-untranslated | | |
| | | | region 2) ZM-AA1: polygalacturonase 47 (Zea mays) | | |
| | | | promoter > brittle-1 (Zea mays) chloroplast transit peptide | | |
| | | | > alpha-amylase-1 (Zea mays) truncated coding sequence | | |
| | | | > >In2-1 (Zea mays) 3′-untranslated region 3) DSRED2: | | |
| | | | 35S (Cauliflower Mosaic Virus) enhancer > lipid transfer | | |
| | | | protein-2 (Hordeum vulgare) promoter > red fluorescent | | |
| | | | protein (Dicosoma sp.) variant coding sequence > protein | | |
| | | | inhibitor II (Solanum tuberosum) 3′-untranslated region | | |
| A- | PV-ZMIR13 | | Insect resistance (Cry3Bb); | Zea mays L. (Maize) | US 2006-095986 |
| 195 | (MON863) | | | | |
| A- | SYN-BTØ11-1 × | Syngenta Seeds, Inc. | Stacked insect resistant and herbicide tolerant maize | Zea mays L. (Maize) | |
| 196 | MON-ØØØ21-9 | | produced by conventional cross breeding of parental lines | | |
| | | | BT11 (OECD unique identifier: SYN-BTØ11-1) and | | |
| | | | GA21 (OECD unique identifier: MON-ØØØ21-9). | | |
| A- | T14 | Bayer CropScience (Aventis | Glufosinate herbicide tolerant maize produced by inserting | Zea mays L. (Maize) | |
| 197 | | CropScience(AgrEvo)) | the phosphinothricin N-acetyltransferase (PAT) encoding | | |
| | | | gene from the aerobic actinomycete Streptomyces | | |
| | | | viridochromogenes. | | |
| A- | T14, T25 | Bayer CropScience (Aventis | Glufosinate herbicide tolerant maize produced by inserting | Zea mays L. (Maize) | |
| 198 | | Crop Science(AgrEvo)) | the phosphinothricin N-acetyltransferase (PAT) encoding | | |
| | | | gene from the aerobic actinomycete Streptomyces | | |
| | | | viridochromogenes. | | |
| A- | T25 × MON810 | Bayer CropScience (Aventis | Stacked insect resistant and herbicide tolerant corn hybrid | Zea mays L. (Maize) | |
| 199 | | CropScience(AgrEvo)) | derived from conventional cross-breeding of the parental | | |
| | | | lines T25 (OECD identifier: ACS-ZMØØ3-2) and | | |
| | | | MON810 (OECD identifier: MON-ØØ81Ø-6). | | |
| A- | TC1507 | Mycogen (c/o Dow | Insect-resistant and glufosinate ammonium herbicide | Zea mays L. (Maize) | U.S. Pat. No. 7,435,807 |
| 200 | | AgroSciences); Pioneer (c/o | tolerant maize produced by inserting the cry1F gene from | | |
| | | Dupont) | Bacillus thuringiensis var. aizawai and the | | |
| | | | phosphinothricin N-acetyltransferase encoding gene from | | |
| | | | Streptomyces viridochromogenes; Insect resistance | | |
| | | | (Cry1F); | | |
| A- | TC1507 × DAS- | DOW AgroSciences LLC | Stacked insect resistant and herbicide tolerant maize | Zea mays L. (Maize) | |
| 201 | 59122-7 | and Pioneer Hi-Bred | produced by conventional cross breeding of parental lines | | |
| | | International Inc. | TC1507 (OECD unique identifier: DAS-Ø15Ø7-1) with | | |
| | | | DAS-59122-7 (OECD unique identifier: DAS-59122-7). | | |
| | | | Resistance to lepidopteran insects is derived from TC1507 | | |
| | | | due the presence of the cry1F gene from Bacillus | | |
| | | | thuringiensis var. aizawai. Corn rootworm-resistance is | | |
| | | | derived from DAS-59122-7 which contains the cry34Ab1 | | |
| | | | and cry35Ab1 genes from Bacillus thuringiensis strain | | |
| | | | PS149B1. Tolerance to glufosinate ammonium herbcicide | | |
| | | | is derived from TC1507 from the phosphinothricin N- | | |
| | | | acetyltransferase encoding gene from Streptomyces | | |
| | | | viridochromogenes. | | |
| A- | VIP1034 | | Insect resistance; | Zea mays L. (Maize) | WO 03/052073 |
| 202 | | | | | |
| A- | MS-B2 | | Male sterility | Brassica ssp | WO 01/31042 |
| 203 | | | | | |
| A- | MS-BN1/RF-BN1 | | Male sterility/restoration | Brassica ssp | WO 01/41558 |
| 204 | | | | | |
| A- | RT73 | | Glyphosate resistance | Brassica ssp | WO 02/36831 |
| 205 | | | | | |
| A- | MON 87708 | MONSANTO | Dicamba herbicide tolerance, transformation vector PV- | Glycine max L. (Soybean) | WO 2011034704 |
| 206 | | TECHNOLOGY LLC | GMHT4355 1) DMO: full length transcript (Peanut | | |
| | | | Chlorotic Streak Virus) promoter > tobacco Etch Virus | | |
| | | | leader > ribulose 1,5-biphosphate carboxylase small | | |
| | | | subunit (Pisum sativum) chloroplast transit peptide > | | |
| | | | dicamba mono-oxygenase (Stenotrophomonas | | |
| | | | maltophilia) coding sequence > ribulose-1,5-bisphosphate | | |
| | | | carboxylase small subunit E9 (Pisum sativum) 3′- | | |
| | | | untranslated region. A CP4 epsps chimeric gene contained | | |
| | | | within a second T-DNA on the transformation vector used | | |
| | | | was segregated away. | | |
| A- | EE-GM3/FG72 | BAYER BIOSCIENCE NV | 1) Ph4a748 ABBC: sequence including the promoter | Glycine max L. (Soybean) | WO 2011063411 |
| 207 | | [BE]; MS TECHNOLOGIES | region of the histone H4 gene of Arabidopsis thaliana, | | |
| | | LLC [US] | containing an internal duplication>5′tev: sequence | | |
| | | | including the leader sequence of the tobacco etch | | |
| | | | virus>TPotp Y: coding sequence of an optimized transit | | |
| | | | peptide derivative (position 55 changed into Tyrosine), | | |
| | | | containing sequence of the RuBisCO small subunit genes | | |
| | | | of Zea mays (corn) and Helianthus annuus | | |
| | | | (sunflower)>hppdPf W336: the coding sequence of the 4- | | |
| | | | hydroxyphenylpyruvate dioxygenase of Pseudomonas | | |
| | | | fluorescens strain A32 modified by the replacement of the | | |
| | | | amino acid Glycine 336 with a Tryptophane>3′nos: | | |
| | | | sequence including the 3′ untranslated region of the | | |
| | | | nopaline synthase gene from the T-DNA of pTiT37 of | | |
| | | | Agrobacterium tumefaciens. 2) Ph4a748: sequence | | |
| | | | including the promoter region of the histone H4 gene of | | |
| | | | Arabidopsis thaliana>intron1 h3At: first intron of gene II | | |
| | | | of the histone H3.III variant of Arabidopsis thaliana | | |
| | | | >TPotp C: coding sequence of the optimized transit | | |
| | | | peptide, containing sequence of the RuBisCO small | | |
| | | | subunit genes of Zea mays (corn) and Helianthus annuus | | |
| | | | (sunflower)>2mepsps: the coding sequence of the double- | | |
| | | | mutant 5-enol-pyruvylshikimate-3-phosphate synthase | | |
| | | | gene of Zea mays>3′histonAt: sequence including the 3′ | | |
| | | | untranslated region of the histone H4 gene of Arabidopsis | | |
| | | | thaliana | | |
| A- | 416/pDAB4468- | DOW AGROSCIENCES | A novel aad-12 transformation event for herbicide | Glycine max L. (Soybean) | WO 2011066384 |
| 208 | 0416 | LLC | tolerance in soybean plants - referred to herein as | | |
| | | | pDAB4468-0416. The aad-12 gene (originally from | | |
| | | | Delftia acidovorans) encodes the aryloxyalkanoate | | |
| | | | dioxygenase (AAD-12) protein. The trait confers tolerance | | |
| | | | to 2,4-dichlorophenoxyacetic acid, for example, and to | | |
| | | | pyridyloxyacetate herbicides. The aad-12 gene, itself, for | | |
| | | | herbicide tolerance in plants was first disclosed in WO | | |
| | | | 2007/053482. | | |
| A- | 127 | | ALS/AHAS inhibitor-tolerance | Glycine max L. (Soybean) | WO2010080829 |
| 209 | | | | | |
| A- | A5547-35 | | Glufosinate tolerance | Glycine max L. (Soybean) | WO 2006/108675 |
| 210 | | | | | |
| A- | A2704-12 | | Glufosinate tolerance | Glycine max L. (Soybean) | WO 2006/108674 |
| 211 | | | | | |
| A- | Kefeng No. 6 | CHINA NAT RICE RES | Transgenic rice Kefeng 6 is a transformation event | Oryza sativa (Rice) | CN 101824411 |
| 212 | | INST | containing two insect-resistant genes, cry1Ac and SCK | | |
| | | | (modified CpTI gene) in China. | | |
| A- | 17053 | | Glyphosate tolerance | Oryza sativa (Rice) | WO2010117737 |
| 213 | | | | | |
| A- | 17314 | | Glyphosate tolerance | Oryza sativa (Rice) | WO2010117735 |
| 214 | | | | | |
| A- | Event 1 | | Fusarium resistance (trichothecene 3-O-acetyltransferase) | Wheat | CA 2561992 |
| 215 | | | | | |
| A- | JOPLIN1 | | disease (fungal) resistance (trichothecene 3-O- | Wheat | US 2008064032 |
| 216 | | | acetyltransferase) | | |
| A- | DAS-40278-9 | DOW AgroSciences LLC | RB7 MARv3>zmUbiquitin 1 promoter>aad1>zmPER5 | Zea mays L. (Maize) | WO 2011022469 |
| 217 | | | 3′UTR>RB 7 MARv4. The aad-1 gene confers tolerance | | |
| | | | to 2,4-dichlorophenoxyacetic acid and | | |
| | | | aryloxyphenoxypropionate (commonly referred to as “fop” | | |
| | | | herbicides such as quizalofop) herbicides | | |
| A- | MIR604 | Syngenta Participations AG | 1) CRY3A: metallotionin-like gene (Zea mays) promoter | Zea mays L. (Maize) | US 2005216970, |
| 218 | | | > delta-endotoxin cry3a (Bacillus thuringiensis subsp. | | US 2008167456, |
| | | | tenebrionis) coding sequence, modified to include a | | US 2011111420 |
| | | | cathepsin-G protease recognition site and maize codon | | |
| | | | optimized > nopaline synthase (Agrobacterium | | |
| | | | tumefaciens) 3′-untranslated region 2) PMI: polyubiquitin | | |
| | | | (Zea mays) promoter (incl. first intron) > mannose-6- | | |
| | | | phosphate isomerase (Escherichia coli) coding sequence > | | |
| | | | nopaline synthase (Agrobacterium tumefaciens) 3′- | | |
| | | | untranslated region | | |
| A- | MON 87427 | MONSANTO | The transgene insert and expression cassette of MON | Zea mays L. (Maize) | WO 2011062904 |
| 219 | | TECHNOLOGY LLC | 87427 comprises the promoter and leader from the | | |
| | | | cauliflower mosaic virus (CaMV) 35 S containing a | | |
| | | | duplicated enhancer region (P-e35S); operably linked to a | | |
| | | | DNA leader derived from the first intron from the maize | | |
| | | | heat shock protein 70 gene (I-HSP70); operably linked to | | |
| | | | a DNA molecule encoding an N-terminal chloroplast | | |
| | | | transit peptide from the shkG gene from Arabidopsis | | |
| | | | thaliana EPSPS (Ts-CTP2); operably linked to a DNA | | |
| | | | molecule derived from the aroA gene from the | | |
| | | | Agrobacterium sp. strain CP4 and encoding the CP4 | | |
| | | | EPSPS protein; operably linked to a 3′ UTR DNA | | |
| | | | molecule derived from the nopaline synthase (T-NOS) | | |
| | | | gene from Agrobacterium tumefaciens. | | |
| A- | DP-004114-3 | Pioneer Hi-Bred | cry1F, cry34Ab1, cry35Ab1, and pat: resistance to certain | Zea mays L. (Maize) | US 2011154523 |
| 220 | | International Inc. | lepidopteran and coleopteran pests, as well as tolerance to | | |
| | | | phosphinothricin. | | |
| A- | DP-032316-8 | Pioneer Hi-Bred | Cry1F, cry34Ab1, cry35Ab1, pat: resistance to certain | Zea mays L. (Maize) | US 2011154524 |
| 221 | | International Inc. | lepidopteran and coleopteran pests, as well as tolerance to | | |
| | | | phosphinothricin | | |
| A- | DP-040416-8 a | Pioneer Hi-Bred | Cry1F, cry34Ab1, cry35Ab1, pat: resistance to certain | Zea mays L. (Maize) | US 20110154525 |
| 222 | | International Inc. | lepidopteran and coleopteran pests, as well as tolerance to | | |
| | | | phosphinothricin | | |
| A- | DP-043A47-3 | Pioneer Hi-Bred | Cry1F, cry34Ab1, cry35Ab1, pat: resistance to certain | Zea mays L. (Maize) | US20110154526 |
| 223 | | International Inc. | lepidopteran and coleopteran pests, as well as tolerance to | | |
| | | | phosphinothricin | | |
| A- | 5307 | | Insect (corn rootworm) resistance (FR8a) | Zea mays L. (Maize) | WO2010077816 |
| 224 | | | | | |

Formulations

Suitable extenders and/or surfactants which may be contained in the compositions according to the invention are all formulation auxiliaries which can customarily be used in plant treatment compositions.

In the compositions according to the invention the ratio of fluopyram to an agrochemically active compound of group (B) can be varied within a relatively wide range. In general, between 0.02 and 2.0 parts by weight, preferably between 0.05 and 1.0 part by weight, of fluopyram is employed per part by weight of agrochemically active compound.

When employing the active compounds of the formula (I) which can be used according to the invention, the application rates can be varied within a certain range, depending on the type of application. In the treatment of seed, the application rates of active compound of the formula (I) are generally between 10 and 10000 mg per kilogram of seed, preferably between 10 and 300 mg per kilogram of seed. When used in solid formulations, the application rates of active compound of the formula (I) are generally between 20 and 800 mg per kilogram of formulation, preferably between 30 and 700 mg per kilogram of formulation.

According to the invention, carrier is to be understood as meaning a natural or synthetic, organic or inorganic substance which is mixed or combined with the active compounds for better applicability, in particular for application to plants or plant parts or seeds. The carrier, which may be solid or liquid, is generally inert and should be suitable for use in agriculture.

Suitable solid carriers are: for example ammonium salts and natural ground minerals, such as kaolins, clays, talc, chalk, quartz, attapulgite, montmorillonite or diatomaceous earth, and ground synthetic minerals, such as finely divided silica, alumina and natural or synthetic silicates, resins, waxes, solid fertilizers, water, alcohols, especially butanol, organic solvents, mineral oils and vegetable oils, and also derivatives thereof. It is also possible to use mixtures of such carriers. Solid carriers suitable for granules are: for example crushed and fractionated natural minerals, such as calcite, marble, pumice, sepiolite, dolomite, and also synthetic granules of inorganic and organic meals and also granules of organic material, such as sawdust, coconut shells, maize cobs and tobacco stalks. Suitable emulsifiers and/or foam-formers are: for example nonionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates, and also protein hydrolysates. Suitable dispersants are: for example lignosulphite waste liquors and methylcellulose.

Suitable liquefied gaseous extenders or carriers are liquids which are gaseous at ambient temperature and under atmospheric pressure, for example aerosol propellants, such as butane, propane, nitrogen and carbon dioxide.

Tackifiers, such as carboxymethylcellulose and natural and synthetic polymers in the form of powders, granules and latices, such as gum arabic, polyvinyl alcohol, polyvinyl acetate, or else natural phospholipids, such as cephalins and lecithins and synthetic phospholipids can be used in the formulations. Other possible additives are mineral and vegetable oils.

If the extender used is water, it is also possible for example, to use organic solvents as auxiliary solvents. Suitable liquid solvents are essentially: aromatic compounds, such as xylene, toluene or alkylnaphthalenes, chlorinated aromatic compounds or chlorinated aliphatic hydrocarbons, such as chlorobenzenes, chloroethylenes or methylene chloride, aliphatic hydrocarbons, such as cyclohexane or paraffins, for example mineral oil fractions, mineral and vegetable oils, alcohols, such as butanol or glycol, and also ethers and esters thereof, ketones, such as acetone, methyl ethyl ketone, methyl isobutyl ketone or cyclohexanone, strongly polar solvents, such as dimethylformamide and dimethyl sulphoxide, and also water.

The compositions according to the invention may comprise additional further components, such as, for example, surfactants. Suitable surfactants are emulsifiers, dispersants or wetting agents having ionic or nonionic properties, or mixtures of these surfactants. Examples of these are salts of polyacrylic acid, salts of lignosulphonic acid, salts of phenolsulphonic acid or naphthalenesulphonic acid, polycondensates of ethylene oxide with fatty alcohols or with fatty acids or with fatty amines, substituted phenols (preferably alkylphenols or arylphenols), salts of sulphosuccinic esters, taurine derivatives (preferably alkyl taurates), phosphoric esters of polyethoxylated alcohols or phenols, fatty esters of polyols, and derivatives of the compounds containing sulphates, sulphonates and phosphates. The presence of a surfactant is required if one of the active compounds and/or one of the inert carriers is insoluble in water and when the application takes place in water. The proportion of surfactants is between 5 and 40 percent by weight of the composition according to the invention.

It is possible to use colorants such as inorganic pigments, for example iron oxide, titanium oxide, Prussian blue, and organic dyes, such as alizarin dyes, azo dyes and metal phthalocyanine dyes, and trace nutrients, such as salts of iron, manganese, boron, copper, cobalt, molybdenum and zinc.

If appropriate, other additional components may also be present, for example protective colloids, binders, adhesives, thickeners, thixotropic substances, penetrants, stabilizers, sequestering agents, complex formers. In general, the active compounds can be combined with any solid or liquid additive customarily used for formulation purposes.

In general, the compositions according to the invention comprise between 0.05 and 99 percent by weight of the active compound combination according to the invention, preferably between 10 and 70 percent by weight, particularly preferably between 20 and 50 percent by weight, most preferably 25 percent by weight.

The active compound combinations or compositions according to the invention can be used as such or, depending on their respective physical and/or chemical properties, in the form of their formulations or the use forms prepared therefrom, such as aerosols, capsule suspensions, cold-fogging concentrates, warm-fogging concentrates, encapsulated granules, fine granules, flowable concentrates for the treatment of seed, ready-to-use solutions, dustable powders, emulsifiable concentrates, oil-in-water emulsions, water-in-oil emulsions, macrogranules, microgranules, oil-dispersible powders, oil-miscible flowable concentrates, oil-miscible liquids, foams, pastes, pesticide-coated seed, suspension concentrates, suspoemulsion concentrates, soluble concentrates, suspensions, wettable powders, soluble powders, dusts and granules, water-soluble granules or tablets, water-soluble powders for the treatment of seed, wettable powders, natural products and synthetic substances impregnated with active compound, and also microencapsulations in polymeric substances and in coating materials for seed, and also ULV cold-fogging and warm-fogging formulations.

The formulations mentioned can be prepared in a manner known per se, for example by mixing the active compounds or the active compound combinations with at least one additive. Suitable additives are all customary formulation auxiliaries, such as, for example, organic solvents, extenders, solvents or diluents, solid carriers and fillers, surfactants (such as adjuvants, emulsifiers, dispersants, protective colloids, wetting agents and tackifiers), dispersants and/or binders or fixatives, preservatives, dyes and pigments, defoamers, inorganic and organic thickeners, water repellents, if appropriate siccatives and UV stabilizers, gibberellins and also water and further processing auxiliaries. Depending on the formulation type to be prepared in each case, further processing steps such as, for example, wet grinding, dry grinding or granulation may be required.

Organic diluents that may be present are all polar and non-polar organic solvents that are customarily used for such purposes. Preferred are ketones, such as methyl isobutyl ketone and cyclohexanone, furthermore amides, such as dimethylformamide and alkanecarboxamides, such as N,N-dimethyldecanamide and N,N-dimethyloctanamide, furthermore cyclic compounds, such as N-methylpyrrolidone, N-octylpyrrolidone, N-dodecylpyrrolidone, N-octylcaprolactam, N-dodecylcaprolactam and butyrolactone, additionally strongly polar solvents, such as dimethyl sulphoxide, furthermore aromatic hydrocarbons, such as xylene, Solvesso™, mineral oils, such as white spirit, petroleum, alkylbenzenes and spindle oil, moreover esters, such as propylene glycol monomethyl ether acetate, dibutyl adipate, hexyl acetate, heptyl acetate, tri-n-butyl citrate and di-n-butyl phthalate, and furthermore alcohols, such as, for example, benzyl alcohol and 1-methoxy-2-propanol.

Solid carriers suitable for granules are: for example crushed and fractionated natural minerals, such as calcite, marble, pumice, sepiolite, dolomite, and also synthetic granules of inorganic and organic meals and also granules of organic material, such as sawdust, coconut shells, maize cobs and tobacco stalks.

Suitable surfactants (adjuvants, emulsifiers, dispersants, protective colloids, wetting agents and tackifiers) are customary ionic and nonionic substances. Examples which may be mentioned are ethoxylated nonylphenols, polyalkylene glycol ethers of straight-chain or branched alcohols, products of reactions of alkylphenols with ethylene oxide and/or propylene oxide, products of reactions of fatty amines with ethylene oxide and/or propylene oxide, furthermore fatty esters, alkylsulphonates, alkyl sulphates, alkyl ether sulphates, alkyl ether phosphates, aryl sulphates, ethoxylated arylalkylphenols, such as, for example, tristyrylphenol ethoxylates, furthermore ethoxylated and propoxylated arylalkylphenols and also sulphated or phosphated arylalkylphenol ethoxylates or ethoxy- and propoxylates. Mention may furthermore be made of natural and synthetic water-soluble polymers, such as lignosulphonates, gelatine, gum arabic, phospholipids, starch, hydrophobically modified starch and cellulose derivatives, in particular cellulose esters and cellulose ethers, furthermore polyvinyl alcohol, polyvinyl acetate, polyvinylpyrrolidone, polyacrylic acid, polymethacrylic acid and copolymers of (meth)acrylic acid and (meth)acrylic acid esters, and moreover also alkali metal hydroxide-neutralized copolymers of methacrylic acid and methacrylic ester and condensates of optionally substituted naphthalenesulphonic acid salts with formaldehyde.

Suitable solid fillers and carriers are all substances customarily used for this purpose in crop pretection compositions. Inorganic particles, such as carbonates, silicates, sulphates and oxides having a mean particle size of from 0.005 to 20 m, particularly preferably from 0.02 to 10 m, may be mentioned as being preferred. Examples which may be mentioned are ammonium sulphate, ammonium phosphate, urea, calcium carbonate, calcium sulphate, magnesium sulphate, magnesium oxide, aluminium oxide, silicon dioxide, finely divided silicic acid, silica gels, natural and synthetic silicates and alumosilicates and vegetable products such as cereal meal, wood powder and cellulose powder.

Suitable colorants that may be present in the seed dressing formulations to be used according to the invention include all colorants customary for such purposes. Use may be made both of pigments, of sparing solubility in water, and of dyes, which are soluble in water. Examples that may be mentioned include the colorants known under the designations Rhodamin B, C.I. Pigment Red 112 and C.I. Solvent Red 1. The colorants used can be inorganic pigments, for example iron oxide, titanium oxide, Prussian Blue, and organic dyes, such as alizarin, azo and metal phthalocyanine dyes, and trace nutrients, such as salts of iron, manganese, boron, copper, cobalt, molybdenum and zinc.

Suitable wetting agents that may be present in the seed dressing formulations to be used according to the invention include all substances which promote wetting and are customary in the formulation of agrochemically active compounds. Preference is given to using alkylnaphthalenesulphonates, such as diisopropyl- or diisobutylnaphthalenesulphonates.

Suitable dispersants and/or emulsifiers that may be present in the seed dressing formulations to be used according to the invention include all nonionic, anionic and cationic dispersants which are customary in the formulation of agrochemically active compounds. Preference is given to using nonionic or anionic dispersants or mixtures of nonionic or anionic dispersants. Particularly suitable nonionic dispersants are ethylene oxide/propylene oxide block polymers, alkylphenol polyglycol ethers, and also tristryrylphenol polyglycol ethers and their phosphated or sulphated derivatives. Particularly suitable anionic dispersants are lignosulphonates, polyacrylic acid salts and arylsulphonate/formaldehyde condensates.

Defoamers that may be present in the seed dressing formulations to be used according to the invention include all foam-inhibiting compounds which are customary in the formulation of agrochemically active compounds. Preference is given to using silicone defoamers, magnesium stearate, silicone emulsions, long-chain alcohols, fatty acids and their salts and also organofluorine compounds and mixtures thereof.

Preservatives that may be present in the seed dressing formulations to be used according to the invention include all compounds which can be used for such purposes in agrochemical compositions. By way of example, mention may be made of dichlorophen and benzyl alcohol hemiformal.

Secondary thickeners that may be present in the seed dressing formulations to be used according to the invention include all compounds which can be used for such purposes in agrochemical compositions. Preference is given to cellulose derivatives, acrylic acid derivatives, polysaccharides, such as xanthan gum or Veegum, modified clays, phyllosilicates, such as attapulgite and bentonite, and also finely divided silicic acids.

Suitable adhesives that may be present in the seed dressing formulations to be used according to the invention include all customary binders which can be used in seed dressings. Polyvinylpyrrolidone, polyvinyl acetate, polyvinyl alcohol and tylose may be mentioned as being preferred.

Suitable gibberellins that may be present in the seed dressing formulations to be used according to the invention are preferably the gibberellins A1, A3 (=gibberellic acid), A4 and A7; particular preference is given to using gibberellic acid. The gibberellins are known (cf. R. Wegler “Chemie der Pflanzenschutz- and Schidlingsbekimpfungsmittel” [Chemistry of Crop Protection Agents and Pesticides], Vol. 2, Springer Verlag, 1970, pp. 401-412).

The formulations generally comprise between 0.1 and 95% by weight of active compound, preferably between 0.5 and 90%.

The active compound combinations according to the invention can be present in commercial formulations and in the use forms prepared from these formulations as a mixture with other active compounds, such as insecticides, attractants, sterilants, bactericides, acaricides, nematicides, fungicides, growth regulators or herbicides. A mixture with fertilizers is also possible.

The treatment according to the invention of the plants and plant parts with the active compound combinations or compositions is carried out directly or by action on their surroundings, habitat or storage space using customary treatment methods, for example by dipping, spraying, atomizing, irrigating, evaporating, dusting, fogging, broadcasting, foaming, painting, spreading-on, watering (drenching), drip irrigating and, in the case of propagation material, in particular in the case of seeds, furthermore as a powder for dry seed treatment, a solution for seed treatment, a water-soluble powder for slurry treatment, by incrusting, by coating with one or more coats, etc.

Preference is given to application by dipping, spraying, atomizing, irrigating, evaporating, dusting, fogging, broadcasting, foaming, painting, spreading-on, watering (drenching) and drip irrigating.

The application of the formulations is carried out in accordance with customary agricultural practice in a manner adapted to the application forms. Customary applications are, for example, dilution with water and spraying of the resulting spray liquor, application after dilution with oil, direct application without dilution, seed dressing or soil application of carrier granules.

The active compound content of the application forms prepared from the commercial formulations can vary within wide limits. The active compound concentration of the application forms can be from 0.0000001 up to 95% by weight of active compound, preferably between 0.0001 and 2% by weight.

The compositions according to the invention do not only comprise ready-to-use compositions which can be applied with suitable apparatus to the plant or the seed, but also commercial concentrates which have to be diluted with water prior to use.

Application Methods

The treatment according to the invention of the plants and plant parts with Fluopyram or compositions is carried out directly or by action on their surroundings, habitat or storage space using customary treatment methods, for example by dipping, spraying, atomizing, irrigating, stem injection, in-furrow application, evaporating, dusting, fogging, broadcasting, foaming, painting, spreading-on, watering (drenching), drip irrigating and, in the case of propagation material, in particular in the case of seeds, furthermore as a powder for dry seed treatment, a solution for seed treatment, a water-soluble powder for slurry treatment, by incrusting, by coating with one or more layers, etc. It is furthermore possible to apply the active compounds by the ultra-low volume method, or to inject the active compound preparation or the active compound itself into the soil.

Generally, fluopyram is applied in a rate of 10 g to 20 kg per ha, preferably 50 g to 10 kg per ha, most preferably 100 g to 5 kg per ha.

The invention furthermore comprises a method for treating seed. The invention furthermore relates to seed treated according to one of the methods described in the preceding paragraph.

Fluopyram or compositions comprising fluopyram according to the invention are especially suitable for treating seed. A large part of the damage to crop plants caused by harmful organisms is triggered by an infection of the seed during storage or after sowing as well as during and after germination of the plant. This phase is particularly critical since the roots and shoots of the growing plant are particularly sensitive, and even small damage may result in the death of the plant. Accordingly, there is great interest in protecting the seed and the germinating plant by using appropriate compositions.

The control of nematodes by treating the seed of plants has been known for a long time and is the subject of continuous improvements. However, the treatment of seed entails a series of problems which cannot always be solved in a satisfactory manner. Thus, it is desirable to develop methods for protecting the seed and the germinating plant which dispense with the additional application of crop protection agents after sowing or after the emergence of the plants or which at least considerably reduce additional application. It is furthermore desirable to optimize the amount of active compound employed in such a way as to provide maximum protection for the seed and the germinating plant from attack by nematodes, but without damaging the plant itself by the active compound employed. In particular, methods for the treatment of seed should also take into consideration the intrinsic nematicidal properties of transgenic plants in order to achieve optimum protection of the seed and the germinating plant with a minimum of crop protection agents being employed.

Accordingly, the present invention also relates in particular to a method for protecting seed and germinating plants against attack by nematodes by treating the seed with Fluopyram or a composition comprising fluopyram according to the invention. The invention also relates to the use of the compositions according to the invention for treating seed for protecting the seed and the germinating plant against nematodes. Furthermore, the invention relates to seed treated with a composition according to the invention for protection against nematodes.

The control of nematodes which damage plants post-emergence is carried out primarily by treating the soil and the above-ground parts of plants with crop protection compositions. Owing to the concerns regarding a possible impact of the crop protection composition on the environment and the health of humans and animals, there are efforts to reduce the amount of active compounds applied.

One of the advantages of the present invention is that, because of the particular systemic properties of Fluopyram or a composition comprising fluopyram according to the invention, treatment of the seed with Fluopyram or these compositions not only protects the seed itself, but also the resulting plants after emergence, from nematodes. In this manner, the immediate treatment of the crop at the time of sowing or shortly thereafter can be dispensed with.

Fluopyram or the compositions comprising fluopyram according to the invention are suitable for protecting seeds of vegetables, in particular tomato and cucurbits, potato, corn, soy, cotton, tobacco, coffee, fruits, in particular, citrus fruits, pine apples and bananas, and grapes.

Fluopyram or the compositions comprising fluopyram according to the invention are particularly suitable for protecting seed of soy, in particular against Heterodera glycines.

Fluopyram or the compositions comprising fluopyram according to the invention are suitable for protecting seed of curcubits, in particular against Meloidogyne incognita.

As also described further below, the treatment of transgenic seed with Fluopyram or compositions according to the invention is of particular importance. This refers to the seed of plants containing at least one heterologous gene which allows the expression of a polypeptide or protein having insecticidal properties. The heterologous gene in transgenic seed can originate, for example, from microorganisms of the species Bacillus, Rhizobium, Pseudomonas, Serratia, Trichoderma, Clavibacter, Glomus or Gliocladium. Preferably, this heterologous gene is from Bacillus sp., the gene product having activity against the European corn borer and/or the Western corn rootworm.

Particularly preferably, the heterologous gene originates from Bacillus thuringiensis.

In the context of the present invention, Fluopyram or a composition comprising fluopyram according to the invention are applied on their own or in a suitable formulation to the seed. Preferably, the seed is treated in a state in which it is sufficiently stable so that the treatment does not cause any damage. In general, treatment of the seed may take place at any point in time between harvesting and sowing. Usually, the seed used is separated from the plant and freed from cobs, shells, stalks, coats, hairs or the flesh of the fruits. Thus, it is possible to use, for example, seed which has been harvested, cleaned and dried to a moisture content of less than 15% by weight. Alternatively, it is also possible to use seed which, after drying, has been treated, for example, with water and then dried again.

When treating the seed, care must generally be taken that the amount of Fluopyram or a composition comprising fluopyram according to the invention applied to the seed and/or the amount of further additives is chosen in such a way that the germination of the seed is not adversely affected, or that the resulting plant is not damaged. This must be borne in mind in particular in the case of active compounds which may have phytotoxic effects at certain application rates.

Fluopyram or a composition comprising fluopyram according to the invention can be applied directly, that is to say without comprising further components and without having been diluted. In general, it is preferable to apply the compositions to the seed in the form of a suitable formulation. Suitable formulations and methods for the treatment of seed are known to the person skilled in the art and are described, for example, in the following documents: U.S. Pat. No. 4,272,417 A, U.S. Pat. No. 4,245,432 A, U.S. Pat. No. 4,808,430 A, U.S. Pat. No. 5,876,739 A, US 2003/0176428 A1, WO 2002/080675 A1, WO 2002/028186 A2.

Fluopyram or a composition comprising fluopyram which can be used according to the invention can be converted into customary seed dressing formulations, such as solutions, emulsions, suspensions, powders, foams, slurries or other coating materials for seed, and also ULV formulations.

These formulations are prepared in a known manner by mixing the active compounds or active compound combinations with customary additives, such as, for example, customary extenders and also solvents or diluents, colorants, wetting agents, dispersants, emulsifiers, defoamers, preservatives, secondary thickeners, adhesives, gibberellins and water as well.

Suitable colorants that may be present in the seed dressing formulations which can be used according to the invention include all colorants customary for such purposes. Use may be made both of pigments, of sparing solubility in water, and of dyes, which are soluble in water. Examples that may be mentioned include the colorants known under the designations Rhodamine B, C.I. Pigment Red 112, and C.I. Solvent Red 1.

Suitable wetting agents that may be present in the seed dressing formulations which can be used according to the invention include all substances which promote wetting and are customary in the formulation of active agrochemical substances. With preference it is possible to use alkylnaphthalene-sulphonates, such as diisopropyl- or diisobutylnaphthalene-sulphonates.

Suitable dispersants and/or emulsifiers that may be present in the seed dressing formulations which can be used according to the invention include all nonionic, anionic, and cationic dispersants which are customary in the formulation of active agrochemical substances. With preference, it is possible to use nonionic or anionic dispersants or mixtures of nonionic or anionic dispersants. Particularly suitable nonionic dispersants are ethylene oxide-propylene oxide block polymers, alkylphenol polyglycol ethers, and tristyrylphenol polyglycol ethers, and their phosphated or sulphated derivatives. Particularly suitable anionic dispersants are lignosulphonates, polyacrylic salts, and arylsulphonate-formaldehyde condensates.

Defoamers that may be present in the seed dressing formulations to be used according to the invention include all foam-inhibiting compounds which are customary in the formulation of agrochemically active compounds. Preference is given to using silicone defoamers, magnesium stearate, silicone emulsions, long-chain alcohols, fatty acids and their salts and also organofluorine compounds and mixtures thereof.

Preservatives that may be present in the seed dressing formulations to be used according to the invention include all compounds which can be used for such purposes in agrochemical compositions. By way of example, mention may be made of dichlorophen and benzyl alcohol hemiformal.

Secondary thickeners that may be present in the seed dressing formulations to be used according to the invention include all compounds which can be used for such purposes in agrochemical compositions. Preference is given to cellulose derivatives, acrylic acid derivatives, polysaccharides, such as xanthan gum or Veegum, modified clays, phyllosilicates, such as attapulgite and bentonite, and also finely divided silicic acids.

Suitable adhesives that may be present in the seed dressing formulations to be used according to the invention include all customary binders which can be used in seed dressings. Polyvinylpyrrolidone, polyvinyl acetate, polyvinyl alcohol and tylose may be mentioned as being preferred.

Suitable gibberellins that may be present in the seed dressing formulations to be used according to the invention are preferably the gibberellins A1, A3 (=gibberellic acid), A4 and A7; particular preference is given to using gibberellic acid. The gibberellins are known (cf. R. Wegler “Chemie der Pflanzenschutz- and Schidlingsbekimpfungsmittel” [Chemistry of Crop Protection Agents and Pesticides], Vol. 2, Springer Verlag, 1970, pp. 401-412).

The seed dressing formulations which can be used according to the invention may be used directly or after dilution with water beforehand to treat seed of any of a very wide variety of types. The seed dressing formulations which can be used according to the invention or their dilute preparations may also be used to dress seed of transgenic plants. In this context, synergistic effects may also arise in interaction with the substances formed by expression.

Suitable mixing equipment for treating seed with the seed dressing formulations which can be used according to the invention or the preparations prepared from them by adding water includes all mixing equipment which can commonly be used for dressing. The specific procedure adopted when dressing comprises introducing the seed into a mixer, adding the particular desired amount of seed dressing formulation, either as it is or following dilution with water beforehand, and carrying out mixing until the formulation is uniformly distributed on the seed. Optionally, a drying operation follows.

The nematicidal compositions according to the invention can be used for the curative or protective control of nematodes. Accordingly, the invention also relates to curative and protective methods for controlling nematodes using the fluopyram and compositions containing fluopyram according to the invention, which are applied to the seed, the plant or plant parts, the fruit or the soil in which the plants grow. Preference is given to application onto the plant or the plant parts, the fruits or the soil.

The compositions according to the invention for controlling nematodes in crop protection comprise an active, but non-phytotoxic amount of the compounds according to the invention. “Active, but non-phytotoxic amount” shall mean an amount of the composition according to the invention which is sufficient to control or to completely kill the plant disease caused by nematodes, which amount at the same time does not exhibit noteworthy symptoms of phytotoxicity. These application rates generally may be varied in a broader range, which rate depends on several factors, e.g. the nematodes, the plant or crop, the climatic conditions and the ingredients of the composition according to the invention.

The fact that the active compounds, at the concentrations required for the controlling of plant diseases, are well tolerated by plants permits the treatment of aerial plant parts, of vegetative propagation material and seed, and of the soil.

In an exemplary seed treatment method, an aqueous composition comprising fluopyram can be applied at a rate to provide in the range of 0.5 g to 10 kg, preferably 0.8 g to 5 kg, most preferably 1 g to 1 kg Fluopyram per 100 kg (dt) of seeds.

In a further embodiment the present invention relates to the use of fluopyram for controlling Meloidogyne incognita in tomato.

In a further embodiment the present invention relates to the use of fluopyram for controlling Helicotylenchus sp. in tomato.

In a further embodiment the present invention relates to the use of fluopyram for controlling Meloidogyne hapla in potato.

In a further embodiment the present invention relates to the use of fluopyram for controlling Tylenchulus semipenetrans in citrus.

In a further embodiment the present invention relates to the use of fluopyram for controlling Radopholus similis in banana.

In a further embodiment the present invention relates to a method of treatment comprising applying fluopyram as a plant drench application for controlling nematodes.

In a further embodiment the present invention relates to a method of treatment comprising applying fluopyram as a plant drench application for controlling nematodes in tomato.

In a further embodiment the present invention relates to a method of treatment comprising applying fluopyram as a plant in-furrow application for controlling nematodes.

In a further embodiment the present invention relates to a method of treatment comprising applying fluopyram as a plant in-furrow application for controlling nematodes in potato.

In a further embodiment the present invention relates to a method of treatment comprising applying fluopyram as a drench application for controlling nematodes.

In a further embodiment the present invention relates to a method of treatment comprising applying fluopyram as a drench application for controlling nematodes in citrus.

In a further embodiment the present invention relates to a method of treatment comprising applying fluopyram as a drench application for controlling nematodes in banana.

In a further embodiment the present invention relates to a method of treatment comprising applying fluopyram as a stem injection application for controlling nematodes.

In a further embodiment the present invention relates to a method of treatment comprising applying fluopyram as a stem injection application for controlling nematodes in banana.

In a further embodiment the present invention relates to the use of compositions comprising fluopyram for controlling Meloidogyne incognita in tomato.

In a further embodiment the present invention relates to the use of compositions comprising fluopyram for controlling Helicotylenchus sp. in tomato.

In a further embodiment the present invention relates to the use of compositions comprising fluopyram for controlling Meloidogyne hapla in potato.

In a further embodiment the present invention relates to the use of compositions comprising fluopyram for controlling Tylenchulus semipenetrans in citrus.

In a further embodiment the present invention relates to the use of compositions comprising fluopyram for controlling Radopholus similis in banana.

In a further embodiment the present invention relates to a method of treatment comprising applying compositions comprising fluopyram as a plant drench application for controlling nematodes.

In a further embodiment the present invention relates to a method of treatment comprising applying compositions comprising fluopyram as a plant drench application for controlling nematodes in tomato.

In a further embodiment the present invention relates to a method of treatment comprising applying compositions comprising fluopyram as a plant in-furrow application for controlling nematodes.

In a further embodiment the present invention relates to a method of treatment comprising applying compositions comprising fluopyram as a plant in-furrow application for controlling nematodes in potato.

In a further embodiment the present invention relates to a method of treatment comprising applying compositions comprising fluopyram as a drench application for controlling nematodes.

In a further embodiment the present invention relates to a method of treatment comprising applying compositions comprising fluopyram as a drench application for controlling nematodes in citrus.

In a further embodiment the present invention relates to a method of treatment comprising applying compositions comprising fluopyram as a drench application for controlling nematodes in banana.

In a further embodiment the present invention relates to a method of treatment comprising applying compositions comprising fluopyram as a stem injection application for controlling nematodes.

In a further embodiment the present invention relates to a method of treatment comprising applying compositions comprising fluopyram as a stem injection application for controlling nematodes in banana.

The general concepts of the invention are described in the following examples, which are not to be considered as limiting.

### Example A

Meloidogyne incognita in Tomato—at Plant Drench Application

To produce a suitable preparation the formulation is diluted with water to the desired concentration.

Soil which contains a mixed population of the Southern Root Knot Nematode (Meloidogyne incognita) is drenched with the formulation at planting of the tomatoes.

After the specified period the nematicidal activity is determined on the basis of the percentage of gall formation. 100% means that no galls were found; 0% means that the number of galls found on the roots of treated plants was equal to that in untreated control plants.

In this test, for example, the following formulation from the preparation examples shows good activity:

TABLE A
Meloidogyne incognita - Test on tomato

| | Concentration | Efficacy |
|---|---|---|
| Active Ingredient | in mg/plant | in % after 92^{d} |
| Fluopyram suspension | 20 | 76.5 |
| concentrate (SC) 500 | 10 | 50.1 |
| | 5 | 47.1 |

### Example B

Helicotylenchulus sp. in Tomato—at Plant Drench Application

To produce a suitable preparation the formulation is diluted with water to the desired concentration.

Soil which contains a mixed population of Spiral Nematodes (Helicotylenculus spp.) is drenched with the formulation at planting of the tomatoes.

After the specified period the nematicidal activity is determined by counting the nematodes. 100% means that no nematodes were found; 0% means that the number of nematodes found in treated soil was equal to that in untreated soil.

In this test, for example, the following formulation from the preparation examples shows good activity:

TABLE B
Helicotylenchulus spp - Test on tomato

| | Concentration | Efficacy |
|---|---|---|
| Active Ingredient | in mg/plant | in % after 60^{d} |
| Fluopyram SC 500 | 300 | 85 |
| | 100 | 79 |
| | 10 | 82 |

### Example C

Meloidogyne hapla in Potato—at Plant In-Furrow Application

To produce a suitable preparation the formulation is diluted with water to the desired concentration.

Soil which contains a mixed population of the Northern Root Knot Nematode (Meloidogyne hapla) is treated with an in-furrow application with the formulation at planting of the potatoes.

After the specified period the nematicidal activity is determined on the basis of the percentage of infested tubers. 100% means that no infested tubers were found; 0% means that the number of infested tubers of treated plants was equal to that in untreated control plants.

In this test, for example, the following formulation from the preparation examples shows good activity:

TABLE C
Meloidogyne hapla - Test on potato

| | Concentration | Efficacy |
|---|---|---|
| Active Ingredient | in g ai/ha | in % after 169^{d} |
| Fluopyram SC 500 | 400 | 43.4 |

### Example D

Tylenchulus semipenetrans in Citrus—Drench Application

To produce a suitable preparation the formulation is diluted with water to the desired concentration.

Soil under citrus tree canopy which contains a mixed population of the citrus nematode (Tylenchulus semipenetrans) is drenched with the formulation.

After the specified period the nematicidal activity is determined by counting the nematodes. 100% means that no nematodes were found; 0% means that the number of nematodes found in treated soil was equal to that in untreated soil.

In this test, for example, the following formulation from the preparation examples shows good activity:

TABLE D
Tylenchulus semipenetrans - Test on citrus

| Active | Concentration | Efficacy |
|---|---|---|
| Ingredient | in g ai/ha | in % 131^{d} after first appl. |
| Fluopyram | 500 (1 appl.) | 41.5 |
| SC 500 | 250 (2 appl. at 29 d interval) | 48.1 |

### Example E

Radopholus similis in Banana—Drench Application

To produce a suitable preparation the formulation is diluted with water to the desired concentration.

Soil under bananas which is infested with a mixed population of the Banana root nematode (Radopholus similis) is drenched with the formulation.

After the specified period the nematicidal activity is determined by counting the nematodes in the banana roots. 100% means that no nematodes were found; 0% means that the number of nematodes found in the treated plots was equal to that in untreated plots.

In this test, for example, the following formulation from the preparation examples shows good activity:

TABLE F
Radopholus similis - Test on banana

| | Concentration | Efficacy |
|---|---|---|
| Active Ingredient | in g ai/plant | in % after 61^{d} |
| Fluopyram SC 500 | 0.3 | 95.8 |

### Example G

Radopholus similis in Banana—Stem Injection

To produce a suitable preparation the formulation is diluted with water to the desired concentration.

Stems of Bananas, which were growing in soil infested with a mixed population of the Banana root nematode (Radopholus similis), are injected with the formulation.

After the specified period the nematicidal activity is determined by counting the nematodes in the banana roots. 100% means that no nematodes were found; 0% means that the number of nematodes found in treated plots was equal to that in untreated plots.

In this test, for example, the following formulation from the preparation examples shows good activity:

TABLE G
Radopholus similis - Test on banana

| | Concentration | Efficacy |
|---|---|---|
| Active Ingredient | in g ai/plant | in % after 91^{d} |
| Fluopyram SC 500 | 0.3 | 84.6 |
| | 0.15 | 62.6 |

### Example H

Meloidogyne incognita in Tomato—Drip Application after Transplanting

To produce a suitable preparation the formulation is diluted with water to the desired concentration.

Soil which contains a mixed population of the Southern Root Knot Nematode (Meloidogyne incognita) is treated via drip irrigation with the formulation 6 days after transplanting of the tomatoes.

After the specified period the nematicidal activity is determined on the basis of the percentage of gall formation. 100% means that no galls were found; 0% means that the number of galls found on the roots of treated plants was equal to that in untreated control plants.

In this test, for example, the following formulation from the preparation examples shows good activity:

TABLE H
Meloidogyne incognita - Test on tomato

| | Concentration | Efficacy |
|---|---|---|
| Active Ingredient | in gr/ha | in % after 56^{d} |
| Fluopyram SC 500 | 500 | 95.5 |
| | 375 | 86.2 |
| | 250 | 76.5 |

### Example I

Meloidogyne javanica in Cucumber—at Plant Drip Application

To produce a suitable preparation the formulation is diluted with water to the desired concentration.

Soil which contains a mixed population of the Root Knot Nematode (Meloidogyne javanica) is treated via drip irrigation with the formulation at planting of the cucumber.

After the specified period the nematicidal activity is determined on the basis of the percentage of gall formation. 100% means that no galls were found; 0% means that the number of galls found on the roots of treated plants was equal to that in untreated control plants.

In this test, for example, the following formulation from the preparation examples shows good activity:

TABLE I
Meloidogyne javanica - Test on cucumber

| | Concentration | Efficacy |
|---|---|---|
| Active Ingredient | in gr/ha | in % after 61^{d} |
| Fluopyram SC 500 | 750 | 95.4 |
| | 500 | 80.6 |
| | 375 | 80.1 |
| | 250 | 75.7 |
| | 125 | 75.7 |

1. An N{[3 chloro-5 (trifluoromethyl)-2 pyridinyl]ethyl}-2,6 dichlorobenzamide (fluopyram) of formula (I) 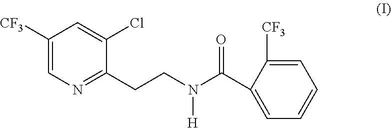 [SMILES: O=C(NCCc1ncc(C(F)(F)F)cc1Cl)c1ccccc1C(F)(F)F]
and/or an N-oxide thereof capable of being used for controlling nematodes infesting at least one crop selected from the group consisting of vegetables, corn, soy, cotton, tobacco, coffee, sugarcane, fruits, tree crops, nuts, and flowers and/or capable of being used for increasing yield of said at least one crop.

2. An N{[3 chloro-5 (trifluoromethyl)-2 pyridinyl]ethyl}-2,6 dichlorobenzamide (fluopyram) of formula (I) 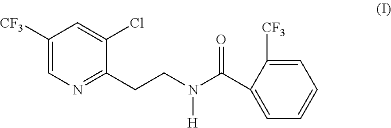 [SMILES: O=C(NCCc1ncc(C(F)(F)F)cc1Cl)c1ccccc1C(F)(F)F]
and/or an N-oxide thereof capable of being used for controlling nematodes infesting at least one crop selected from the group consisting of vegetables, tomato, cucurbits, potato, pepper, carrots, onions, corn, soy, cotton, tobacco, coffee, sugarcane, fruits, citrus fruits, pine apples and bananas, and grapes, tree crops—pome fruits, tree crops—stone fruits, tree crops—nuts, and flowers and/or capable of being used for increasing yield.

3. A composition comprising
A) fluopyram and/or an N-oxide thereof and
B) at least one agrochemically active compound,
at least one extender and/or surfactant, wherein said composition is capable of being used for controlling nematodes infesting at least one crop selected from the group consisting of vegetables, corn, soy, cotton, tobacco, coffee, sugarcane, fruits, tree crops, nuts, and flowers and/or capable of being used for increasing yield of said at least one crop.

4. The composition according to claim 3, wherein fluopyram and/or the N-oxide has been applied to said at least one crop at a rate of 100 g to 5 kg per ha.

5. A method of controlling nematodes comprising applying fluopyram and/or an N-oxide thereof according to claim 1, to a plant.

6. A method of treating seeds for control of nematodes in a crop selected from the group consisting of vegetables, potato, corn, soy, cotton and banana, comprising applying a compound according to claim 1 to a seed.

7. A method for increasing yield, comprising applying fluopyram and/or an N-oxide thereof according to claim 1, to a plant.

8. A method for increasing yield, comprising applying fluopyram and/or an N-oxide thereof according to claim 1 to a seed.
